(19) United States
(12) Patent Application Publication
(10) Pub. No.: US 2009/0030848 A1
(43) Pub. Date: Jan. 29, 2009

(54) SYSTEMS AND METHODS FOR ONLINE SALES NEGOTIATIONS

(75) Inventor: Harold A. Wendel, Encinitas, CA (US)

Correspondence Address: COOLEY GODWARD KRONISH LLP;ATTN: Patent Group, Suite 1100, 777 - 6th Street, NW, WASHINGTON, DC, 20001, US

(73) Assignee: FIDIDEL, INC., San Jose, CA (US)

(21) Appl. No.: 12/181,185

(22) Filed: Jul. 28, 2008

Related U.S. Application Data
(60) Provisional application No. 60/952,159, filed on Jul. 26, 2007.
(60) Provisional application No. 60/974,409, filed on Sep. 21, 2007.
(60) Provisional application No. 61/016,782, filed on Dec. 26, 2007.

(51) Int. Cl. G06Q 30/00; G06Q 10/00

(52) U.S. Cl. 705/80; 705/9; 705/26

(57) ABSTRACT

An online negotiations system including hardware and software, may be configured to direct or outsource online negotiations, in real or near-real time, for goods and services listed and described on an online site. Outsourcing of negotiations may be managed to provide an agent to negotiation on behalf of a seller with respect to a listed item, wherein agents are typically managed and allocated independently of sellers by an online negotiations management system including an outsourcing management module having a central queue.

### CROSS REFERENCE TO RELATED APPLICATIONS

This application claims priority under 35 U.S.C. § 119(e) to U.S. Provisional Patent Application Ser. No. 60/952,159, entitled SYSTEMS AND METHODS FOR ONLINE SALES NEGOTIATIONS, filed Jul. 26, 2007, to U.S. Provisional Patent Application Ser. No. 60/974,409, entitled SYSTEMS AND METHODS FOR ONLINE SALES NEGOTIATIONS, filed Sep. 21, 2007, and to U.S. Provisional Patent Application Ser. No. 61/016,782, entitled SYSTEMS AND METHODS FOR EMAIL BASED DELIVERY OF NEGOTIATIONS SOLICITATIONS, filed Dec. 26, 2007. The content of each of these applications is hereby incorporated by reference herein in its entirety for all purposes.

### FIELD OF THE INVENTION

This invention relates generally to online sales transactions. More particularly but not exclusively, this invention relates to systems and methods for providing real or near real time online sales negotiations between buyers and sellers where sellers may be represented by an outsourced pool of negotiators denoted as agents and offered products may be promoted by a pool of promoters.

### BACKGROUND

The growth of the Internet has led to a wide range of applications supporting online sales transactions (also denoted herein as e-commerce). Among these applications, a number are directed towards providing online auction functionality, which enables sellers to list items for sale and buyers to enter a bid for the item in an auction format or even purchase the item outright at a specific preset price. The most popular currently available online auction site is known as Ebay, provided at www.ebay.com.

In a typical Ebay auction style transaction, a seller posts an item for sale in an online listing for a limited period of time with a fixed starting and ending time. The item listing typically includes an auction duration, starting price, an optional reserve price, as well as an optional buy-it-now price (at which the potential buyer can purchase the item instantly). Buyers can then enter bids for the items at any time prior to the close of the auction. If a buy-it-now price is included in the listing, a potential buyer can purchase the item by selecting a menu button associated with that option; however, in a normal listing the auction ends with the highest bidder at the time of auction close being the winner/purchaser (assuming the reserve price is met in cases where a reserve price is set).

While this approach to online selling has proven to be very attractive, for popular items it is often the case that there are many potential buyers watching the item, and buyers often wait until the final minutes or even seconds before the auction closes to submit their bids. There are also applications known as “sniping” programs that make last minute bids on behalf of a bidder to attempt to secure an item at the last possible time in the auction. Example sniping programs can be downloaded from web sites such as www.auctionsage.com.

These last-second bids can result in buyers who are unable to place a bid near the close of the auction being shut out, even if the potential buyer has been the highest bidder for most of the open auction period. Moreover, while a bidder can typically enter a maximum bid amount during an auction on Ebay, it is often the case that a bidder may desire to increase his or her bid if the auction goes over that amount. If, however, the potential buyer is unable to access the auction site at or near the time of auction closing, he or she may be unable to raise the bid. In addition, in auctions where there is a last minute rush of bids, some bidders may be coerced into overbidding for an item in order to avoid getting outbid. In some cases unscrupulous sellers may even take advantage of bidders by providing last minute shill bidders to raise prices.

Currently available e-commerce sites lack the facility to provide for an online negotiations process allowing a potential buyer and seller or seller's agent to interact, in real or near real time, to attempt to reach agreement on a sales price. Consequently, there is a need in the art for alternate approaches for providing online sales transactions that may provide benefits to both buyers and sellers in reaching agreement on an acceptable purchase price while allowing direct interactions through negotiation.

### SUMMARY

The present invention is related generally to systems and methods for providing online negotiations to facilitate online sales transactions.

In one aspect, the present invention is directed to a computer implemented method for providing an online sales negotiation, comprising receiving, from a first buyer, a request to negotiate for a first item of a plurality of items offered for sale, assigning, responsive to the request to negotiate, a first negotiator to a first negotiation session with the first buyer, for purchase of the first item, and providing a user interface to the first buyer to facilitate the first negotiation session; wherein the request to negotiate is provided in response to a listing of ones of said plurality of items offered for sale.

In another aspect, the present invention is directed to a system for facilitating online negotiations, comprising a processor, a memory coupled to the processor, and a machine readable medium including a set of instructions for execution on the processor to facilitate a listing of ones of a plurality of items offered for sale, receive, from a first buyer, receive a request to negotiate for a first item of said plurality of items offered for sale, assign, responsive to the request to negotiate, a first negotiator to a first negotiation session with the first buyer, for purchase of the first item, and provide a user interface to the first buyer to facilitate the first negotiation session.

In another aspect, the present invention is directed to a computer implemented method for providing an online sales negotiation on a third party web site, comprising providing a user interface, on the third party web site, disposed to receive a request from a first buyer to negotiate for purchase of a first item of a plurality of items offered on the third party web site by a first seller, wherein said first seller is associated with the third party web site, receiving, from the first buyer, a request to negotiate for the first item, assigning, responsive to the request to negotiate, a first negotiator to a first negotiation session with the first buyer, for purchase of the first item and providing a user interface, on the third party web site, to the first buyer to facilitate the first negotiation session.

In another aspect, the present invention is directed to a computer implemented method for providing an online sales negotiation, comprising receiving, from a first buyer, a request to negotiate for a first item of said plurality of items offered for sale, providing a user interface to the first buyer to facilitate the first negotiation session, and providing, from an expert system, a response to the request to negotiate for a first sale item; wherein the request to negotiate is provided in response to a listing of ones of said plurality of items offered for sale.

In another aspect, the present invention is directed to a processor readable medium containing instructions that when executed on a processor receive, from a first buyer, a request to negotiate for a first item of a plurality of items offered for sale, assign, responsive to the request to negotiate, a first negotiator to a first negotiation session with the first buyer, for purchase of the first item, and provide a user interface to the first buyer to facilitate the first negotiation session.

In another aspect, the present invention is directed to a method of assigning agents in support of outsourced negotiations, comprising receiving, from a first buyer, a request to negotiate for a first item of a plurality of items offered for sale, assigning, responsive to the request to negotiate, a first agent to a first negotiation session with the first buyer, for purchase of the first item, and providing a user interface to the first buyer to facilitate the first negotiation session; wherein the request to negotiate is provided in response to a listing of ones of said plurality of items offered for sale.

Additional aspects of the present invention are further described below with respect to the appended drawings.

### BRIEF DESCRIPTION OF THE DRAWINGS

The invention is more fully appreciated in connection with the following detailed description taken in conjunction with the accompanying drawings, wherein:

FIG. 1 illustrates a representative distributed network system whereupon embodiments of the present invention may be implemented.

FIG. 2a is flowchart illustrating an embodiment of a process for providing outsourced online negotiations in accordance with aspects of the present invention.

FIG. 2b is flowchart illustrating an embodiment of a process for providing direct online negotiations in accordance with aspects of the present invention.

FIG. 3 illustrates an embodiment of an online negotiations system in accordance with aspects of the present invention.

FIG. 3b illustrates an embodiment of a negotiator assignment process in accordance with aspects of the present invention.

FIG. 3c illustrates an embodiment of a negotiator assignment process in accordance with aspects of the present invention.

FIG. 4 is a flowchart illustrating an embodiment of an online negotiations process and associated process management in accordance with aspects of the present invention.

FIG. 5 is an illustration of an embodiment of a central queue in accordance with aspects of the present invention.

FIG. 6 is a flowchart illustrating an embodiment of an online negotiations process and associated process management in accordance with aspects of the present invention.

FIG. 7 is a flowchart illustrating an embodiment of a user registration process in accordance with aspects of the present invention.

FIG. 8 is a screen shot of an embodiment of a sale item listing in accordance with aspects of the present invention.

FIG. 9 is a screen shot of an embodiment of an item listing in accordance with aspects of the present invention.

FIG. 10 is a screen shot of an embodiment of a seller web page in accordance with aspects of the present invention.

FIG. 11 is a screen shot of an embodiment of a buyer selection web page in accordance with aspects of the present invention.

FIG. 12 is a screen shot of an embodiment of a buyer personalized web page in accordance with aspects of the present invention.

FIG. 13 is a screen shot of an embodiment of a registration web page in accordance with aspects of the present invention.

FIG. 14 is a screen shot of an embodiment of process flow in accordance with aspects of the present invention.

FIG. 15 illustrates details of an embodiment of aspects of the present invention as may be provided in an outsourcing management module.

FIG. 16 illustrates details of an embodiment of a sales promotion process in accordance with aspects of the present invention.

FIG. 17 illustrates details of an embodiment of standard negotiations screen view in accordance with aspects of the present invention.

FIG. 18 illustrates an embodiment of an agent screen view in accordance with aspects of the present invention.

FIG. 19 illustrates an embodiment of a home page screen view in accordance with aspects of the present invention.

FIG. 20 illustrates an embodiment of a promoter sign up screen view in accordance with aspects of the present invention.

FIG. 21 illustrates an embodiment of a negotiations module screen view in accordance with aspects of the present invention.

FIG. 22 illustrates an embodiment of a product/item screen view in accordance with aspects of the present invention.

FIG. 23 illustrates an embodiment of an outsourced negotiations screen view accessible to a seller, in accordance with aspects of the present invention.

FIG. 24 illustrates an embodiment of an agent testing and certification process in accordance with aspects of the present invention.

FIG. 25 illustrates an embodiment of an outsourcing processing workflow in accordance with aspects of the present invention.

FIG. 26 illustrates an embodiment of an electronic message in accordance with aspects of the present invention.

FIG. 27a illustrates an embodiment of a system to facilitate generation of an electronic message as illustrated in FIG. 26, in accordance with aspects of the present invention.

FIG. 27b illustrates an embodiment of a system to facilitate generation of an electronic message as illustrated in FIG. 26, in accordance with aspects of the present invention.

FIG. 28 illustrates an embodiment of a process for enabling online negotiations in accordance with aspects of the present invention.

FIG. 29 is a screen shot of an embodiment of a user access view in accordance with aspects of the present invention.

FIG. 30 is a screen shot of an embodiment of a user information view in accordance with aspects of the present invention.

FIG. 31 is a screen shot of an embodiment of a user log-in view in accordance with aspects of the present invention.

FIG. 32a is a screen shot of an embodiment of an item listing view in accordance with aspects of the present invention.

FIG. 32b is a screen shot of an embodiment of a store view in accordance with aspects of the present invention.

FIG. 33 is a screen shot of an embodiment of a detailed item view in accordance with aspects of the present invention.

FIG. 34 is a screen shot of an embodiment of a negotiation assignment view in accordance with aspects of the present invention.

FIG. 35 is a screen shot of an embodiment of an interactive negotiations view in accordance with aspects of the present invention.

FIG. 36 is a screen shot of an embodiment of an interactive negotiations view in accordance with aspects of the present invention.

FIG. 37 is a screen shot of an embodiment of an interactive negotiations view in accordance with aspects of the present invention.

FIG. 38 is a screen shot of an embodiment of a seller acceptance view in accordance with aspects of the present invention.

FIG. 39 is a screen shot of an embodiment of a transaction payment view in accordance with aspects of the present invention.

FIG. 40 is a screen shot of an embodiment of a payment view in accordance with aspects of the present invention.

FIG. 41 is a screen shot of an embodiment of an unpaid items list view in accordance with aspects of the present invention.

FIG. 42 is a screen shot of an embodiment of a payment confirmation view in accordance with aspects of the present invention.

FIG. 43 is a screen shot of an embodiment of a user account information and negotiation history view in accordance with aspects of the present invention.

FIG. 44 is a screen shot of an embodiment of a negotiation history view in accordance with aspects of the present invention.

FIG. 45 is a screen shot of an embodiment of a purchased items view in accordance with aspects of the present invention.

FIG. 46 in an embodiment of a user feedback view in accordance with aspects of the present invention.

### DETAILED DESCRIPTION OF EMBODIMENTS OF THE INVENTION

The present invention is generally related to online sales transactions. More particularly, but not exclusively, the invention relates to systems and methods for online negotiation of sales transactions including systems and methods for providing outsourced real time or near real time negotiation between buyers and sellers either directly or through use of a plurality of outsourced agents representing sellers and/or wherein products for sale may be promoted by a pool of promoters (denoted herein as “promoters”).

Near real time negotiation may include various time periods for completing or attempting to complete negotiated transactions between buyers, sellers, agents and/or promoters. For example, near real time negotiation may include a time period wherein a buyer offers a purchase price or counter-offer in relation to an item offered for sale by the seller, the seller considers the price offered by the buyer, the seller responds with a counter-offer or other reply, the buyer considers the counter-offer or other reply, the buyer responds with an acceptance or other counter-offer or reply, and so on.

In one aspect, the present invention is directed to a computer implemented method for providing an online sales negotiation, comprising receiving, from a first buyer, a request to negotiate for a first item of a plurality of items offered for sale, assigning, responsive to the request to negotiate, a first negotiator to a first negotiation session with the first buyer, for purchase of the first item, and providing a user interface to the first buyer to facilitate the first negotiation session; wherein the request to negotiate is provided in response to a listing of ones of said plurality of items offered for sale.

In another aspect, the present invention is directed to a system for facilitating online negotiations, comprising a processor, a memory coupled to the processor, and a machine readable medium including a set of instructions for execution on the processor to facilitate a listing of ones of a plurality of items offered for sale, receive, from a first buyer, receive a request to negotiate for a first item of said plurality of items offered for sale, assign, responsive to the request to negotiate, a first negotiator to a first negotiation session with the first buyer, for purchase of the first item, and provide a user interface to the first buyer to facilitate the first negotiation session.

In another aspect, the present invention is directed to a computer implemented method for providing an online sales negotiation on a third party web site, comprising providing a user interface, on the third party web site, disposed to receive a request from a first buyer to negotiate for purchase of a first item of a plurality of items offered on the third party web site by a first seller, wherein said first seller is associated with the third party web site, receiving, from the first buyer, a request to negotiate for the first item, assigning, responsive to the request to negotiate, a first negotiator to a first negotiation session with the first buyer, for purchase of the first item and providing a user interface, on the third party web site, to the first buyer to facilitate the first negotiation session.

In another aspect, the present invention is directed to a computer implemented method for providing an online sales negotiation, comprising receiving, from a first buyer, a request to negotiate for a first item of said plurality of items offered for sale, providing a user interface to the first buyer to facilitate the first negotiation session, and providing, from an expert system, a response to the request to negotiate for a first sale item; wherein the request to negotiate is provided in response to a listing of ones of said plurality of items offered for sale.

In another aspect, the present invention is directed to a processor readable medium containing instructions that when executed on a processor receive, from a first buyer, a request to negotiate for a first item of a plurality of items offered for sale, assign, responsive to the request to negotiate, a first negotiator to a first negotiation session with the first buyer, for purchase of the first item, and provide a user interface to the first buyer to facilitate the first negotiation session.

In another aspect, the present invention is directed to a method of assigning agents in support of outsourced negotiations, comprising receiving, from a first buyer, a request to negotiate for a first item of a plurality of items offered for sale, assigning, responsive to the request to negotiate, a first agent to a first negotiation session with the first buyer, for purchase of the first item, and providing a user interface to the first buyer to facilitate the first negotiation session; wherein the request to negotiate is provided in response to a listing of ones of said plurality of items offered for sale.

Additional aspects of the present invention are further described below with respect to the appended drawings. In the description and drawings which follow, like elements are marked throughout the specification and the drawings with the same respective reference designators unless indicated otherwise.

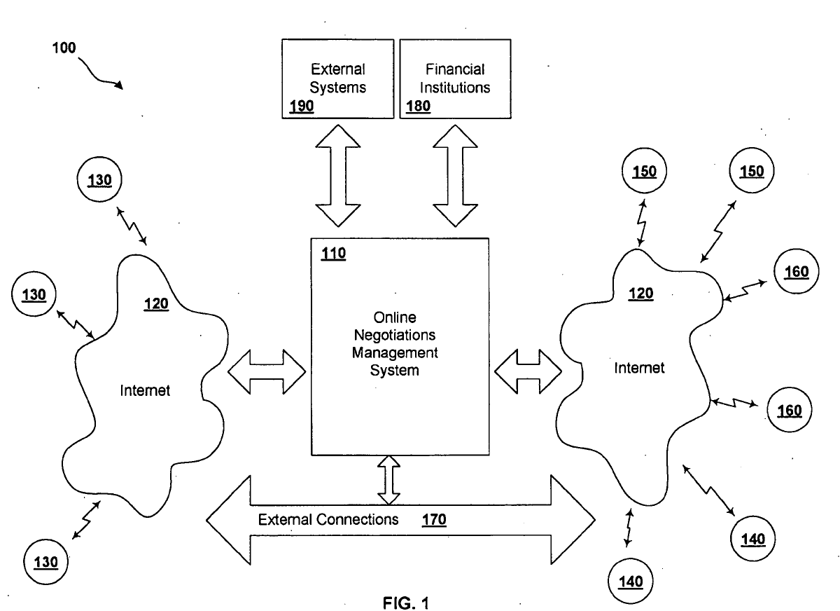

Turning now to the drawings, FIG. 1 illustrates an online negotiations network configuration 100 upon which embodiments of the present invention may be implemented. As shown in FIG. 1, a negotiations management system (also denoted herein for brevity as a “management system”) 110 may be configured to interface with a plurality of other devices and/or associated users, and/or outside financial institutions, and/or merchants, wherein the users, devices, merchants and financial institutions typically access management system 110 through a distributed network 120, such as the Internet.

It is envisioned that embodiments of a system in accordance with the present invention will be provided under the service mark FIDIDEL and/or FIDIDEL CENTRAL. Such an online negotiations management system and associated service, also denoted herein as a “Fididel System” and “Fididel Service,” and/or “Fididel Central,” may be provided to employ functionality as is described herein. The Fididel Service may be configured and operative in conjunction with the Fididel System to provide for collection of commissions, listing fees, advertising fees, and/or other fees associated with items offered for sale and subsequently completed sales transactions. These fees collected by the Fididel Service may include, but are not limited to, listing insertion fees charged to sellers, sales commission fees charged to sellers, buyer's premium fees charged to buyers, other seller fees, fees associated with agents and charged to agents, and advertising fees such as fees charged to insert advertising content, banners, and the like onto Fididel System web pages or other media. Similar systems and/or functionality may also be provided to outside entities, such as online merchants, so as to enable the outside entities to provide similar functionality, in whole or in par, as is described herein through their own and/or others' online sites.

In a typical embodiment of the present invention four general categories of users and their associated network access devices or systems may be supported. These four user categories are denoted herein as buyers 130, sellers 140, agents 150 and promoters 160. Buyers 130 are persons or entities interested in purchasing items offered for sale, sellers 140 are persons or entities listing items for sale, agents 150 are persons or entities authorized to negotiate for the sale of listed items on behalf of sellers 140 and promoters 160 are persons or entities that promote a sales transaction of items listed by sellers 140. Seller 140 and agents 150 may be allowed to act as negotiators with buyers, where agents 150 may be selected and assigned to act on behalf of sellers 140 as is described in further detail herein. Additional users, such as system administrators, system managers, merchants or other third party users may also be supported.

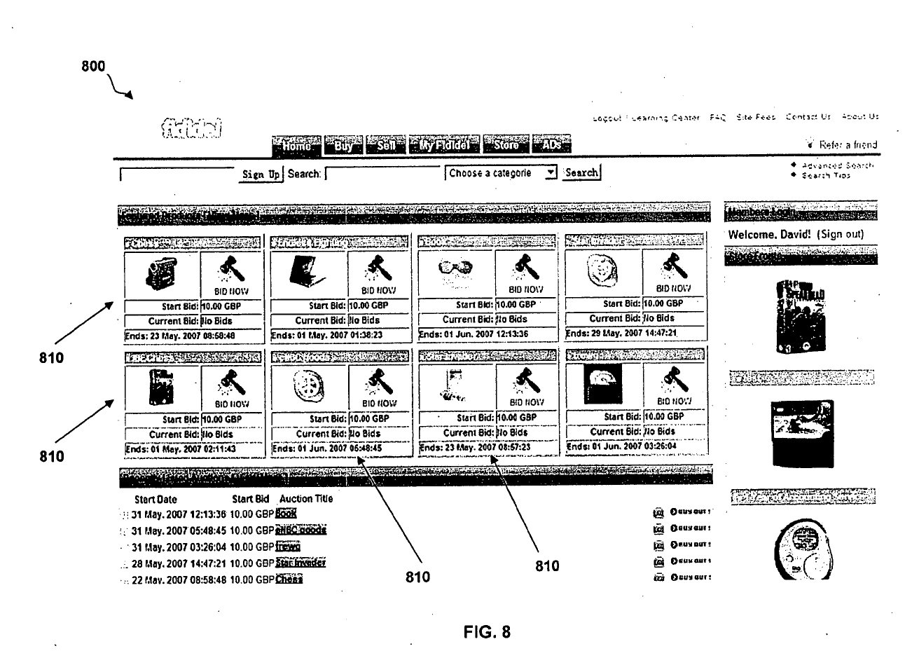

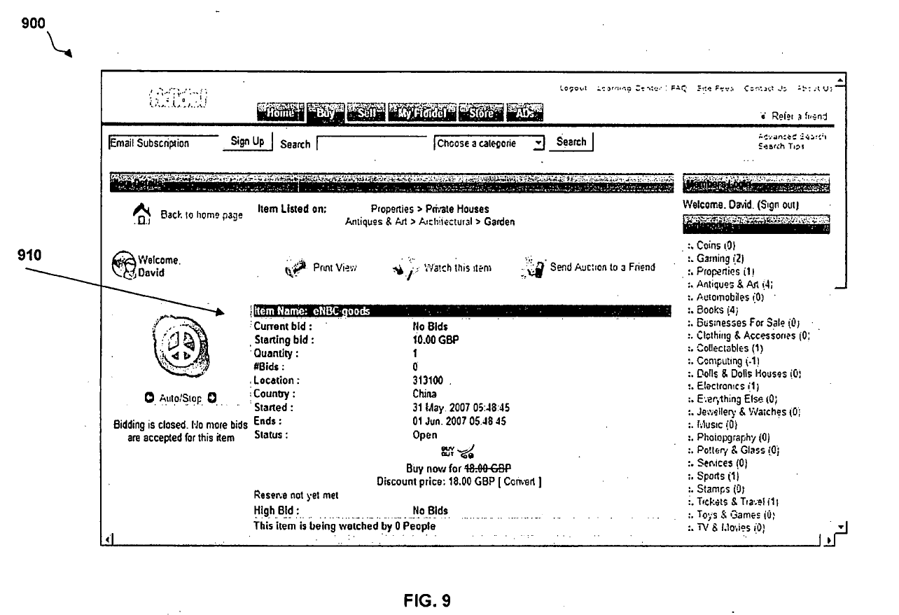

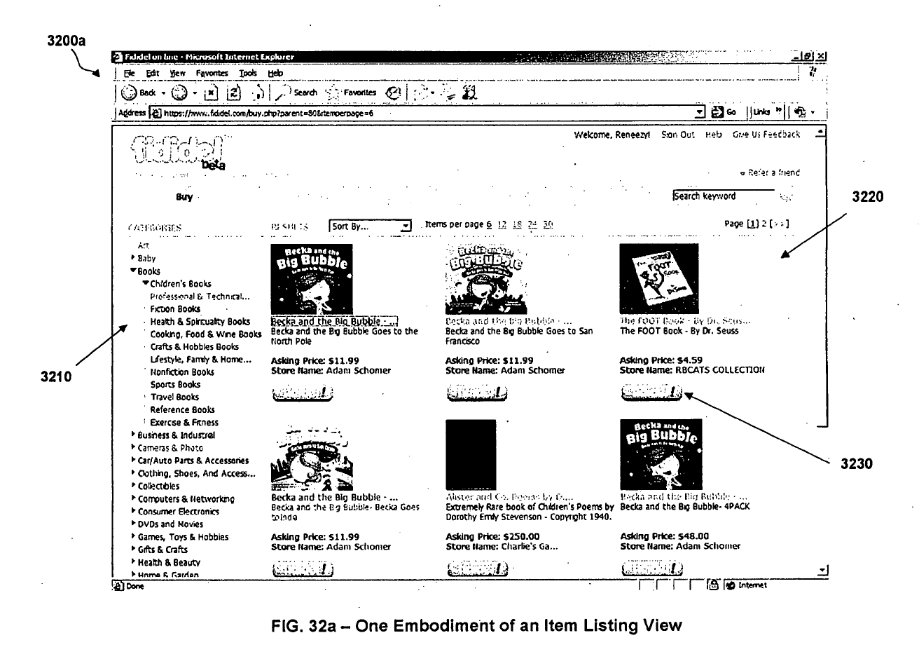

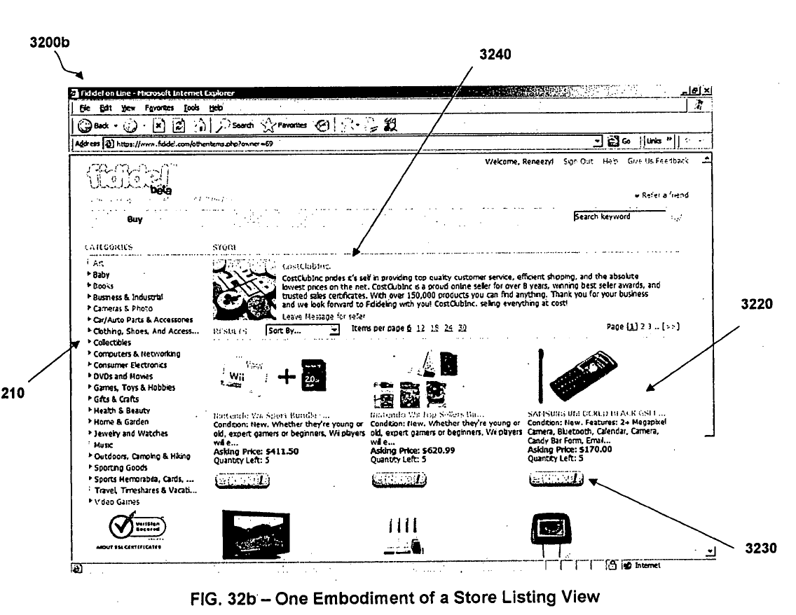

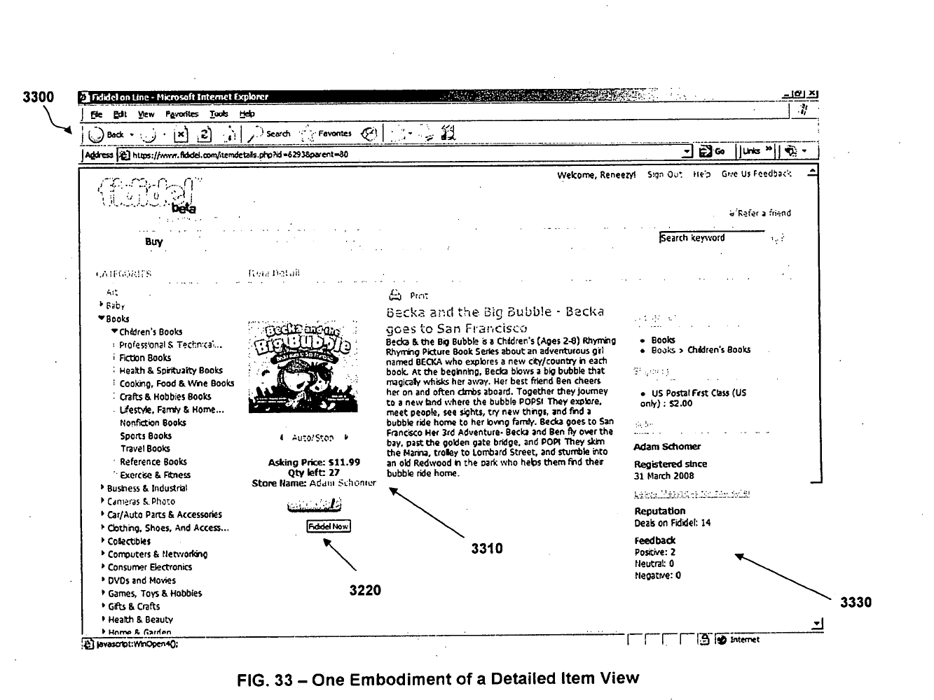

An online site providing negotiations capabilities such as those described herein may also be denoted generically herein as a “negotiations site.” Typical negotiation sites may be implemented as a web page or via a similar presentation format, over wired or wireless networks. Negotiations sites may be configured to be accessed by personal computers such as desktop or mobile computers, notebook computers, as well as over web-enabled cellular phones, PDAs, or other types of wired or wireless devices using web browsers or other types of network browsing applications. A typical negotiations site will include a wide variety of items listed for sale. For example, FIG. 8, FIG. 32a and FIG. 32b are example screen shots of listings of sales items as provided by embodiments of a negotiations site and associated negotiations management system in accordance with aspects of the present invention, and FIG. 9 and FIG. 33 are example screen shots of listing details for specific sales item on such a site.

In various embodiments, sales listings on negotiations sites may be made accessible to buyers via fixed devices such as desktop computers, or via mobile devices such as portable computers, cellular phones, PDAs or other mobile devices. Likewise, negotiations may be supported and facilitated over wired or wireless networks on fixed or mobile devices. Negotiations carried out in conjunction with such sites are typically done in real or near-real time, allowing buyers to interact with sellers and/or agents in a direct, personalized fashion, with minimum latency between buyer and seller responses. This interaction may be managed and controlled by the systems and methods described herein so that buyers and agents can provide one or more of a specific or predefined set of responses, and/or may be able to provide specific, individualized responses, such as comments and specific price offers and terms and/or counteroffers.

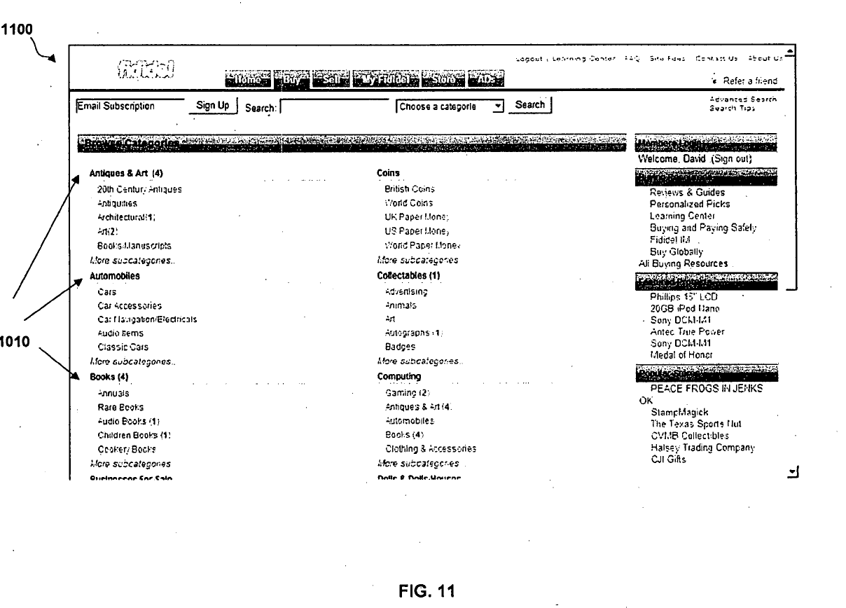

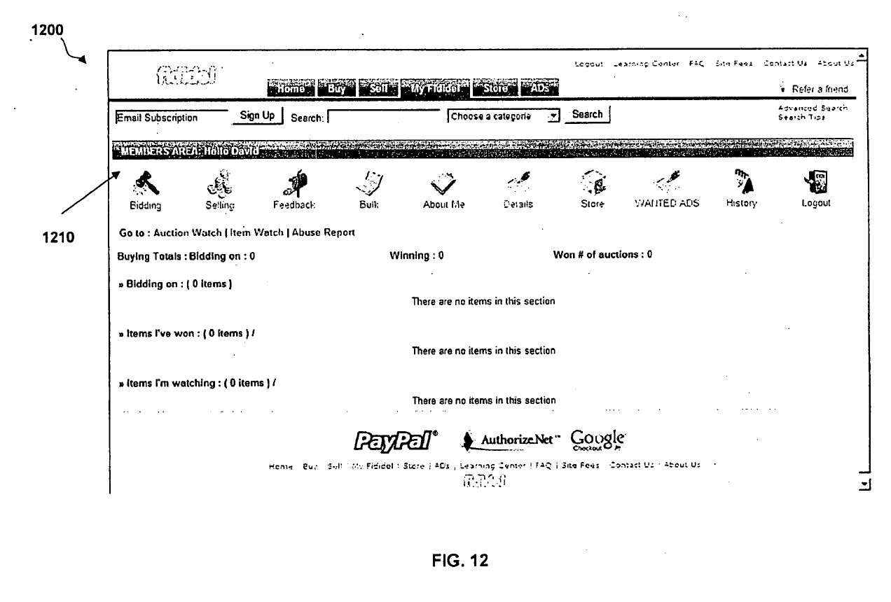

Potential buyers 130 (also denoted herein for brevity as “buyers 130”) are individuals or entities wishing to purchase goods or services listed at a negotiations site, such as those sales items illustrated in FIG. 9 and FIG. 33 and/or others listed on a negotiations site such as an online Internet web site, wireless accessible site such as a WAP site, or other type of networked site. Buyers 130 may be provided with one or more web pages or other displays, such as those shown in FIG. 11, FIG. 12, FIG. 32a and FIG. 32b, to allow buyers 130 to search the negotiations site for sale items of interest and/or personalize their search or purchasing experience.

Sellers 140 are individuals or entities wishing to sell goods or services (also denoted herein as sales items) online at a negotiations site. Sellers may choose to list or display their sales items at a negotiations site in the form of a listing on a web page or via a similar presentation format, wherein the listed information may be accessible over wired or wireless networks. FIG. 32b illustrates a screen shot of a seller sale item listing page as provided by one embodiment of the present invention. In addition, sellers 140 may be provided with display screens, search engines and/or other means to search for buyers 130 to purchase sale items listed by the sellers 140.

Agents 150 are individuals or entities that act on behalf of sellers 140 to negotiate a sales transaction with buyers 130. Agents are typically different than sellers; however, in some embodiments sellers may be enabled to act on their own behalf and/or may share negotiation responsibility with one or more agents and/or may nominate or designate specific agents to act on their behalf. Agents 150 interact with buyers 130 using, at least in part, wired or wireless networks to negotiate sales transactions.

In some embodiments, functionality of agents 150 as described herein may be implemented in whole or part by computer based expert systems in conjunction with, or separate from, natural persons. In such embodiments, expert systems may be configured to interact with potential buyers in a transparent, human-like fashion, so that the potential buyer is unaware of whether he or she is interacting with another person or with an expert system.

Promoters 160 may act either independently of or on behalf of sellers 140 to promote sales transactions with prospective buyers 130. Promoters 160 may take one or more of various actions when promoting sales transactions, including disclosing buyer information to sellers 140 and/or disclosing seller information, such as listed sale item information or other seller information, to prospective buyers 130. In some embodiments, disclosure of buyer information is not permitted because identities and/or information related to prospective buyers 130 is not made available to sellers 140.

Promoters 160 may also be provided with the ability to attach information, such as a picture, sales information, etc., related to a sales item offered by a seller 140 to another site, such as a blog, MySpace web page, Facebook web page, Craigslist web page, or any other web page or other sales facilitation mechanism provided for advertising the product to buyers 130 (herein denoted as a “web forum”). Attachment of information related to the sales item may be achieved by various means, including copying sales information and pasting it into the web forum, clicking on the sales information to link it to the web forum, and/or other means known or developed in the art for attaching information. In addition, when viewing a page displaying one or more sales items offered by a seller 140, a promoter 160 may be provided with a view or screen including a selection of options, such as may be provided by a pull-down menu of options, that allow the promoter 160 to attach information related to a sales item to his or her web forum, copy the URL of the Fididel web page presenting the sales item, and/or perform other operations that may assist the promoter 160 in promoting one or more sales items offered by the seller 140.

Promoters 160 may alternatively and/or additionally advertise one or more sales items using standard and/or web-based advertising campaigns known or developed in the art. For example, promoters 160 using web-based advertising may purchase advertisement space on web pages, purchase search engine keywords, send out cell phone text messages and/or send out email messages to buyers 130. Alternatively, promoters 160 using standard advertising may purchase advertisement space on billboards and in periodicals, among other advertising forums. Web-based advertisements may lead a viewer/prospective buyer 130 directly to the Fididel web page presenting the sales items or to a web forum of a promoter 160. Standard advertisements may instruct a viewer/prospective buyer 130 to visit the Fididel web page presenting the sales items, or to a web forum of a promoter 160.

Promoters 160 are typically different than sellers 140; however, in some embodiments sellers 140 may be enabled to promote sales transactions of their listed sales items to prospective buyers 130. Promoters 160 are also typically different than agents 150; however, in some embodiments, agents 150 may be enabled to promote sales transactions in a manner similar to that of promoters 160.

In typical embodiments, promoters 160 interact with prospective buyers 130 and sellers 140 using wired or wireless networks to promote sales transactions. In some embodiments, functionality of promoters 160 as described herein may be implemented in whole or part by computer based expert systems in conjunction with, or separate from, natural persons. In such embodiments, expert systems may be configured to interact with prospective buyers 130 and sellers 140 in a transparent, human-like fashion, so that the prospective buyer 130 is unaware of whether he or she is interacting with another person or with an expert system.

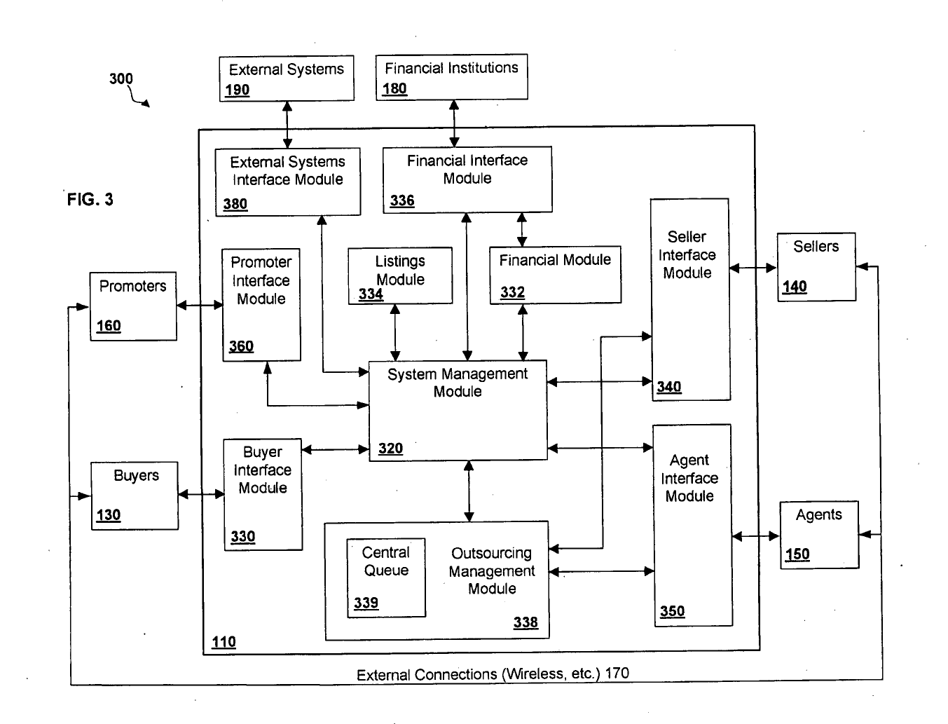

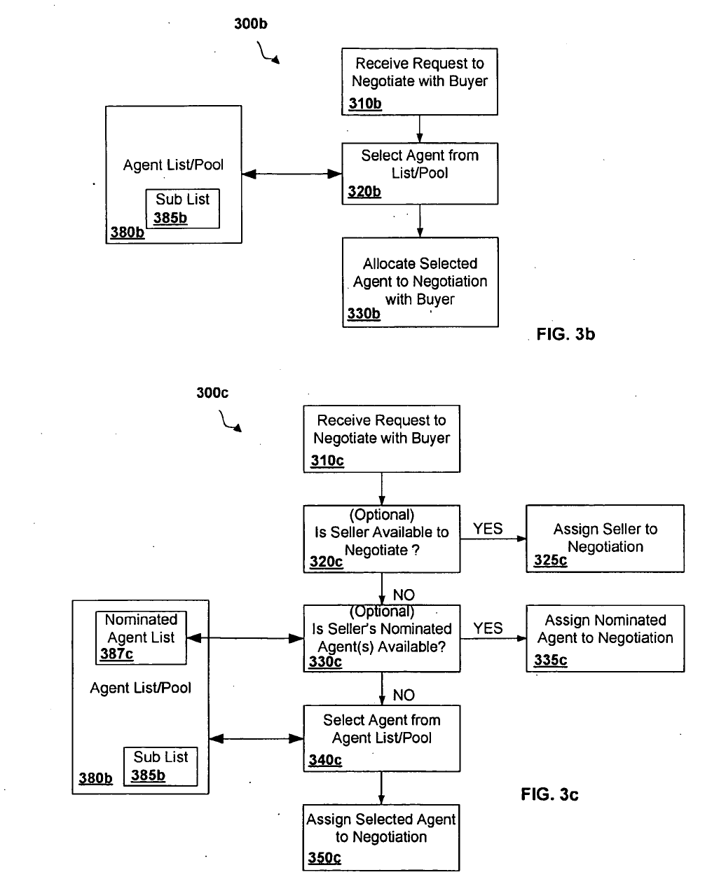

Management system 110 may include one or more modules comprising hardware, software, and/or combinations of hardware and software to implement the functionality described above as well as other functionality as is further described below. Such modules may include one or more software programs with instructions stored on a computer readable medium, such instructions configured to be executed by one or more processors and other hardware on one or more computer systems. Additional details of embodiments of such modules are illustrated and described in further detail below in conjunction with FIG. 3.

In a typical embodiment, management system 110 includes interface modules to interface with ones of a plurality of buyers 130, a plurality of sellers 140, a plurality of agents 150 and/or a plurality of promoters 160. These interfaces are typically implemented in conjunction with the Internet, and may include software stored on a computer readable medium with instructions configured to be executed by one or more processors, along with wired or wireless elements providing or facilitating connectivity to fixed devices such as desktop or mobile computers or other computer-like devices, portable devices such as cell phones, personal digital assistants (PDAs), or other similar wired or wireless devices. In addition, management system 110 may provide for or facilitate coordination of any related external communications between buyers, sellers, agents and/or promoters through one or more external connections 170, such as by cell phones, PDAs, or other portable devices operating in conjunction with wired or wireless network service providers such as cellular carriers.

Management system 110 may further include one or more modules to receive, store, manage, and display information related to items or services offered for sale by the sellers 140, as well as providing one or more graphical user interfaces (GUI) accessible to the buyers 130, sellers 140, and agents 150 for transacting sales. Such modules may include software stored on a computer readable medium with instructions configured to be executed by one or more processors on one or more computer systems. Screen shots of exemplary display screens and GUI's provided by embodiments of the invention are shown in FIGS. 8-13 and FIGS. 29-46.

Additional modules may be provided to store financial information associated with buyer 130, sellers 140, agents 150 and/or promoters 160. Such modules may further be configured to interface with outside financial services such as banks or other financial institutions and may include software stored on a computer readable medium with instructions configured to be executed by one or more processors, as well as hardware configured to implement such interfaces. Additional modules may also be provided to interface to other external systems such as servers or systems supporting third party web pages, databases, tools, management systems and/or applications, advertising systems, or other types of external systems, including software stored on a computer readable medium with instructions configured to be executed by one or more processors on one or more computer systems.

In some embodiments, all or part of management system 110 may be linked to, included in, or associated with a third party's online systems so that the interface and functionality is presented by the third party or appears to be presented by the third party, providing potential buyers with the impression that the system is hosted in whole or in part by the third party provider. For example, a merchant's online sales site, such as www.circuitcity.com associated with electronics retailer Circuit City, may incorporate functionality provided by system 110 in whole or part and/or may link in whole or part to an external system providing functionality provided by system 110 so that a potential buyer's interaction with the system 110 appears to be part of the site hosted by Circuit City.

In a typical embodiment, management system 110 provides a system and processes, including hardware and software stored on a computer readable medium with instructions configured for execution on one or more processors, for allowing a seller 140 to list items for sale with one or more sales constraints (such as a minimum price, sales duration, sales transaction promotion authorization and/or other constraints), and for providing the sales items to a plurality of buyers 130 and/or promoters 160 through a web page such as those shown in FIG. 8, FIG. 9, FIG. 32a and FIG. 32b or via other formats. A buyer 130 may view information related to a sales item at a web forum of a seller 140 (such as, for example, a Fididel Seller's web page). If a buyer 130 is interested in negotiating for an item, he or she can indicate an interest in negotiating for purchase of the item, and management system 110 will then determine an appropriate seller/agent and assign the negotiation to a seller 140 and/or agent 150 while providing a medium and communicative connections to facilitate allowing buyers 130 to negotiate with sellers 140 and/or allocated agents 150 in real time or near real time to perform the negotiations in an online or online assisted format.

Alternately, a promoter 160 may promote a sales item to prospective buyers 130 depending on any constraints set by the seller 140 of the sales item. For example, a promoter 160 may advertise sales items on a web forum associated with the promoter 160. A buyer 130 may view information related to a sales item at a web forum of a promoter 160, and then click through to a Fididel web page, such as a seller's web page, for real time or near real time negotiation.

If acceptable terms of sale are agreed upon between the buyer 130 and seller 140 or agent 150, one or more financial transactions may be completed by or in conjunction with management system 110. The financial transactions may include transacting a commission to a promoter 160 for successful promotion of the sales item. In addition, management system 110 may facilitate and/or assist in completing any subsequent actions, such as interacting with external financial institutions 180 such as banks or third party payment systems for debiting or crediting seller, agent, buyer, or Fididel Service accounts, or supporting shipping and receipt of merchandise between seller and buyer. In addition, management system 110 may support one or more databases for collecting, storing, analyzing, presenting, and providing account related information associated with buyers 130, sellers 140, agents 150, promoters 160, a Fididel Service and/or others. Such information may include purchasing or selling history, agent performance history, or other account or transaction related information, negotiations information, personal information, or historical information.

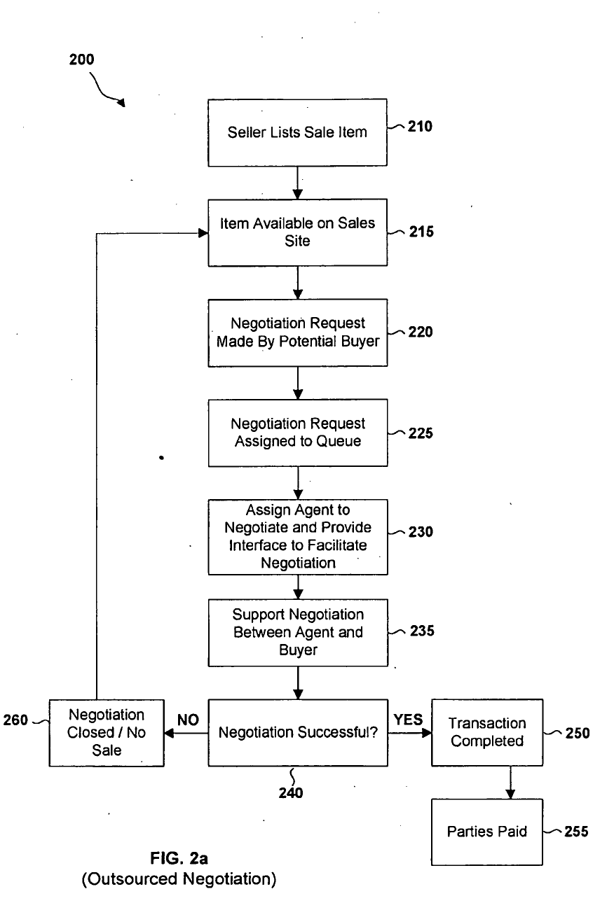

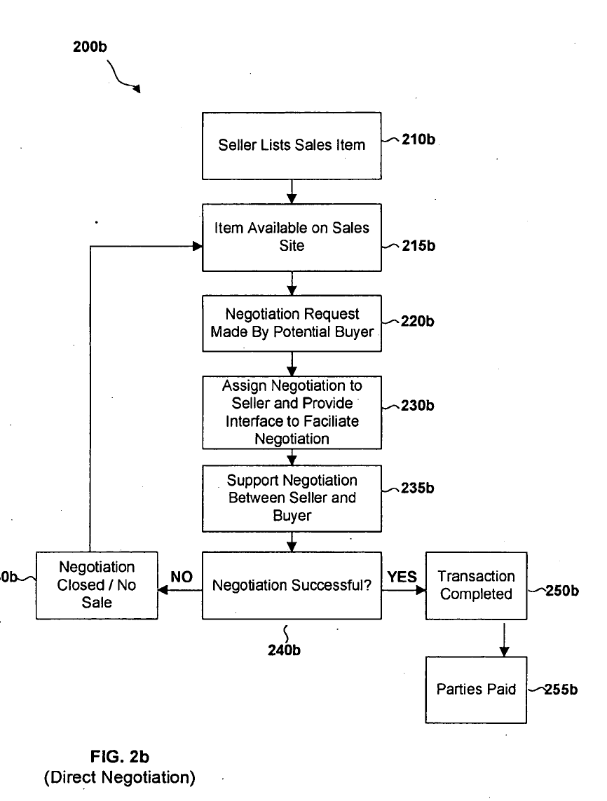

Attention is now directed to FIG. 2a which provides details of an embodiment of an exemplary process 200 enabling online negotiations. Such a process 200 is typically implemented on one or more modules within management system 110, such modules typically including computer software stored on a computer readable medium including instructions configured to be executed by one or more processors on one or more computer systems. It is noted that, while the process illustrated in FIG. 2a includes particular stages, it is apparent that other processes including fewer, more, or different stages than those shown in FIG. 2a are within the spirit and scope of the present invention. Accordingly, the process shown in FIG. 2a is provided for purposes of illustration, not limitation.

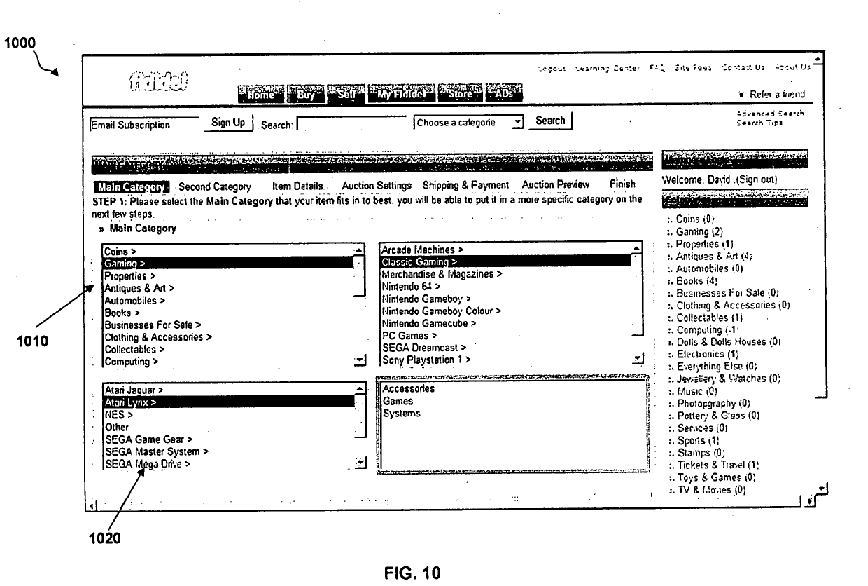

Process 200 may be begin with the seller being provided with options for listing an item for sale at stage 210. This may include, but is not limited to, providing a web page, display screen, user interface, or other means for allowing the seller to list an item for sale and set one or more parameters associated with the sale such as a category, duration, starting price, floor price, ceiling price, other target prices, commission related to each of the prices (if any), photograph or other image of the item, promotion authorization or other text, graphical, audible, or image based details and parameters related to the sale item. FIG. 10 illustrates a screen shot of one such display screen for selecting a category for the sale item, in accordance with an embodiment of the invention.

The sale item may then be listed on a negotiations site at stage 215. The listing may include information related to the sale item provided by the seller as well as other information such as system displays, logos, links to other items or information, banners, advertisements, or other information. The listing typically includes a button, link, or other means of allowing a potential buyer to indicate his or her interest in negotiating for purchase of the item. FIG. 9 and FIG. 33 are screen shots of such a sales item listing as provided by embodiments of the present invention.

The negotiations site may be configured to receive a negotiations request from a buyer 130 at stage 220. This may be done by a button, link, or other means of user actuation as are known or developed in the art. The buyer 130 may be provided with one or more display screens, such as those shown in FIG. 8, FIG. 9, FIG. 32a and FIG. 32b to facilitate viewing and selection of items for negotiation, as well as to indicate interest in negotiating by making a negotiations request. Upon receipt of the negotiations request, it may be assigned to an outsourcing management module 338 and central queue 339 (as shown in FIG. 3) at stage 225, wherein the queue represents a stored list of incoming requests for negotiations that may then be allocated to one or more agents 150.

Once the negotiations request has been received and/or assigned to the central queue 339, an agent or agents 150 may then be assigned to negotiate on behalf of the seller 140 of the sale item at stage 230. This process is denoted generally herein as an “outsourced negotiation.” Agent information and negotiation allocation may be managed by or in conjunction with the outsourcing module 338 and central queue 339 as illustrated and described below with respect to FIG. 3. The central queue 339 may be configured to receive information about agents 150 such as registration information, logon and logoff information, or other information associated with the agent that may be used in determining agent assignment to negotiations.

In a typical embodiment, the agent 150 is generally not known to the seller 140, however, in some embodiments the agent 150 may be a designated representative of the seller 140, or the seller 140 may desire to negotiate directly with the buyer 130. In such a scenario where the seller desires to negotiate directly, denoted herein as a “direct negotiation,” an alternate process as shown in FIG. 2b and further described below may be employed in conjunction with or in place of the process illustrated in FIG. 2a.

Agents 150 are typically assigned to a negotiation at random or based ordering in a list of available agents, by module 338 in conjunction with the central queue 339, with the agent 150 neither required nor permitted to choose which item or items he or she may negotiate for. However, in some embodiments an agent 150 may be a nominated or preferred agent associated with a particular seller or sellers 140 and/or may be associated with negotiations involving a particular type or characteristic of goods based on knowledge, expertise, experience, location, and/or other criteria. Additional details regarding agent allocation are described below with respect to FIG. 3b and FIG. 3c.

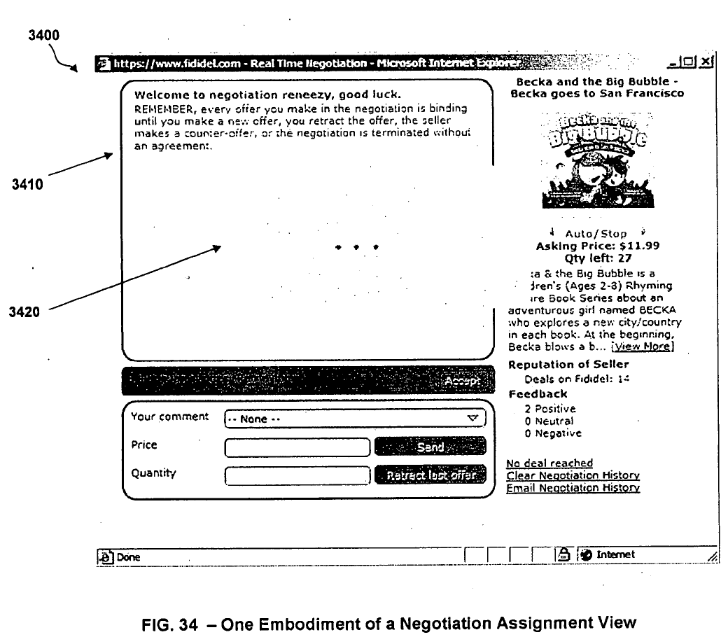

Once an agent 150 is allocated to a buyer 130, the agent 150 and buyer 130 then perform online negotiations at stage 235, with communications, displays, and interactions being managed and supported at least in part by management system 110. Embodiments of screen views facilitating such online negotiations are illustrated in FIGS. 34-38. Interactions between buyers 130 and agents 150 are typically supported and provided through the Internet and management system 110; however, in some embodiments external communications may be facilitated or provided through one or more external connections 170, such as cell phones, PDAs, or other fixed or mobile devices or systems using equivalent or similar portable or mobile device screen displays and user interfaces. For example, in some embodiments management system 110 may facilitate allowing a buyer 130 and agent 150 to communicate directly via wired phones, cellular phones, PDAs, wireless networks such as 802.11 networks, or via other types of wired or wireless communications external to management system 110.

In some embodiments a single agent 150 may be provided to handle a particular negotiations transaction. However, in some embodiments more than one agent 150 may be assigned to manage a negotiation. Where multiple agents 150 are assigned, they may be assigned temporally in parallel and/or temporally in series (i.e. one agent may drop out of a negotiations if, for example, he is unable to continue and/or he feels that he is not making sufficient progress).

Alternately, in some embodiments multiple buyers 130 may be supported by a single agent or plurality of agents 150 in conjunction with a single or multiple sales items. In such a case, management system 110 may facilitate interaction and communications between the multiple buyers 130 and multiple agents 150.

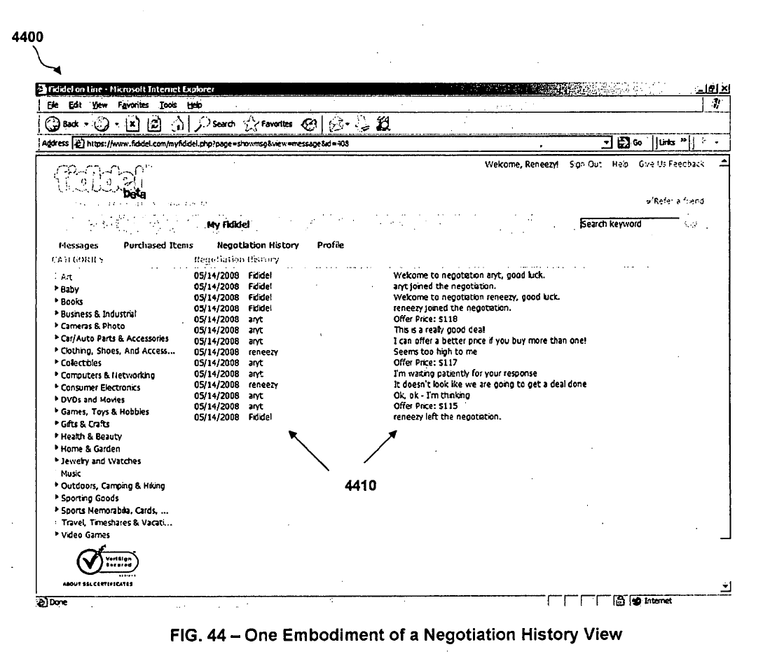

A decision stage may then be reached at stage 240, where a decision is made by the buyer 130, agent 150, buyer 130 and agent 150 in combination, and/or management system 110 to either complete a transaction or end negotiations. If no successful negotiation is reached, the process may then close out the connection between buyer 130 and agent 150 at stage 260, and return to stage 215 where the same or another buyer 130 may then be presented with the sale item. For example, FIG. 44 illustrates an example negotiation script 4410 where a buyer 130 (denoted as reneezy), chose to leave the negotiation after no price was reached, and system 110 (denoted as Fididel) then closes out the negotiation process.

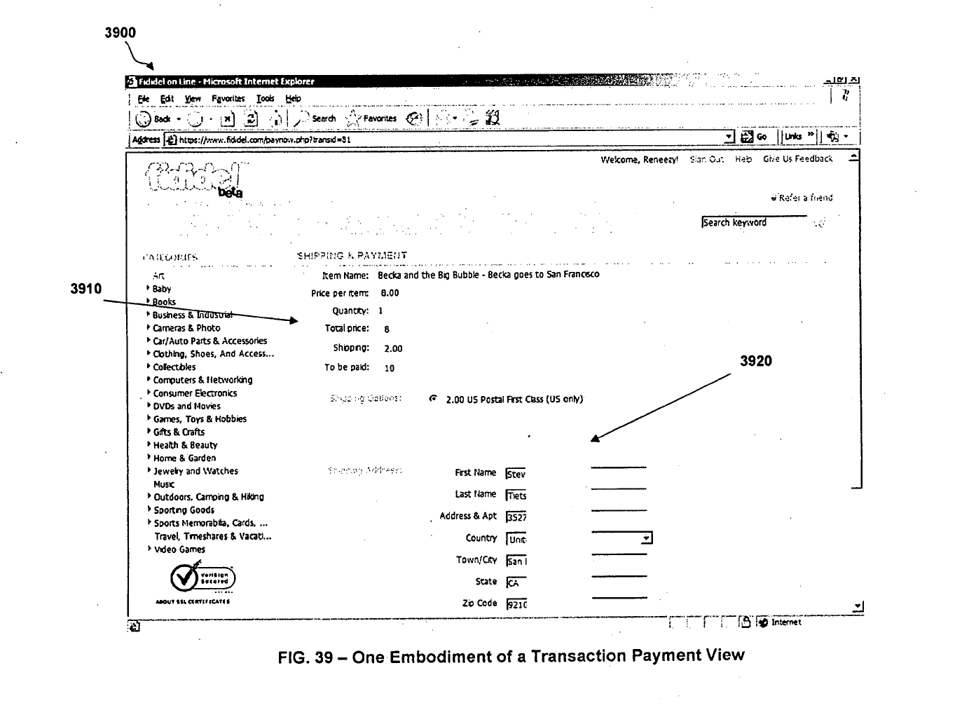

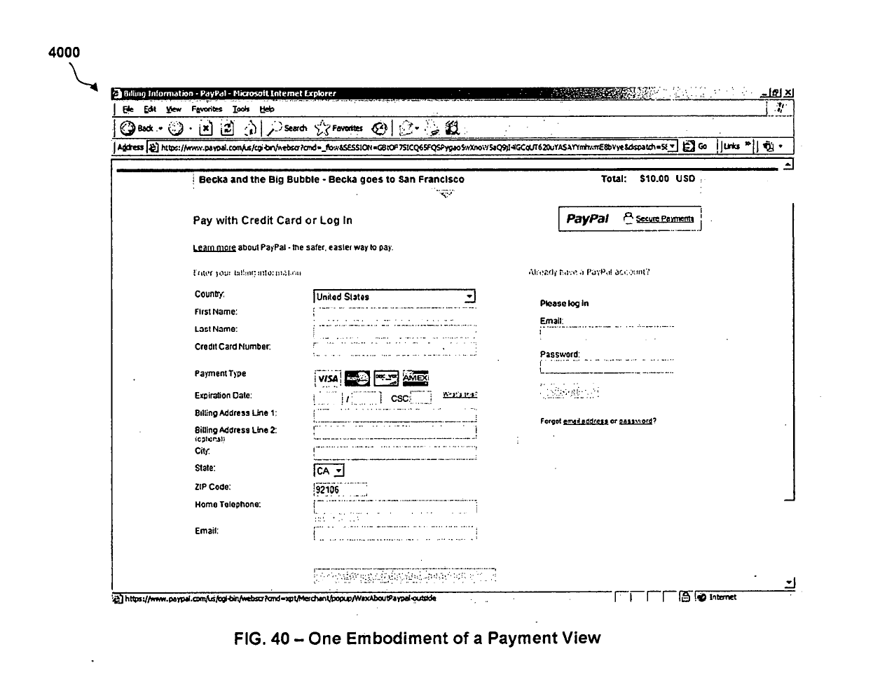

Alternately, if negotiations are successful, the transaction may be completed at stage 250, including finalizing any additional terms and conditions, prompting buyer 130, agent 150 and/or seller 140 for an acknowledgment, and completing any associated financial interactions with modules of management system 110 and/or external financial systems. The seller 140 and agent 150 may then be paid for the item at stage 255, and any associated listing fees, commissions, or other fees related to the transaction may then be debited or credited, including any payments or credits made to a Fididel Service in conjunction with the transaction. FIG. 39 and FIG. 40 illustrate display views for facilitating payment in accordance with an embodiment of the invention.

FIG. 2b illustrates an alternate embodiment to FIG. 2a that supports direct negotiations between buyers 130 and sellers 140. In some embodiments, sellers 140 may be allowed to negotiate directly for their own sales listings. This may be supported by providing, for example, a seller availability schedule on the listing page indicating when a seller 140 is available to negotiate for sales of a particular item. Alternately, direct sales may be facilitated in a form that is transparent to the buyer 130 so that the buyer is unaware that he or she is negotiating with the seller 140, with the seller acting in the capacity of an agent from the buyer's perspective. The process illustrated in FIG. 2b may also be provided as a branch from the process illustrated in FIG. 2a, where availability of the seller 140 to negotiate is tested, such as by web page, email, voicemail, text message or other testing or communication mechanism known or developed in the art, and, if the seller 140 is available, a direct negotiation as shown in FIG. 2b is provided, or if a seller is not available, an outsourced negotiation using an agent 150 as illustrated in FIG. 2a is provided.

Turning now to FIG. 2b, an embodiment of a process 200b is illustrated enabling such direct negotiations. Such a process 200b is typically implemented on one or more modules within management system 110, such modules typically including computer software stored on a computer readable medium with instructions configured to be executed by one or more processors on one or more computer systems. It is noted that, while the process illustrated in FIG. 2b includes particular stages, it is apparent that other processes including fewer, more, or different stages than those shown in FIG. 2b are within the spirit and scope of the present invention. Accordingly, the process shown in FIG. 2b is provided for purposes of illustration, not limitation.

Process 200b may be begin with the seller 140 being provided with options for listing an item for sale at stage 210b. This may include, but is not limited to, providing a web page, display screen, user interface, or other means for allowing the seller to list an item for sale and set one or more parameters associated with the sale such as a duration, starting price, photograph or other image of the item, or other text, graphical, audible, or image based details and parameters related to the sale item. FIG. 10 illustrates a screen shot of one such display screen in accordance with an embodiment of the invention.

The sale item may then be listed on a negotiations site at stage 215b. The listing may include information related to the sale item provided by the seller as well as other information such as system displays, logos, links to other items or information, banners, or other information. The listing typically includes a button, link, or other means of allowing a buyer 130 to indicate his or her interest in negotiating for purchase of the item. FIG. 9 displays a screen shot of such a listing as provided by one embodiment of the present invention.

The negotiations site may be configured to receive a negotiations request from a buyer 130 at step 220b. This may be done by a button, link, or other means of user selection as are known in the art. The buyer 130 may be provided with one or more display screens, such as those shown in FIG. 8, FIG. 9, FIG. 32a or FIG. 32b, to facilitate viewing and selection of items for negotiation, as well as to indicate interest in negotiating by making a negotiations request. Upon receipt of the negotiations request, it may be then be assigned directly to the seller 140 at stage 230b, and a connection may be provided between buyer 130 and seller 140 to facilitate online negotiations. Such an assignment will typically be done outside of central queue 339, however, in some embodiments direct assignments to sellers 140 may be processed or monitored by the central queue 339.

The seller 140 and buyer 130 then perform online negotiations at stage 235b, with connections, communications, displays, and interactions being managed and supported at least in part by management system 110. Interactions between buyers 130 and sellers 140 are typically supported and provided through the Internet and management system 110, however, in some embodiments external communications may be facilitated or provided through one or more external connections 170, such as cell phones, PDAs, or other fixed or portable devices or systems. For example, in some embodiments management system 110 may facilitate allowing a buyer 130 and agent 150 to communicate directly via wired phones, cellular phones, PDAs, wireless networks such as 802.11 networks, or via other types of wired or wireless communication external to management system 110.

A decision stage may then be reached at 240b, where a decision is made by the buyer 130, seller 140, buyer 130 and seller 140 in combination, and/or by management system 110 to either complete a transaction or end negotiations. If no successful negotiation is reached, the process may then close out the connection between buyer 130 and seller 140 at stage 260b, and return to stage 215 where the same or another buyer 130 may then be presented with the sale item.

Alternately, if negotiations are successful, the transaction may be completed at stage 250b, including finalizing any additional terms or conditions, prompting buyer 130 and/or seller 140 for an acknowledgment, and completing any associated financial interactions with modules of management system 110 and/or external financial systems. The seller 140 may then be paid for the item at stage 255b, and any associated listing fees, commissions, or other fees related to the transaction may then be debited or credited, including any payments or credits made to a Fididel Service in conjunction with the transaction.

Attention is now directed to FIG. 3 which illustrates one embodiment of an online negotiation system 300 (such as a Fididel System) including a management system 110 and associated modules. It is noted that the configuration and modules illustrated in FIG. 3 are provided for purposes of illustration and not limitation. Accordingly, other system configurations, including configurations including fewer, more, or different modules and connections are contemplated within the spirit and scope of the present invention.

As illustrated in FIG. 3, management system 110 may include multiple modules. These modules may comprise hardware, software, and/or hardware/software combinations that may reside on one or more computers systems, server systems, or other systems. Software may include instructions stored on a computer readable medium configured to be executed on one or more processors to implement the functionality described below. Such processors may be included within one or more computer systems, and modules comprising management system 110 may be arranged in a distributed configuration to allow for distributed functionality based on networked interconnections between multiple computer systems.

Management system 110 may be configured to interface to buyers 130, sellers, 140, agents 150 and/or promoters 160 as previously discussed. In addition, management system 110 may include interfaces to one or more financial systems 180 and/or other external systems 190. External systems may include systems supporting general Internet access, financial institutions, databases, advertising, development tools and systems, systems monitoring, or other systems providing external functions.

Management system 110 may include one or more interface modules, such as a buyer interface module 330 configured to provide an interface to a plurality of buyers 130, a seller interface module 340 configured to provide an interface to a plurality of sellers 140, an agent interface module 350 configured to provide an interface to a plurality of agents 150, a promoter interface module 360 configured to provide an interface to a plurality of promoters 160, a financial interface module 336 configured to provide an interface to one or more external financial systems such as those provided by banks or other financial institutions, as well as an external systems interface module 380 configured to provide an interface to one or more additional external systems 190.

Management system 110 may also include a system management module 320 configured to provide overall system control as well as interfaces between other modules and buyers 130, sellers 140, agents 150, promoters 160 and/or other systems users such as system or database administrators. System management module 320 typically provides interconnections between other modules as shown in FIG. 3, as well as providing overall system control and operation including managing users, accounts, and overall operation.

Management system 110 may also include an outsourcing management module 338 (also denoted herein as outsourcing module 338 for brevity). Outsourcing module 338 is configured to manage outsourcing of transaction negotiations to agents 150. Functions include, but are not limited to, receiving information on available agents, assigning agents to negotiations, tracking agent performance, correlating agent skills with sales items to match agents to transactions, queuing agents, associating seller designated agents to specific transactions, assigning sellers to negotiations, as well as other functions related to managing and monitoring direct or outsourced negotiation functions. Outsourcing module 338 will typically include a central queue 339. Central queue 339 may alternately be included in an external module, wherein it is communicatively coupled to outsourcing module 338. Central queue 339, in conjunction with outsourcing module 338, provides functionality related to selection and assignment of agents 150 for outsourcing. Central queue 339 typically includes a list or queue of available agents 150 and sales items, and upon receiving a request to negotiation from a buyer 130, processes the request to allocate an agent 150 and/or a seller 140 to negotiate with buyer 130. Additional details of embodiments of processes for facilitating this procedure are provided below with respect to FIG. 3b and FIG. 3c.

Management system 110 may also include a listing module 334 containing information related to items offered for sale by sellers 140. Listings module 334 may be a separate module within management system 110 and/or may be included in other modules such as system management module 320 and/or outsourcing management module 338. Listing module 334 may include a database, a server or servers, storage media, and/or data structures configured to allow loading, storage, access, processing, display, receipt, and retrieval of information related to sales items, sales transactions, and sales transaction histories. Listing module 334 may also be configured to host one or more web pages or other online media to provide listings associated with sale items and receive requests to negotiate for sale of listing items from one or more buyers 130. In some embodiments, listing module 334 includes a server or other computer system to host a web page associated with a Fididel Service and/or software to provide such web pages. Web pages may include listings in various formats, as well as search capabilities, personalized pages, or other features and functions associated with listings of items offered for sale by sellers 140.

Management system 110 may also include a financial module 334, configured to receive, store, process, retrieve, transmit, or otherwise interact with financial information associated with buyers 130, sellers 140, agents 150, promoters 160 and/or other entities. In a typical embodiment, a Fididel Service is configured to collect fees associated with listings, completed sales, advertising transactions, commissions earned by and/or owed to promoters 160, as well as other fees or payments.

In some embodiments, one or more of the interface modules as shown in FIG. 3 may be incorporated in a common module and/or may include one or more submodules, and/or may share or divide functionality with one or more other modules. Accordingly, the modular configuration shown in FIG. 3 is provided for purposes of illustration, not limitation.

In some embodiments, management system 110 may support or provide connectivity between buyers 130, sellers 140, agents 150 and/or promoters 160 through one or more external connections 170. This may include providing for external direct connections via cell phone, PDA, or other wired or wireless devices to allow buyers and agents to negotiate directly in forms such as by voice, email, text message, or other forms of communications as are known in the art.

As noted previously, selection of an agent 150 for negotiations may be done in any of a number of ways. FIG. 3b illustrates a general process 300b for selecting and allocating agents 150 to negotiations with sellers 130 for purchase of a seller's listed item, such as may be performed by a module or modules of system 110. In a typical embodiment, selection and assignment of agents is performed in outsourcing management module 338 in conjunction with central queue 339. Process 300b may begin at stage 310b where a request for negotiation is received. This may be based on a negotiation request input provided by a buyer 130 to negotiations management system 110 such as through a web page button, link or other actuation mechanism provided on a computer web browser, or by other actuation mechanisms provided on other devices such cell phones, PDAs and the like. Once the request is received, an agent or agents 150 may be selected from a list or pool of available agents 380b, such as is further described below. The selected agent or agents 150 may then be assigned to the negotiation at stage 330b.

In accordance with one embodiment, an agent 150 may be assigned from the central queue 339 at stage 320b based on the agent's priority or ordering in a default agent list or pool 380b of available or potentially available agents, maintained in the queue 339 or in another database. For example, the top agent in the list 380b may be assigned to the next available auction. Alternately, agents 150 may be assigned and selected from one or more sublists 385b, where the sublists 385b may be based on specific criteria such as item type, item price, agent expertise or experience, agent sales record, agent performance and/or other listing criteria related to items for sale or agent competence, expertise, experience and/or performance. For example, if an agent has particular experience or expertise related to knowledge of particular types of products or classes of products, the agent may be assigned to a sublist associated with a particular characteristic of the product being offered. If the assigned agent is not available, is uninterested in negotiating or is otherwise unavailable, the next agent in the list 380b or sublist 385b may then be assigned, and so on, until one or more agents 150 are matched with the buyer 130.

In accordance with another embodiment, an agent or agents may be assigned at random at stage 320b from the list 380b to the next available negotiation. Alternately, or in addition, the agent may be assigned at random from a sublist 385b of agents, such as a subset of agents 150 selected based on the particular item for sale and/or the agent expertise, competency, experience and/or performance. In this implementation, one or more agents 150 from the list 380b or sublist 385c may be selected by management module 338 to negotiate with the next buyer 130, and if that agent is not available, interested in negotiating or is otherwise unavailable to negotiate, the next agent in the sublist 385c may then be assigned at random, and so on, until an agent or agents 150 are matched with the buyer 130.

In accordance with another embodiment, agent 150 selection may be implemented at stage 320b by selecting and notifying a set of available agents from the list 380b or sublist 385b, such as by sending a request to negotiate to the agents on list 380b or sublist 385b, and then assigning the pending negotiation to the first agent that acknowledges the negotiation request or otherwise indicates willingness to negotiate. For example, the selected agents may be contacted via a request, such as through the Internet, or via other wired or wireless connections, about the availability of an available negotiations session. The selected agents may be selected based on their ordering in the list 380b or sublist 385b, at random from the list or sublist, or based on other selection criteria. Once a first agent of the selected agents responds positively to the request, that first agent 150 is then assigned to the pending negotiation with buyer 130. In one embodiment, the selection of agents may constitute 5 agents from the list 380b or sublist 385b, with the first of the 5 selected agents that responds being assigned to the negotiation.

Attention is now directed to FIG. 3c, which illustrates another embodiment of processing functionality 300c associated with outsourcing management module 338 and central queue 339 to facilitate agent selection in conjunction with agent “nomination.” In accordance with this implementation, a seller 140 may be allowed to “nominate” an agent or agents, denoted herein as “nominated agents,” to negotiate on behalf of the seller 140. In general, a menu screen, selection screen, view of other input mechanism may be provided to sellers 140 to select an agent or agents for nomination as a nominated agent. These nominated agents may be included in a nominated agent list 387c associated with a particular seller, either within the default agent list 380b, or external to the default agent list 380b in some embodiments. Nominated agents may be agents 150 that are generally available on management system 110 for negotiations or may be agents that are specifically selected for and/or limited to negotiations on behalf of a particular seller 140 or set of sellers 140.

Process 300c facilitates preferential use of these nominated agents to perform negotiations on the seller's behalf. Process 300c may begin with receipt of a request to negotiate with a buyer 130 at stage 310c. In one embodiment, the availability of a seller 140 for negotiations is checked at optional stage 320c, and if the seller 140 is available for negotiation, the seller 140 is then assigned to negotiate with the buyer 130. Alternately, if either the seller is unavailable or if stage 320c is omitted, the availability of one or more of a seller's nominated agents from nominated agent pool 387c may be checked at stage 330c, and the negotiation assigned to one or more selected agents from the seller's nominated agents pool 387c may be done at stage 335c. Selection of the nominated agent may be done is a fashion similar to agent selection as described above with respect to FIG. 3b, such as selection based on position in a list or pool of nominated agents, by random selection, by first acknowledgment or by other methods. If no nominated agents are available or selected at stage 330c, process 300c may then continue to stage 340c where an agent or agents 150 may be selected from the general agent list 380b or sublist 385b, such as was described above with respect to FIG. 3b, or by other methods.

It is further noted that in some embodiments, combination of the various agent assignment processes described above, as well as others, may be implemented to provide agent assignment functionality.

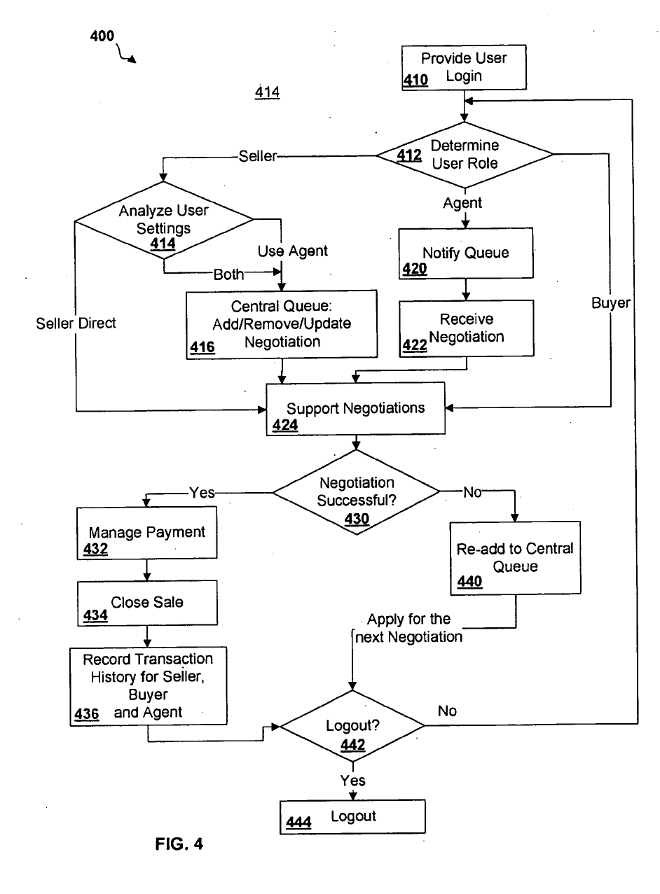

Attention is now directed to FIG. 4, which illustrates details of an embodiment of a process 400 for providing and managing online negotiations in accordance with aspects of the present invention. While the process illustrated in FIG. 4 includes particular stages, it is apparent that other processes including fewer, more, or different stages from those shown in FIG. 4 are within the spirit and scope of the present invention. Accordingly, the process shown in FIG. 4 is provided for purposes of illustration, not limitation. The process 400 may be implemented on and/or in conjunction with an online negotiations system 300 (such as a Fididel System) as shown in FIG. 3, and may be implemented on and/or managed by a management system 110 and/or one or more associated modules, such as those illustrated in FIG. 3.

Process 400 may first begin at stage 410, where a login screen in the form of a GUI, menu, or other user login screen or user interface is provided to allow a prospective user to access management system 110. The system 110 then manages the user login and determines the user's role at stage 412. As noted previously, a user will generally be a buyer 130, seller 140 or agent 150. Additional users, such as promoters 160, system administrators or other systems managers may also be supported by management system 110; however, for purposes of clarity, FIG. 4 illustrates a simplified process based on buyers 130, sellers 140, and agents 150.

If it is determined that a user is a seller 140, the seller's settings may be analyzed at stage 414, and listings and negotiation assignments are assessed in terms of the seller's parameters. In particular, with respect to a particular seller and listing, the seller 140 may wish to directly negotiate with buyers 130, may wish to employ an agent 150, or may wish to employ other negotiation outsourcing strategies, such as those described previously with respect to FIG. 3b and FIG. 3c. If the settings indicate that a seller 140 wishes to use an agent 150, the central queue 339 and/or outsourcing management module 338 are configured and/or updated at stage 416 to facilitate agent assisted negotiation, with the agent assisted negotiation then transferred to negotiation support stage 424. Alternately, if a seller 140 has chosen to negotiate directly without an agent 150, the seller 140 may be transferred directly to the negotiations support stage 424.

In some embodiments, joint seller/agent negotiations may be supported, such as was described previously with respect to FIG. 3b and FIG. 3c. For example, a seller 140 may wish to negotiate on his or her behalf if they are logged onto the management system 110 or have otherwise specified their interest in negotiating, such as by providing a negotiations schedule to management system 110 that may be used by modules such as the outsourcing module 338 and/or central queue 339 to allocate agents 150. If the seller 140 is present, he or she may be assigned at stage 416 directly to the buyer 130 to negotiate, whereas, if the seller 140 is unavailable or otherwise uninterested in negotiations, an agent 150 may be assigned to the buyer 130.

Alternately, if a user has been determined to be an agent 150 at stage 412, the central queue may be updated at stage 420 to reflect availability of the agent 150 to negotiate. The agent may then be placed in position in the central queue 339, and when an appropriate negotiation becomes available, the agent may then be assigned a negotiation at stage 422. The agent may then be connected to the buyer 130 and transferred to the negotiations support stage 424.

In addition, in some embodiments nominated agents may be selected for negotiation as described previously with respect to FIG. 3c, and if the nominated agents are not available, either the seller 140 or an agent 150 from the default agent list/pool, such as pool 380b, may be assigned to the negotiation.

The negotiations support stage 424 is provided to support negotiations between buyers 13 and agents 150 and/or sellers 140. Negotiations support stage 424 includes, but is not limited to, providing one or more display screens, web pages, audible or visual displays or indications, or other media to facilitate interaction between buyers 130 and sellers 140 and/or agents 150. Additional information may be provided at stage 424 such as information related to the buyer 130, seller 140, and/or agent 150, results of previous similar transactions, comparable items, addition items, hints or suggestions related to the negotiation process, external links, information on connecting the buyer 130 and agent 150 and/or seller 140 via external connections such as cell phones, PDAs, or other portable devices, and the like.

If a negotiation is successful and any relevant transaction terms, such as price and delivery mechanism, are agreed upon between the buyer 130 and seller 140, and/or buyer 130 and agent 150, the process may continue to stage 430, where the outcome is assessed by and/or in conjunction with management system 110. Assuming a successful transaction, the system 110 may then facilitate or managing providing payment from the buyer 130 to seller 140 at stage 434. This stage may provide for closing the sales transaction by providing written sales terms, sales summaries, results of financial transactions such as funds transfers, acknowledgements, or other information, such as is shown in the exemplary payment view embodiments of FIG. 39 and FIG. 40. Payment may be made by or in conjunction with management system 110 to sellers 140, agents 150 and/or promoter 160 as required based on the terms of the negotiated transaction, as well as to a Fididel Service, which may receive listing fees, commissions, or other payments associated with the transaction.

Results of the transaction may then be recorded in conjunction with accounts associated with the buyer 130, seller 140, agent 150, promoter 160 and/or Fididel Service at stage 436. This may include creating and/or updating a history record of sales, terms, number of transactions, or other metrics related to sales performance. Users may then be prompted to log out at stage 442, whereupon logout procedures to close out interaction between system 110 and the associated buyer 130, seller 140, or agent 150 may be executed. If the user chooses not to log out at stage 442, he or she may be returned to stage 412 to repeat the process.

Alternately if a transaction is not successful at stage 430, the item may be relisted and/or the current listing may be maintained and/or updated. The agent 150 may then be re-assigned to the central queue 339 at stage 440 and may be automatically assigned to another negotiation and/or may apply for another negotiation. They agent 150 may also choose to log out at stage 442.

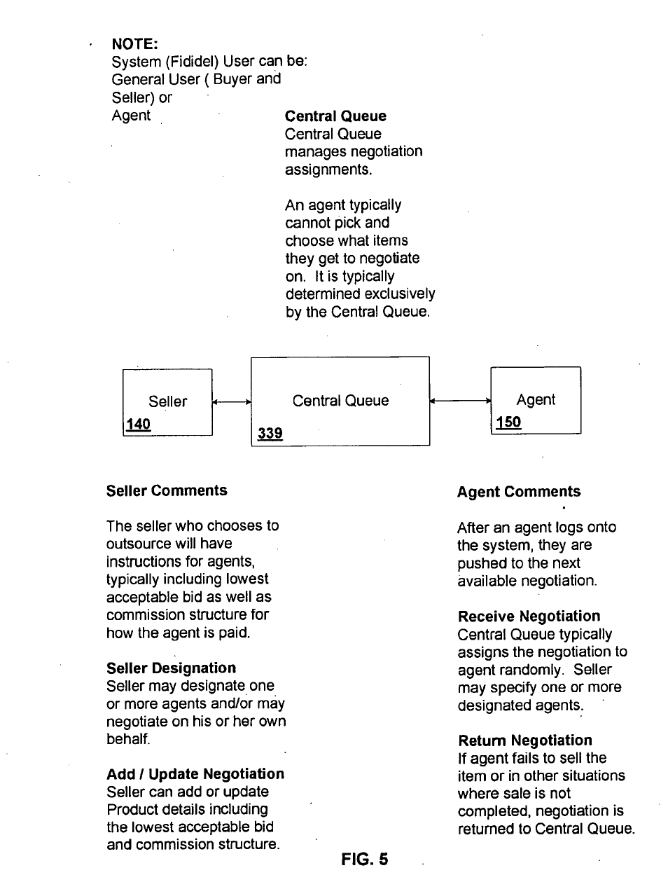

FIG. 5 illustrates a high level view of an embodiment of a central queue 339. Central queue 339 may be provided in a management system 110 in conjunction with outsourcing module 338 to receive information related to listings, buyers 130, sellers 140, agents 150, promoters 160 and/or to other parties and/or other parameters; and then allocate sellers 140 and/or agents 150 to negotiations based on requests to negotiate received from buyers 130. A seller 140 choosing to outsource will typically provide settings associated with each listing including lowest acceptable bid from a potential buyer, commission structure, other payment terms for successful or unsuccessful negotiations, nominated agents, special negotiation instructions, other constraints on how the agent(s) may negotiate on the seller's behalf, and the like. A seller 140 may be provided with options to designate one or more nominated agents, have agents chosen at random, or to negotiate on his or her own behalf. In addition, the seller 140 may be provided with a mechanism for updating the sale item listings, such as a web page, user screen, GUI or other interface for adding or removing item information and details, changing minimum bids, commission structures, nominated agents, auction times, and the like.

When agents 150 log onto management system 110, such as is shown in FIG. 4, they are typically allocated to the next available negotiation by the central queue 339. As noted previously, agent 150 selection may be at random and/or may be based on one or more agent specific criteria such as time of day, geographic location, favored price ranges, types of items, agent languages, or other listing and/or agent specific criteria, such as those described with respect to FIG. 3b and FIG. 3c.

If an agent 150 fails to complete a successful negotiation, the negotiation may be cleared and the agent 150 returned to an agent pool, typically maintained in the central queue 339, where the agent 150 may subsequently be assigned to an agent list or pool, such as pool 380b, and then assigned by module 338 in conjunction with central queue 339 to the next available negotiation.

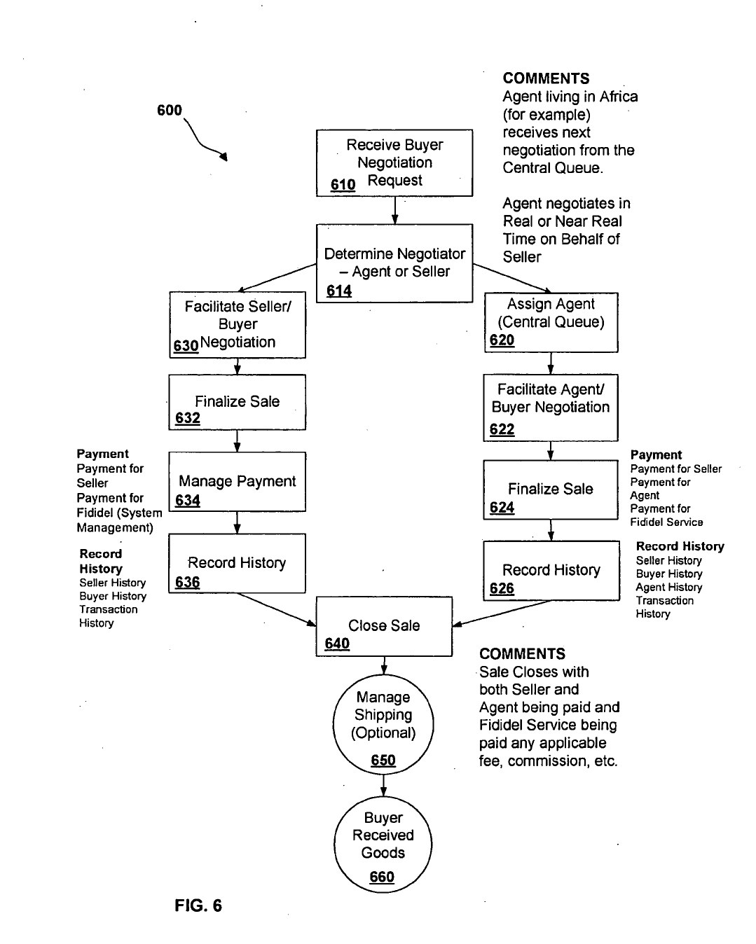

Attention is now directed to FIG. 6, which illustrates details of an embodiment of an online negotiation process 600 in accordance with aspects of the present invention. While the process illustrated in FIG. 6 includes particular stages, it is apparent that other processes including fewer, more, or different stages than those shown in FIG. 6 are within the spirit and scope of the present invention. Accordingly, the process shown in FIG. 6 is provided for purposes of illustration, not limitation. Process stages as are shown in FIG. 6 may be performed on one or more modules of management system 110, such as those modules shown in FIG. 3.

Management system 110 may first receive a buyer request for negotiation at stage 610. A buyer may make such a request by, for example, viewing a listing of items offered for sale by a seller 140 on a web page associated with or hosted on management system 110. Example listings as provided by screen shots of embodiments of the invention are shown in FIG. 8, FIG. 9, FIG. 32a and FIG. 32b. When the request is received and processed at stage 610, the system may then determine whether the negotiation is limited to negotiations by the seller 140 and/or whether the listing settings are configured to provide for outsourced negotiations using agents 150 and/or whether there are any nominated agents. If the seller 140 has configured the listing to allow for direct negotiations, management system 110 may facilitate seller/buyer interaction at stage 630 by, for example, providing one or more display screens, web pages, or other media to facilitate interaction between buyers 130 and sellers 140. Additional information may also be provided such as results of previous similar transactions, comparable items, addition items, suggestions for negotiation, external links, information on connecting via external connections such as cell phones, PDAs, or other portable devices, and the like. If a negotiation is successful, the transaction may be finalized at stage 632, payment may be managed at stage 634, including providing for payment to the seller and to any associated services (such as a Fididel Service) on the negotiations management system 110, at stage 634. Transaction history may be recorded at stage 636, including updating files and/or records associated with the buyer 130, seller 140, and/or Fididel Service. Any additional transaction completion functions may be provided at stage 640, and management system 110 may optionally manage or facilitate shipping to buyer 130 at stage 650 and/or may manage or assist in monitoring and managing receipt of goods at stage 660.

Similarly, if negotiations are carried out by an agent 150 on behalf of sellers 140, the agent 150 may be assigned by or in conjunction with the central queue 339 at stage 620, such as was described previously with respect to FIG. 3b and FIG. 3c. The system may facilitate negotiation between the buyer 130 and agent 150 at stage 622, and if the negotiation is successful, the sale may be finalized at stage 624. Finalizing the sale, in the case of use of an agent 150, may include providing payment to the seller 140, agent 150 (based on, for example, the commission or other sales fees associated with the listing), and service associated with the negotiations system 110 (i.e. the Fididel Service). Transaction records associated with the buyer 130, seller 140, agent 150 and/or promoter 160 may be updated at stage 626, and the sale closed at stage 640. Finally, management system 110 may provide optional management of shipping at stage 650 and/or management and/or monitoring of item receipt at stage 660.

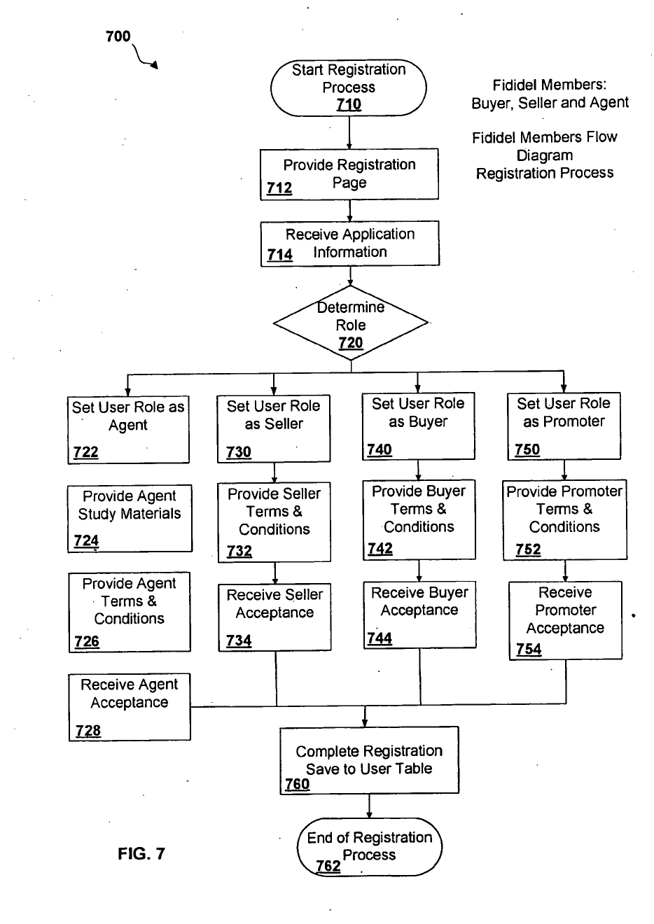

FIG. 7 illustrates an embodiment of a registration process 700 facilitating registration of various types of users of a negotiations system 110 in accordance with aspects of the present invention. While the process illustrated in FIG. 7 includes particular stages, it is apparent that other processes including fewer, more, or different stages than those shown in FIG. 7 are within the spirit and scope of the present invention. Accordingly, the process shown in FIG. 7 is provided for purposes of illustration, not limitation. Process stages as are shown in FIG. 7 may be performed on one or more modules of management system 110 such as those modules shown in FIG. 3.

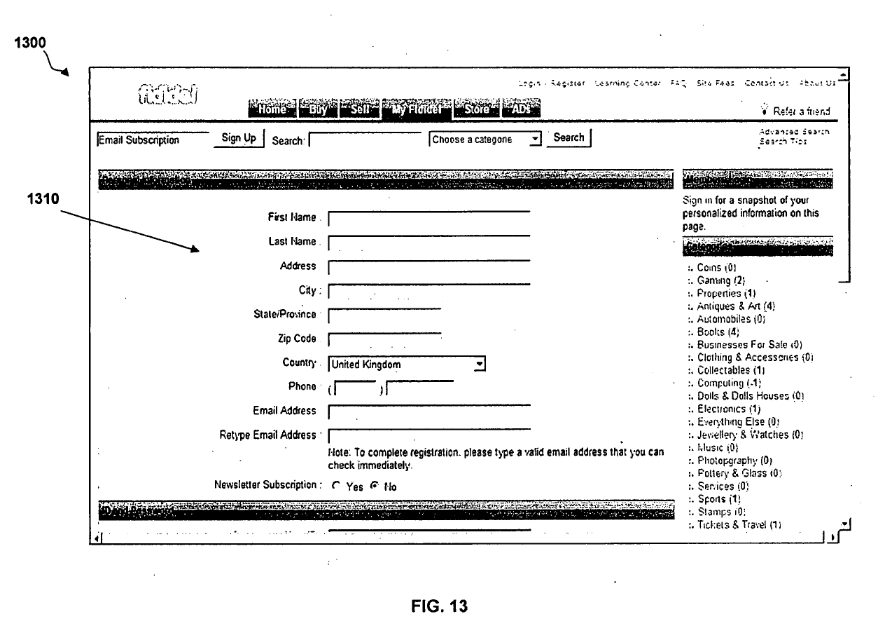

A buyer 130, seller 140, agent 150 and/or promoter 160 may begin the registration process 700 by first selecting to register as a user at stage 710. A registration page may be provided at stage 712, such as the registration page shown in FIG. 13, which is an embodiment of a GUI for facilitating online registration. Management system 110 may then receive application information entered by the registrant at stage 714, such as desired role (Buyer, Seller, Agent, Promoter), user name, address, email address, telephone address, bank or other financial account information and the like. The user provided information may then be evaluated at stage 720 to determine the user's role, i.e., whether the user wishes to be a buyer 130, seller 140, agent 150 or promoter 160. If the user desires to be an agent 150, the user's role may be set as an agent at stage 722. At stage 724, study materials, such as an agent's user guide or other materials related to agent duties, procedures, performance requirements, managing negotiations, interacting with buyers, payments and commissions, and other information related to acting in the capacity of an agent may be provided. Additional contractual terms and conditions for buyers may then be provided at stage 726, and the user may then be provided with an acceptance form, such as an online list of terms and conditions, that the user must click on, select, or otherwise actuate to indicate acceptance at stage 728.

Alternately, if a user is determined to be a seller 140 at stage 720, the user's role may then be set as an seller at stage 730. Contractual terms and conditions for sellers may then be provided to the user at stage 732, and the user may then be provided with an acceptance form, such as an online list of terms and conditions, that the user must click on, select, or otherwise actuate to indicate acceptance at stage 734.

Alternately, if a user is determined to be a buyer 130 at stage 720, the user's role may be set as an buyer at stage 740. Contractual terms and conditions for buyers may then be provided to the user at stage 742, and the user may then be provided with an acceptance form, such as an online list of terms and conditions, that the user must click on, select, or otherwise actuate to indicate acceptance at stage 744.

Alternately, if a user is determined to be a promoter 160 at stage 720, then the user's role may be set as a promoter at stage 750. Contractual terms and conditions for promoters may then be provided to the user at stage 752, and the user may then be provided with an acceptance form, such as an online list of terms and conditions, that the user must click on, select or otherwise actuate to indicate acceptance at stage 754.

Once the buyer 130, seller 140, agent 150 or promoter 160 has consented to the terms and conditions or other requirements presented at stages 744, 734, 728, or 754, respectively, the registration may be completed at stage 760, and information related to the buyer 130, seller 140, agent 150 or promoter 160 may be stored and/or updated in databases, queues, or other relevant modules or date structures within management system 110. The user will then be registered with management system 110, and the registration process may then be terminated at stage 762.

Attention is now directed to FIG. 8 which illustrates an embodiment of an item listing screen view 800. Screen view 800 includes listings for a number of items 810 offered for sale. FIG. 32 illustrates an alternate item listing screen view based on another embodiment of the invention that is further described below.

FIG. 9 illustrates an embodiment of a detailed item listing view 900. View 900 illustrates an item 910 offered for sale, along with information about the item and any bidding history associated with the item.

FIG. 10 illustrates an embodiment of a seller category listing view 1000. View 1000 includes a listing of categories and/or subcategories of items 1010 that a seller 140 may be interested in listing offered for purchase, with clickable links 1020 or other mechanisms for allowing the seller 140 to search for categories and select a relevant category to list items offered for sale. The categories illustrated in FIG. 10 may include main categories along with a pulldown list or other selection mechanism for selecting one or more nested subcategories.

FIG. 11 illustrates an embodiment of another category listing view 1100 provided to buyers 130, illustrating various categories 1010 and subcategories provided to allow buyer 130 selection of relevant categories of interest in which to further search for sales items.

FIG. 12 illustrates an embodiment of a user summary view 1200, illustrating various options and displays provided to facilitate overview of negotiations and purchases associated with a particular user 130 and associated user account 1210. It is noted that users may be provided with an account allowing setting and review of a variety of information associated with the user, such as items bought or sold, negotiation and bidding histories, preferences, personal details, wanted listing, advertisements, feedback and/or other user related information.

FIG. 13 illustrates an embodiment of a user personalization view 1300, illustrating a template for providing information 1310 associated with a particular user to create or edit a user account.

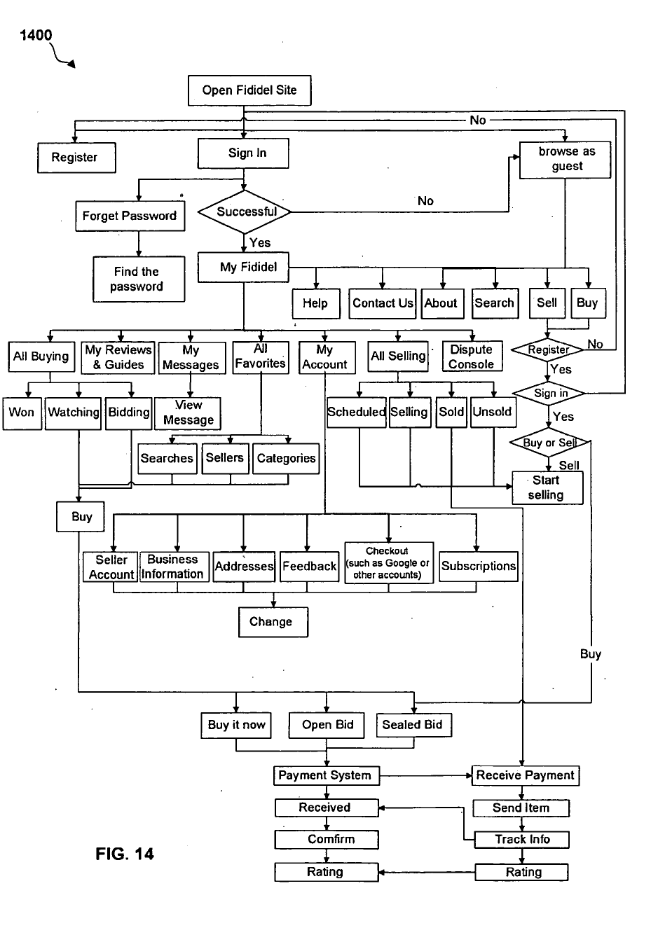

FIG. 14 is a diagram illustrating additional details of a user workflow 1400 of an embodiment of the present invention, illustrating various stages of user interaction that may be facilitated by management system 110.

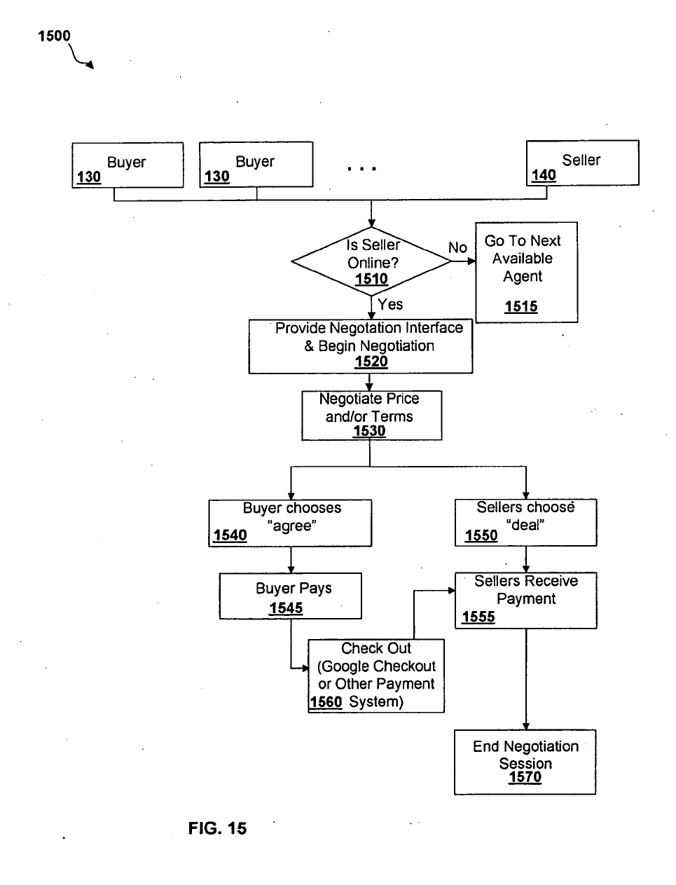

FIG. 15 is a diagram illustrating a user workflow 1500 of an embodiment of aspects of the present invention, illustrating various stages of user interaction that may be implemented in conjunction with an outsourcing management module 338 such as is shown in FIG. 3. While the process illustrated in FIG. 15 includes particular stages, it is apparent that other processes including fewer, more, or different stages from those shown in FIG. 15 are within the spirit and scope of the present invention. Accordingly, the process shown in FIG. 15 is provided for purposes of illustration, not limitation. Process 1500 may be implemented on and/or in conjunction with an online negotiations system 300 (such as a Fididel System) as shown in FIG. 3, and may be implemented on and/or managed by a management system 110 and/or one or more modules as illustrated in FIG. 3. Such modules typically including computer software stored on a computer readable medium including instructions configured to be executed by one or more processors on one or more computer systems.

As shown in FIG. 15, in some embodiments system 110 may facilitate connecting one or more buyers 130 with a seller 140 to facilitate online negotiations. At stage 1510, presence of seller 140 may be tested, and if the seller 140 is not online or otherwise available to negotiation, the process 1500 may be terminated at stage 1515 and/or the negotiation may be assigned to an agent 150 as is described elsewhere herein. Alternately, if the seller 140 is online and wishes to negotiate, a negotiation session may begin at stage 1520 wherein one or more buyers 130 are connected with the seller 140, such as is described elsewhere herein. A price and terms competition/negotiation stage 1530 is then entered, wherein the one or more buyers 130 and seller 140 engage in a negotiation to determine a mutually acceptable price and/or other terms. If a buyer 130 agrees with a seller's offered price at stage 1540 and the seller 140 agrees to complete the transaction at the buyer's agreed upon price at stage 1550, the buyer 130 is then provided with a payment mechanism at stage 1545, and may check out or otherwise complete the payment transaction at stage 1560, such as using an internal checkout system or an external third party online payment system such as Google Checkout or another online payment system, with the seller then provided with the payment and/or associated payment information at stage 1555, either directly or in conjunction with the external third party system. The negotiation session may then be closed out at stage 1570 and/or returned to a start stage, such as stage 1510, to repeat the transaction processing with other sellers 150, buyers 130 and/or agents 150.

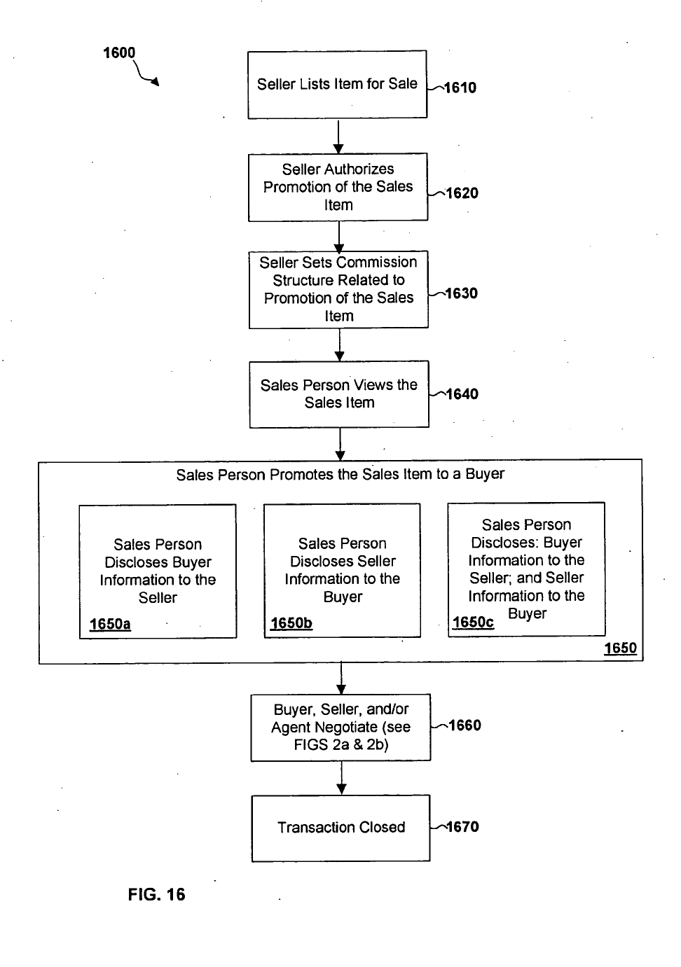

Attention is now directed to FIG. 16, which illustrates one embodiment of a process 1600 for providing and managing online promotion of a sales transaction in accordance with aspects of the present invention. While the process illustrated in FIG. 16 includes particular stages, it is apparent that other processes including fewer, more, or different stages from those shown in FIG. 16 are within the spirit and scope of the present invention. Accordingly, the process shown in FIG. 16 is provided for purposes of illustration, not limitation. Process 1600 may be implemented on and/or in conjunction with an online negotiations system 300 (such as a Fididel System) as shown in FIG. 3, and may be implemented on and/or managed by a management system 110 and/or one or more modules as illustrated in FIG. 3. Such modules typically including computer software stored on a computer readable medium including instructions configured to be executed by one or more processors on one or more computer systems.

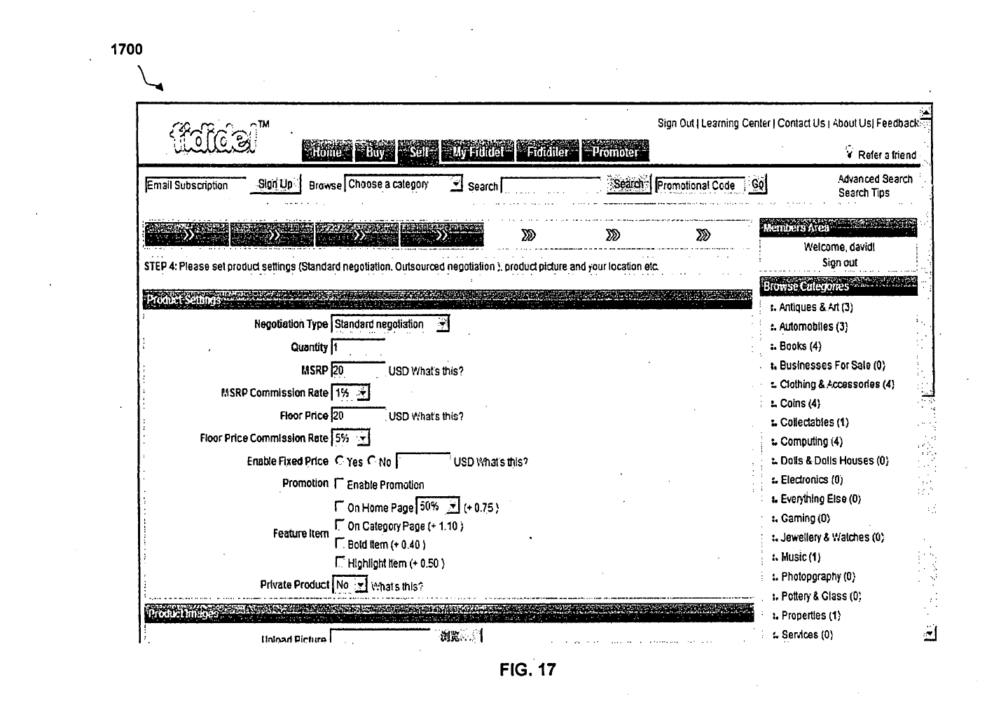

Process 1600 may be begin with the seller 140 being provided with options for listing an item for sale at stage 1610. This may include, but is not limited to, providing a web page, display screen, user interface, or other means for allowing the seller 140 to list an item for sale and set one or more parameters associated with the sale such as a duration, starting price, floor price, ceiling price, other target prices, commission related to each price (if any), photograph or other image of the item, promotion authorization or other text, graphical, audible, or image based details and parameters related to the sale item. FIG. 10 and FIG. 17 illustrate screen shots of such display screens in accordance with embodiments of the invention.

After listing an item, the seller 140 may authorize or restrict promotion of the listed sales item by one or more promoters 160 at an optional stage 1620. The seller 140 may also set one or more commission structures associated with successful promotion by a promoter 160 of the sales item at an optional stage 1630. A commission structure may set forth any number of conditions related to the promotion of the sales item, including the amount of a fee collected by a promoter 160 who successfully promotes a sales transaction of the sales item. A fee amount set forth in a commission structure may be set at any amount, including at a fixed amount or a percentage of the selling price of a sales item. Successful promotion of a sales transaction may be judged by any number of criteria, including a causal connection between the disclosure of a sales item by a promoter 160 to a buyer 130 and the purchase of the sales item by the buyer 130. One of skill in the art will appreciate that the optional steps 1620-1630 may be automatically performed by the management system 110 instead of the seller 140.

Upon being listed by the seller 140, the sales item may then be displayed on a negotiations site for viewing by a promoter 160 at stage 1640. The display of the sales item may include information related to the sale item provided by the seller as well as other information such as system displays, logos, links to other items or information, banners, advertisements, or other information. The display typically includes a button, link, or other means of allowing the promoter 160 to view one or more commission structures associated with promotion of the sales item. The display may also include a button, link, or other means of allowing the promoter 160 to register with the seller 140 and/or to request authorization to promote the sales item of the seller 140.

Upon viewing the sales item on the negotiations site, the promoter 160, as facilitated by management system 110, promotes the sales item at stage 1650. Promotion of the sales item by the promoter 160 may include any number of actions on the part of the promoter 160, including disclosure of prospective buyer information to the seller 140 of the sales item at stage 1650a, disclosure of seller information (e.g., sales item information) to one or more prospective buyers 130 at stage 1650b, or disclosure of prospective buyer information to the seller 140 and disclosure of seller information to the prospective buyers 130 at stage 1650c.

Promoters 160 may also have the ability to attach information (e.g., a picture, sales information) related to a sales item offered by a seller 140 to a blog, Myspace web page, Facebook webpage, Craigslist web page, or any other web page or other mechanism for advertising the product to buyers 130. As previously described, attachment of information related to the sales item may be achieved by various means, including a copying sales information and pasting it into a web forum, clicking on the sales information to link it to the web forum, and/or other means known or developed in the art. Additionally, when viewing a page displaying one or more sales items offered by a seller 140, a promoter 160 may view a pull-down menu of options that allow the promoter 160 to attach information related to a sales item to his/her web forum, copy the URL of the Fididel web page presenting the sales item, and/or perform other operations that help the promoter 160 promote one or more sales items offered by the seller 140.

Promoters 160 may alternatively and/or additionally advertise one or more sales items using standard and/or web-based advertising campaigns known or developed in the art. For example, promoters 160 using web-based advertising may purchase advertisement space on web pages, purchase search engine keywords, send out cell phone text messages and/or send out spam to buyers 130. Alternatively, promoters 160 using standard advertising may purchase advertisement space on billboards and in periodicals, among other advertising media. Web-based advertisements may lead a viewer/prospective buyer 130 directly to the Fididel web page presenting the sales items or to a web forum of a promoter 160. Standard advertisements may instruct a viewer/prospective buyer 130 to visit the Fididel web page presenting the sales items or to a web forum of a promoter 160.

Promotion of a sales item by a promoter 160 effectively introduces the sales item to a prospective buyer 130 and allows the prospective buyer 130 to determine whether he or she wishes to purchase the item. It should be noted that in some cases, promotion of a sales item may not be successful. That is, promotion of a sales item does not necessarily result in the purchase of the sales item by a prospective buyer 130; however, promotion of the sales item may lead to the purchase of the sales item by the prospective buyer 130, in which case the promotion would be considered successful.

If one of the prospective buyers 130 wishes to purchase a sales item promoted by the promoter 160, the prospective buyer 130 may negotiate to purchase the sales item from the seller 140 or an agent 150 assigned to the seller 140 at stage 1660, as facilitated by the management system 110. During stage 1660, the buyer 130, seller 140, and/or agent 150 may negotiate in a manner similar to that described above with respect to stages 220-255 of FIG. 2a or stages 220b-255b or FIG. 2b, or via other negotiation processes.

If negotiations between the buyer 130, seller 140 and/or agent 150 are successful, the transaction may be completed as shown in FIGS. 2a and 2b. For example, the promoter 160 may be paid, in accordance with the commission structure set in stage 1630, for successful promotion of the sales item. Additionally, any associated listing fees, or other fees related to the transaction may then be debited or credited, including any payments or credits made to a Fididel Service in conjunction with the transaction. At stage 1670, any additional formalities to close the transaction may then be performed.

Additional details of aspects of embodiments of the present invention are provided in FIGS. 17-23. FIG. 17 illustrates an embodiment of a “standard negotiation” screen 1700 accessible to a seller 140 after choosing a type of negotiation from a “Negotiation Type” pull down menu. By way of example, screen 1700 may be indicative that the seller 140 is not outsourcing negotiations to an agent 150 and will be negotiating directly with a buyer 130 to transact a sale of the new product/item.

As shown, screen view 1700 facilitates enabling a seller 140 to set various commission rates and prices (e.g., a floor price and an MSRP price that indicates a suggested retail price for buyers 130), as well as other settings, including an “Enable Promotion” button that authorizes promotion of an item by a promoter 160. Additionally, a “private product” setting can be selected to enable only private negotiation of an item between the seller 140 and select buyers 130.

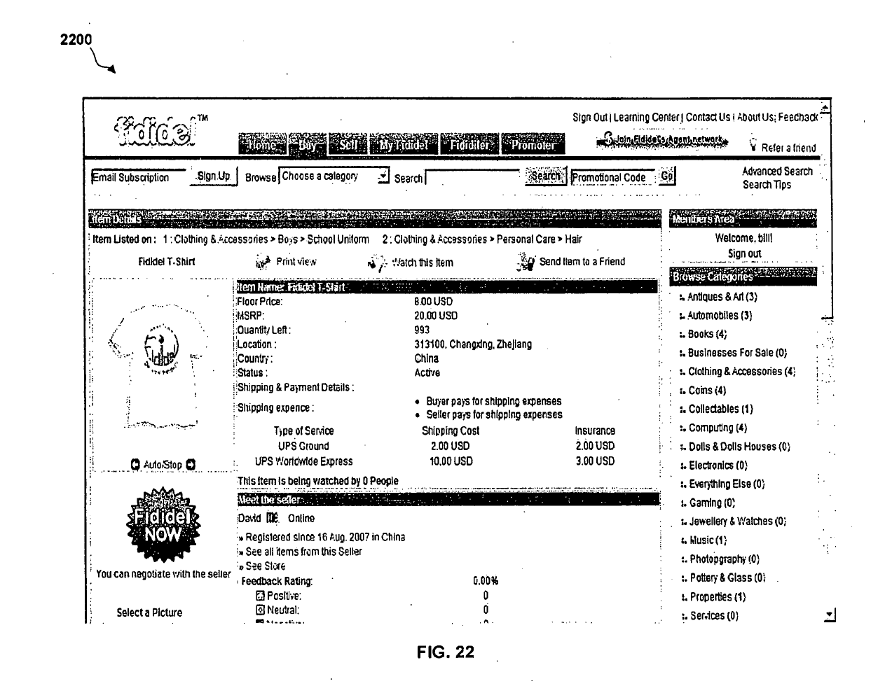

Screen 1700 also facilitates allowing a seller 140 to enable a fixed price negotiation setting by selecting “yes” next to “Enable Fixed Price” and then setting a fixed price that will be used to respond to an offer by a buyer 130 under circumstances when the seller 140 is unavailable to negotiate with the buyer 130. For example, a buyer 130 who clicks on a button identified as “Fididel Now” (as shown in FIG. 22) or “Fididel!” (as shown in FIG. 32a), or an equivalent, when a seller 140 is not available to negotiate, will receive a response from the seller 140 that indicates the seller 140 is not available to negotiate and that the item may be purchased by the buyer 130 for the fixed price set with respect to an “Enable Fixed Price” function. Alternatively, if the seller 140 does not select “yes” next to “Enable Fixed Price,” the buyer 130 may only be prompted to leave a message for the seller 140 that includes an offer price and/or other information. Upon receiving such a message from a buyer 130, the seller 140 may then view the offer and respond to the buyer 130 and/or engage in real-time/near real-time negotiations with the buyer 130.

One of skill in the art will appreciate an alternative embodiment that allows a seller 140 to set a “minimum” fixed price. If a seller 140 is not available, the management system 110 may then provide to a buyer 130 one or more counter offers higher than the minimum fixed price. The one or more counter offers may be provided by the management system 110 in response to offers or counter offers from the buyer 130. Such an embodiment allows the management system 120 to negotiate on behalf of the seller 140, while establishing limits as to a minimum counter offer that the management system 120 is permitted to make on behalf of a seller 140. One of skill in the art will appreciate alternative embodiments in which the management system 120 is permitted to negotiate down to a price within a certain percentage of a price fixed by a seller 140. Such functionality may be implemented by an expert system provided in management system 110.

One of skill in the art will further appreciate that the management system 110 may negotiate with a buyer 130 on behalf of a seller 140 by using price increments set by the seller 140 (e.g., starting price, second price, . . . , minimum price), or by employing a processing algorithm that determines which counter offers to make based on various methods.

In addition, the seller or management system 110 may respond to the buyer 130 in response to offers from the buyer 130 until the minimum fixed price is offered. It is noted that more than one fixed price may be entered by a seller 140. In some embodiments, system 110 may be configured to allow a seller 140 to set a fixed price and allow management system 110 to negotiate a price within a percentage of the fixed price.

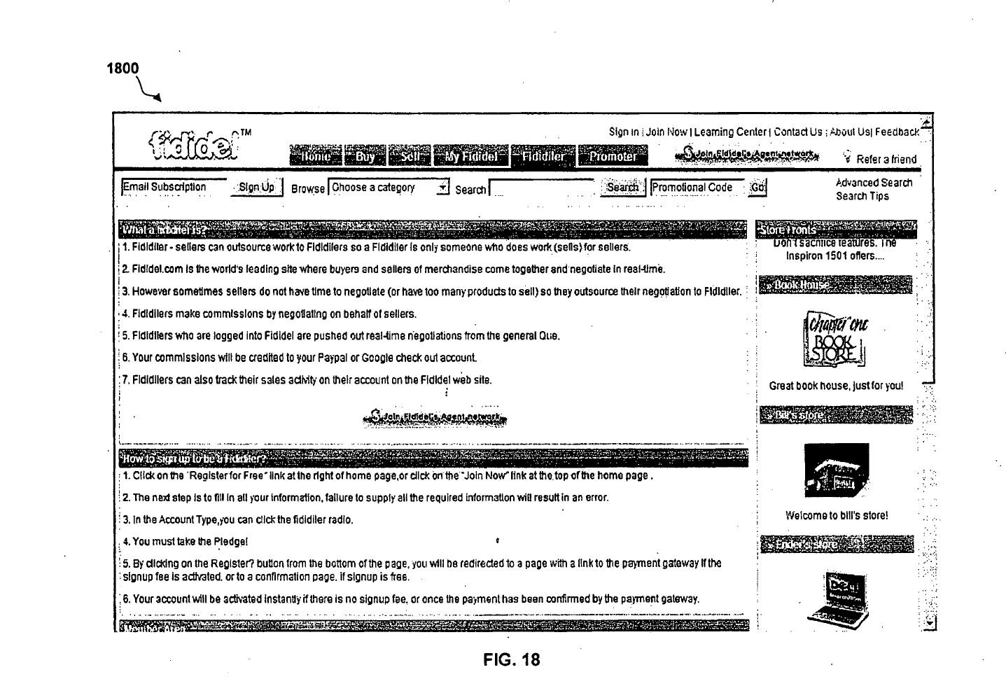

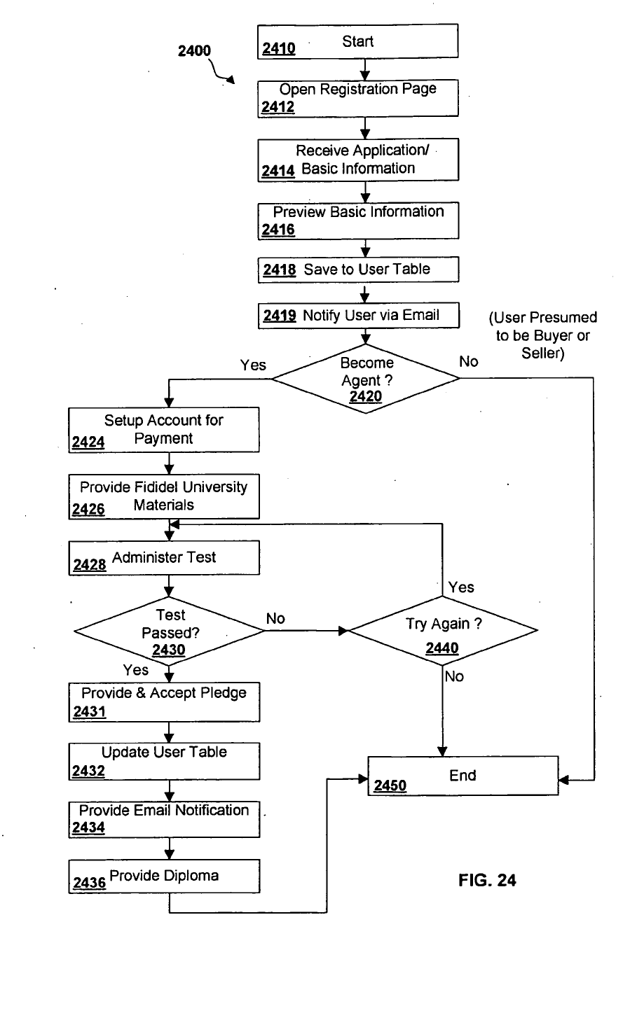

FIG. 18 illustrates an embodiment of a “Agent” screen view 1800 that may be presented to an Agent 150 (denoted in this screen as a “Fidideler”) after clicking on an agent (“Fidideler”) tab. If a user is interested in becoming an agent 150, the user may click on a “Join Fidideler Network” button (not shown) that will take the user through one or more screens that, for example, describe how the user can become an agent and/or allow the user to become an agent. In one embodiment, one or more screens (not shown) associated with a FIDIDEL UNIVERSITY may test the user prior to allowing the user to become a agent, such as is illustrated in FIG. 24. This testing may include an online study and/or review mechanism to allow the potential agent to learn about Fididel processes and system and then take a test to verify competency. After passing the test, the agent may print a Fididel University diploma having the user's name printed thereon. In another embodiment, one or more screens (not shown) require the user/prospective agent to register for PayPal or other online or e-commerce systems to facilitate payments and payment management. FIG. 24 illustrates additional details of such a process for testing and registration.

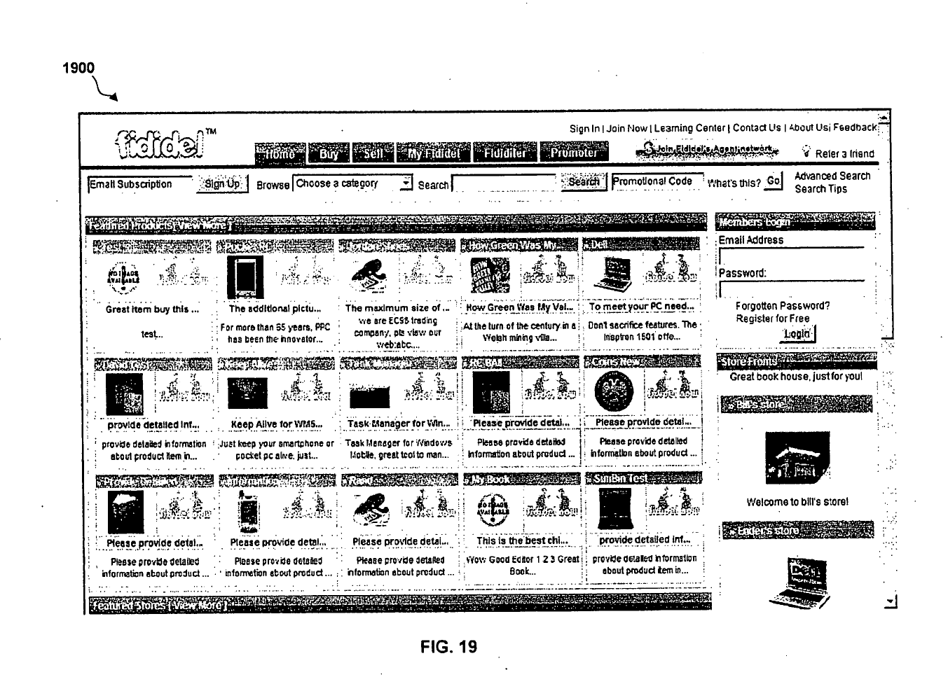

FIG. 19 illustrates an embodiment of a “home page” screen view 1900 that lists multiple tabs positioned at the top of screen 1900, including a home tab, a buy tab, a sell tab, a My Fididel tab, a Fidideler (Agent 150) tab and a promoter tab. The screen 1900 also lists featured products/items and featured store fronts. In some embodiments, a seller 140 may have to pay to have the seller's item listed on the home page screen 1900. In other embodiments, the store fronts and/or items may be listed on screen 1900 based on random selection by the management system 110.

Additionally, screen 1900 also includes a “Fididel Now” icon related to each item (similar functionality is also denoted herein as “Fididel!” or in conjunction with a “Fididel!” icon, button or other selection item, where the selection item provides a link or similar mechanism to allow a buyer 130 to actuate the selection item and be directed to a negotiation session for purchase of the item). If a buyer 130 clicks on a “Fididel Now” or “Fididel!” selection item associated with a particular sale item, the buyer may be directed directly or indirectly to a product page of the particular item and/or an associated negotiation session for negotiation for purchase of the item.

Additionally, screen 1900 allows a buyer 150 to enter a promotional code. For example, a seller 140 (e.g., Best Buy) may operate a store front and/or offer an item for sale on Fididel. The seller 140 may also advertise the store front or item (e.g., in a newspaper, the Internet, television). An advertisement may advise a viewer of the advertisement/buyer 130 to visit an associated service provider web site, such as www.Fididel.com, and to enter a promotional code. If the buyer 130 enters the promotional code, the buyer 130 may be taken directly to a particular page operated by Fididel and associated with the seller 140. The buyer 130 would therefore not have to search for the page.

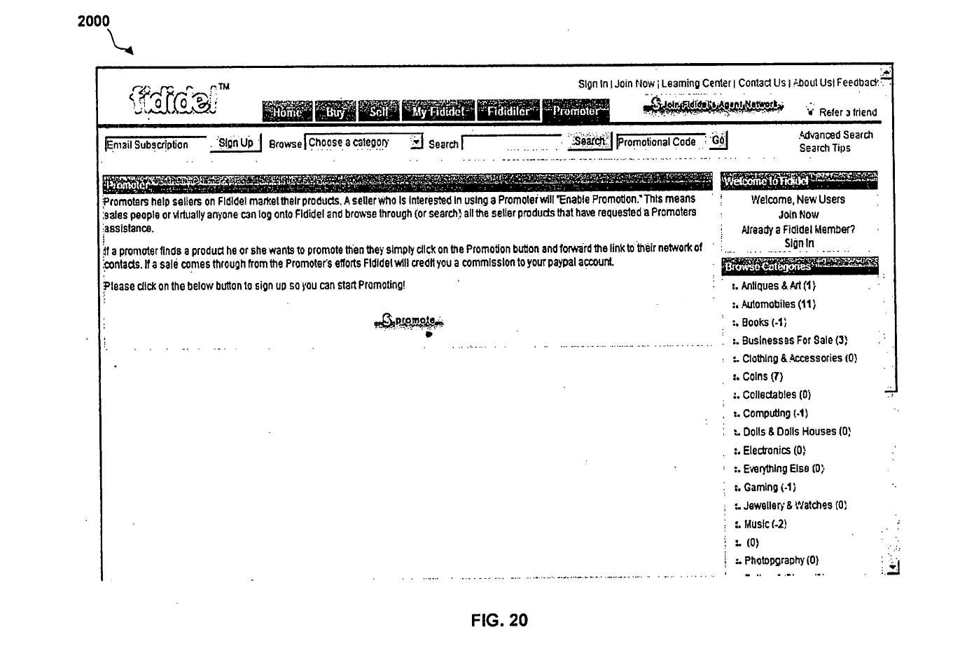

FIG. 20 illustrates an embodiment of a “promoter sign up” screen 2000 configured to facilitate signing up and registration as a promoter 160.

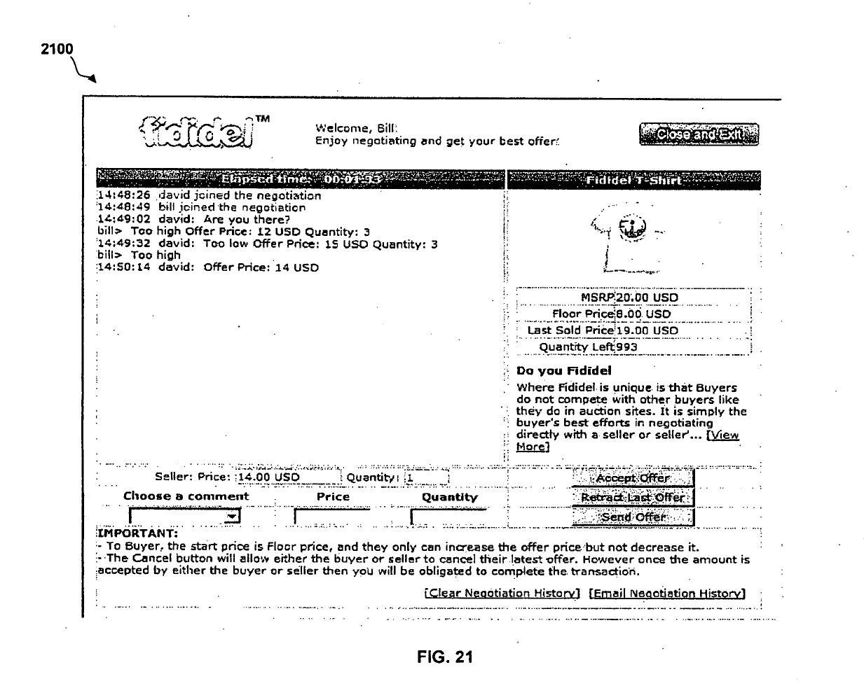

FIG. 21 illustrates an embodiment of a “negotiation module” screen 2100. If a buyer 130 clicks on a “Fididel Now” or “Fididel!” button or icon associated with an item/product on homepage screen 1900, the buyer may by provided with screen 2100, which may show an audit trail of every offer and counter offer associated with the item. Screen 2100 may also offer a pull down menu of pre-set comments.

FIG. 22 illustrates an embodiment of a “product/item” screen 2200, which depicts what a buyer 130 may see after clicking on a “Fididel Now” option from screen 1900 (see above), after searching for the item, or after locating the item in a seller's store. Screen 2200 provides details about an item offered for sale and the seller 140 of the item. If a buyer 130 selects the “Fididel Now” button, the buyer 130 may then see screen 2100 (as described previously).

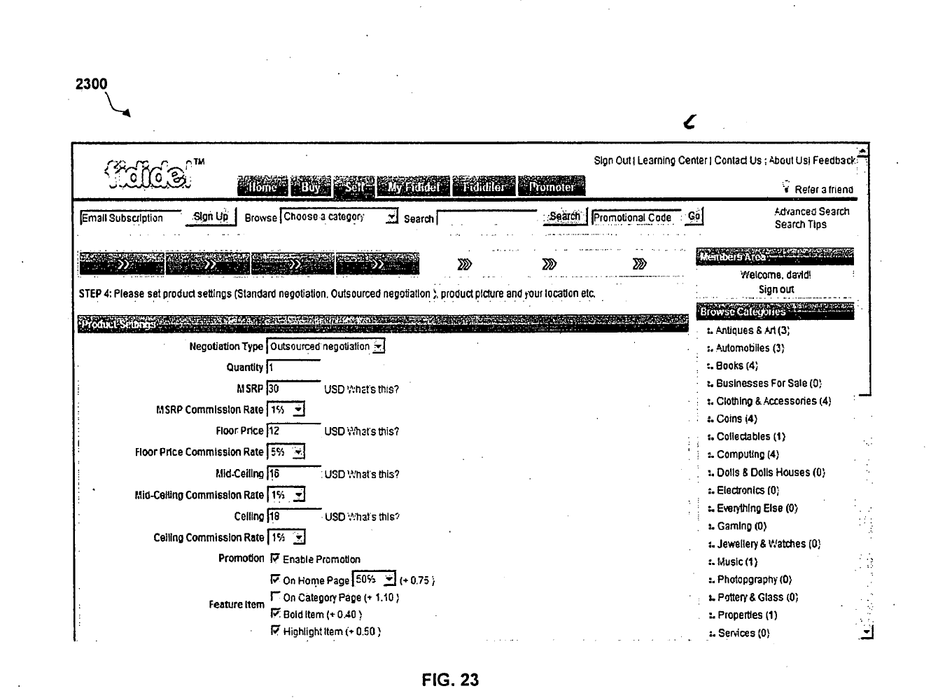

FIG. 23 illustrates an embodiment of an “outsource negotiation” screen 2300 accessible to a seller 140 after choosing a type of negotiation from a “Negotiation Type” pull down menu. By way of example, screen 2300 may be indicative that the seller 140 is outsourcing negotiations to an agent 150 and will not be negotiating directly with a buyer 130 to transact a sale of the new product/item. In some embodiments, the seller 140 may create various commission structures that may include a floor price, a middle price, a ceiling price an MSRP price or other pricing structures, each of which may have an associated commission value.

Additional details of aspects of certain embodiments of the present invention are provided in FIG. 24, which illustrates an embodiment of a workflow 2400 for registering and testing agents 150 for competency and providing confirmation, such as in the form of a certificate or diploma, demonstrating competency. The testing and competency certification as illustrated in FIG. 24 may be done in conjunction with a service associated with a service provider as described herein, and in one embodiment may be offered under the name of “Fididel University.” The process shown in FIG. 24 may be offered to buyers 130, sellers 140 agents 150 and/or promoters 160; however, in typical embodiments it may be bypassed for buyers 130, sellers 140 and promoters 160, who do not necessarily need the testing and certification stage in order to be able to use the services provided by a negotiations management system such as management system 110. While the process illustrated in FIG. 24 includes particular stages, it is apparent that other processes including fewer, more, or different stages from those shown in FIG. 24 are within the spirit and scope of the present invention. Accordingly, the process shown in FIG. 24 is provided for purposes of illustration, not limitation. Process 2400 may be implemented on and/or in conjunction with an online negotiations system 300 (such as a Fididel System) as shown in FIG. 3, and may be implemented on and/or managed by a management system 110 and/or one or more modules as illustrated in FIG. 3. Such modules typically including computer software stored on a computer readable medium including instructions configured to be executed by one or more processors on one or more computer systems.

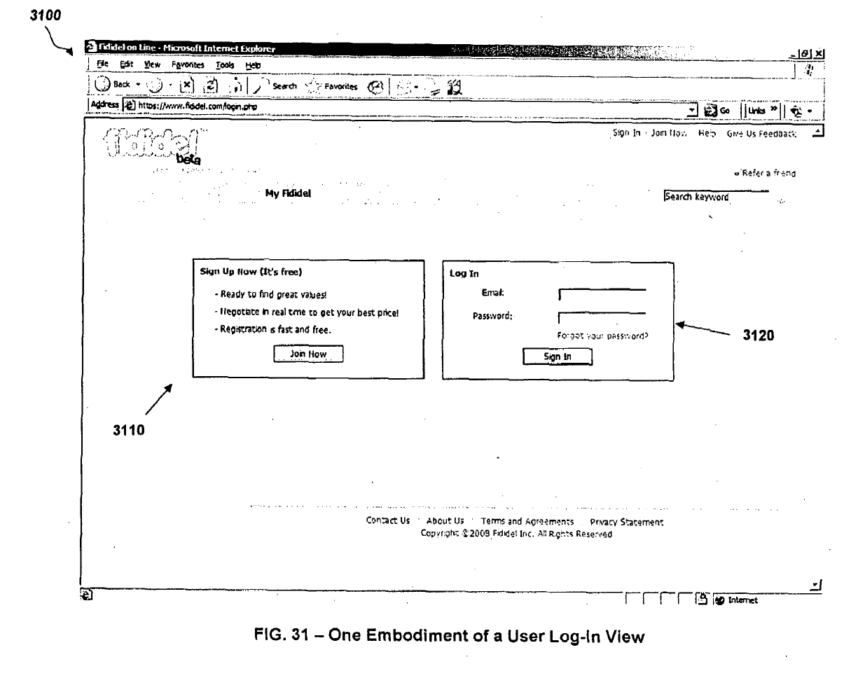

Process 2400 may begin with a start stage 2410, which may be entered from a user access page, such as shown in screen view 3100 of FIG. 31, or from another user screen provided by management system 110. A user registration page may be provided at stage 2412, with an input interface provided at stage 2414 to receive a user's application and basic information, such as name, address, proposed userid, financial information, preferences and/or other user related information and setup information. The information may then be previewed at stage 2414, with one or more prompts being provided to allow a user to correct or update information provided at stage 2414, and once the user's input information is sufficiently complete and correct, the information may be saved to a user table or other type of database record at stage 2418 and the user may be notified by email, voicemail or another notification mechanism. The user may then be provided with an option at stage 2420 to confirm whether he or she wishes to be an agent 150 and engage in activities in conjunction with a negotiations management system, such as management system 110, associated with online negotiating for purchase of sales items. In particular, in typical embodiments, this stage may be important in assessing whether sellers 140, agents 150 and/or promoters 160 want to be registered and/or certified. If the user does not wish to become an agent 150, it is presumed that the user is instead interesting in being a buyer 130, seller 140 or promoter 160. In this case, the process 2400 may be ended at end stage 2450. Alternately, if the user wishes to become an agent 150, the user may be provided with an display to setup an account for payment and/or receipt of payment at stage 2424 and may be provided with study materials associated with learning the rules and usage of the system at stage 2426. The study materials may be provided online such as through a user-interactive study module or other online study mechanism and/or may be provided in a downloadable format so that the user can print and review the materials offline and/or may be provided in a hard copy format for non-computer assisted study.

In conjunction with the study materials, a test may be administered at stage 2430, with the results of the test used to determine successive stages. For example, if a user fails to meet a sufficient test passage criteria, such as achieving a minimum score, he or she may be allowed to retake either some or all of the test at stage 2440 by being redirected to stage 2428 and/or may be allowed to exit at stage 2450 without retaking the test. In some embodiments, the user may be notified upon passage of the test directly online and/or may be notified of passage via a second email, voicemail or other notification mechanism at stage 2434.

If a user passes a test, he or she may be provided with a user's pledge or other terms and conditions for use of the system at stage 2431, and may be required to accept the pledge or terms and conditions before continuing with process 2400. The user may then have their user information updated in a user table or other database at stage 2432 and may be provided with a certificate, diploma or other confirmation receipt at stage 2436 that the user passed the required certifications steps to become an agent 150. The certificate or diploma may be provided online and/or may be sent to the user in an email or hard copy format.

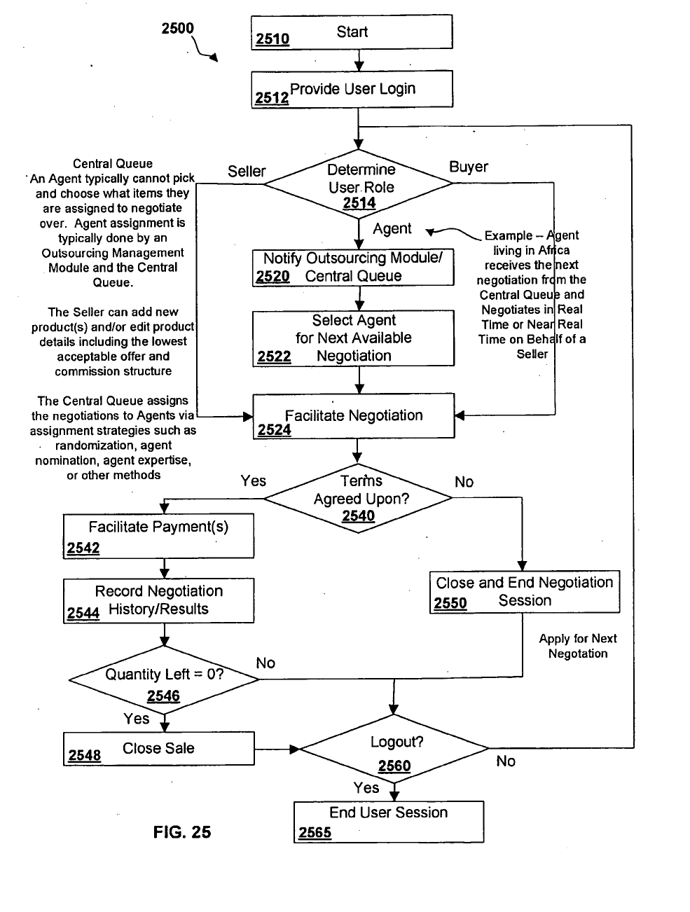

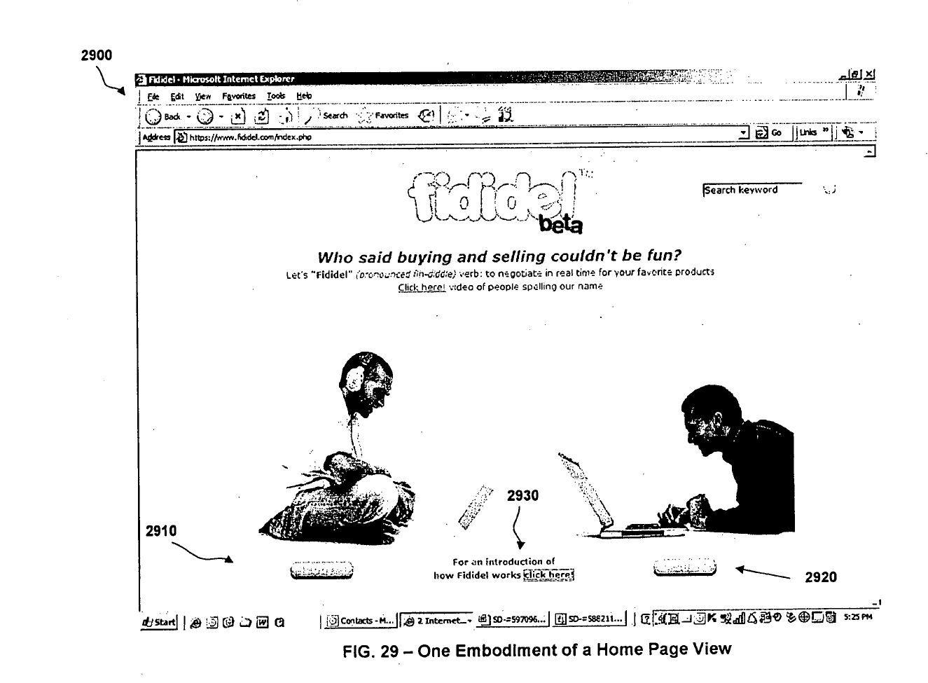

FIG. 25 illustrates another embodiment of a user processing workflow 2500 for managing outsourcing on system 110 in accordance with aspects of the present invention. As shown in FIG. 25, a user, such as a buyer 130, seller 140, or agent 150 may initially be provided with a start stage 2510, such as by providing a system access screen view such as the one illustrated in FIG. 29 to access management system 110. The user may then be provided with a login view, screen or other mechanism to facilitate login to the system 110 at stage 2512, such as the login view illustrated in FIG. 31. Management system 110 may then determine the user's role in interacting with the system at stage 2514, wherein buyers 130 and sellers 140 may be assigned to negotiations based on their interest in a particular item and availability to negotiate, respectively. If the user is an agent 150, the outsourcing module 338 and central queue 339 may be notified at stage 2520 of the agent 150's availability and the agent may then be assigned to a list or pool of available agents. The agent 150 may then be assigned to a negotiation at stage 2522 based on agent selection criteria, such as is described elsewhere herein, and in particular with respect to FIG. 3b and FIG. 3c. Once the buyer 130, seller 140 and/or agent 150 have been assigned to a negotiation, the negotiation may be facilitated by system 110 at stage 2524, such that the buyer 130, seller 140 and/or agent 150 can communicate offers, counteroffers, terms and other conditions related to the negotiation. If terms are agreed upon at stage 2540, payment of the seller 140 and/or agent 150 may be supported at stage 2542, and a record of the negotiation created at stage 2544. If there is remaining inventory to be sold, the transaction may be returned to stage 2560 for logout or repeat of the workflow. Alternately, the sale may be closed at stage 2548. If the user chooses to logout at stage 2565, the negotiation session may be ended at stage 2565, and users removed from the site, such as by indicating that the seller 140 or agent 150 are no longer available and a buyer 130 is no longer on the site.

Attention is now directed to FIGS. 29-46, which illustrate aspects of various embodiments of interactive screen views in accordance with aspects of the present invention. It is noted that the screen views illustrated in FIG. 29-46 are shown in the context of a web browser display with particular placement of elements, however, the invention is not so limited, and other display interfaces and associated elements are within the spirit and scope of the invention. In addition, the various screen views are provided in the context of a particular implementation, provided generally under the FIDIDEL brand name and service mark, and by an associated Fididel service provider; however, the invention is not intended to be limited to a particular brand or service provider.

Turning to FIG. 29, an embodiment of a user access or homepage screen 2900 is shown. This screen generally allows users to select options for browsing and buying items offered for sale via an online negotiations format and/or selling items. A user may be provided with associated buttons or other user selection or actuation options allowing a user to select whether to buy an item, by selecting button 2910, or sell an item, by selecting button 2920. Other options and functions may also be provided, such as menus or options for performing a search, such as a keyword search, on particularly desired items, as well as provider other user items or information, as well as an online negotiations system introduction to buyer 130 and seller 140 or agent 150 interaction, such as by selecting link 2930.

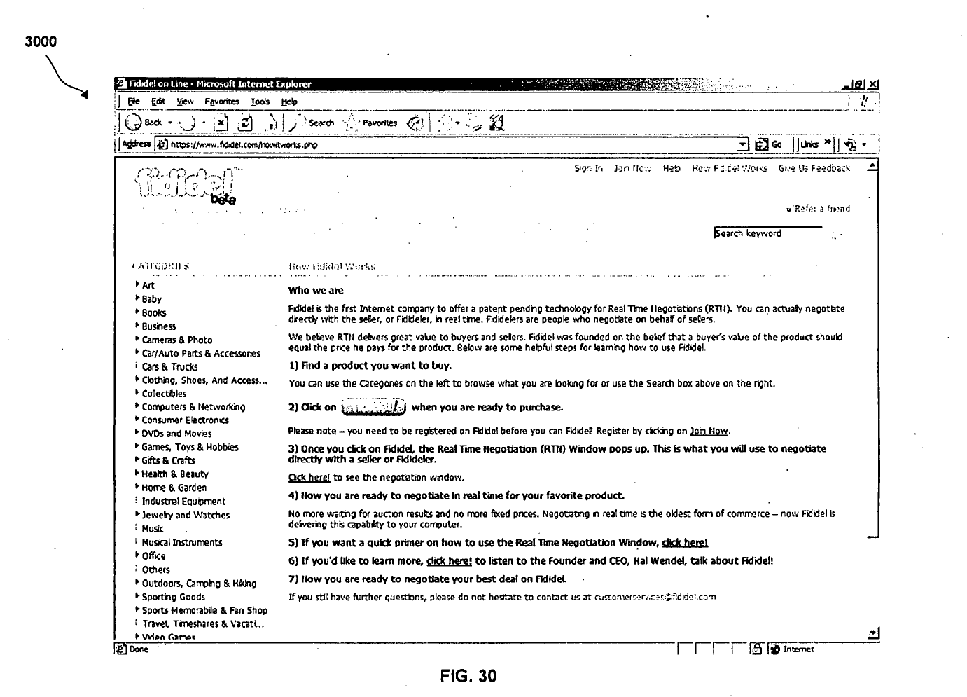

FIG. 30 illustrates an embodiment of an online negotiation introduction view 3000 describing use and interaction with an online negotiations management system such as management system 110.

FIG. 31 illustrates an embodiment of a user sign-up and log-in screen view 3100. Such a screen may be provided to allow a user to sign-up to use an online negotiation site, such as may be provided by system 110, via a sign-up selection button 3110 and/or to log-in once the user is signed up via a log-on selection button 3120. Additional features and options may also be provided in such a log-in screen, including those shown in FIG. 31.

FIG. 32 illustrates an embodiment of an item listing screen view 3200. Once a user has signed on or otherwise accessed the online negotiations site such an item listing screen view may be provided, showing items offered for sale, sales and listing categories, seller information, and/or other user options. The listing screen view may include a goods category list 3210 or other listing of categories or other classification criteria for goods offered for sale. The goods category list may further include subcategories as shown in 3210, allowing a user to select or scroll through general categories of goods offered for sale. In addition, information associated with a specific sales item 3220 may be provided. This may include information related to the item such as an icon, photograph, textual description of the item or associated item characteristics, seller information, asking price information, and/or other item related information. The display may be configured to allow the user to select the item via the icon, photograph, textual information, or other information, with the selection then hyperlinked to a more detailed item display view as shown in FIG. 33. In addition, a negotiation selection option or button 3230 may be provided in conjunction with a particular item or set of items, with negotiation selection button 3230 allowing a user to select or actuate the button to allow a user to immediately enter into an online negotiation for purchase of the item. In an exemplary embodiment, negotiations selection button 3230 may be identified as a “Fididel!” or “Fididel Now” selection item, such as an icon, button or other actuation mechanism to indicate to the user that online negotiations may be initiated via actuation of the button.

FIG. 33 illustrates an embodiment of a detailed item display screen 3300 illustrating information associated with the item offered for sale 3310 as well as a negotiations selection button 3230. Display screen 3300 may also include other information such as seller profile information 3330, which may include information about the seller and/or information about seller negotiation transactions or other seller related information. If a user is interested in negotiating for an offered item, such as item 3310, the user may actuate negotiations selection button 3230, which will then signal the system that the user wishes to enter into real time negotiation over the offered item.

FIG. 34 illustrates one embodiment of a negotiation assignment screen view 3400. When a buyer 130 has selected negotiations selection button 3230, an indication is sent to the online negotiations management system 110 requested that an agent 150 be assigned to negotiate on behalf of the buyer, as described previously herein. A message window or other display 3420 may be provided informing the buyer 130 that negotiations management system 110 is reviewing the negotiations request and assigning the negotiation to an available agent 150. In addition, an interactive negotiations panel 3410 may also be provided for facilitating interaction between the buyer 130 and agent 150 or seller 140.

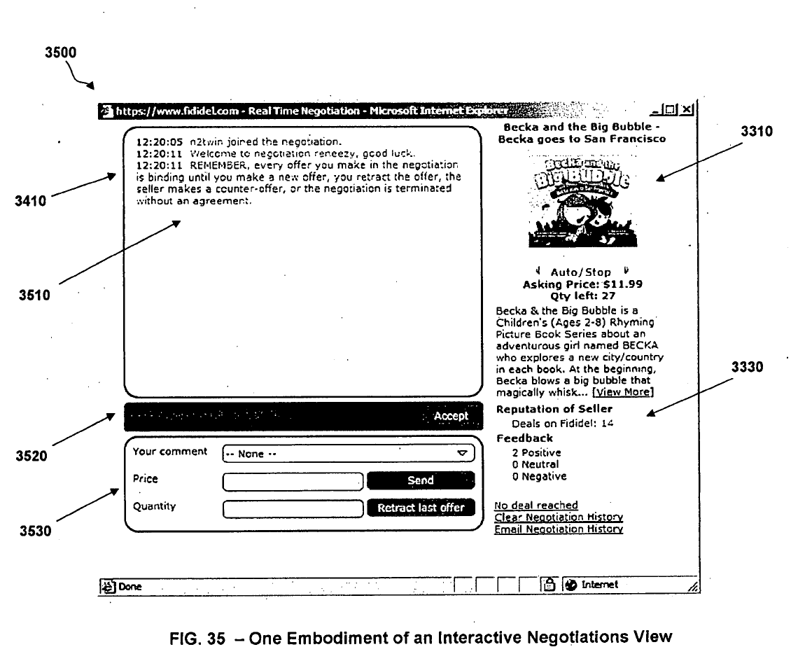

FIG. 35 illustrates one embodiment of an interactive negotiations view 3500 for facilitating negotiation communication between the buyer 130 and agent 150 or seller 140. Interactive negotiations view 3500 (also denoted as a real time negotiation (RTN) window) may include a negotiations panel 3410, which may include one or more sub-panels, along with information about the item 3310, information about the seller 3330, as well as other options and information. Negotiations panel 3410 may include a running negotiation summary sub-panel display 3510, where information associated with the negotiation and associated actions related to the negotiation session, including information about the time, agent 150 or seller 140, general help or information, buyer 130 or agent 150 responses and offers/counteroffers, or other information may be provided. For example, display 3510 illustrates that an agent 150, denoted as “n2twin,” joined the negotiation after a buyer 130 request, and additional information about the negotiation process, such as contractual information or other information, may also be provided. The additional information may be provided in display 3510 and/or in associated panels in negotiation panel 3410, such as information regarding the latest offer, along with an accept button, is shown in sub-panel 3520. In addition, a user interaction sub-panel 3530, including items such as a pulldown window or other selection mechanism, may be provided alone or as part of panel 3410 to allow a buyer 130 to select and send information to the seller 140 or agent 150 regarding comments, offered price, counter-offers, quantity, retraction of previous offers or other information related to the negotiation. It is noted that similar negotiation interfaces and panels may be provided to the negotiator (agent 150 or seller 140) to facilitate interaction with the buyer 130.

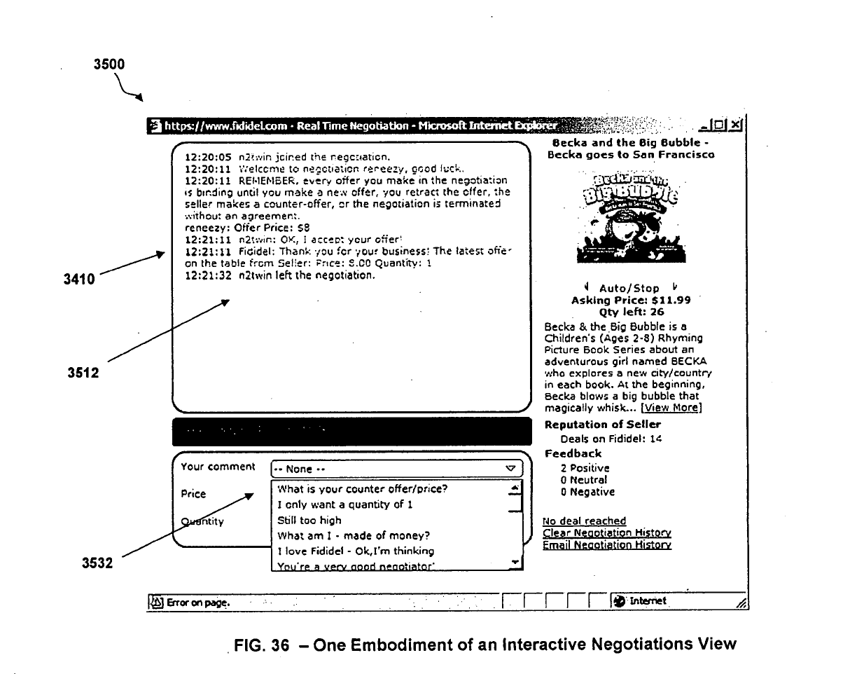

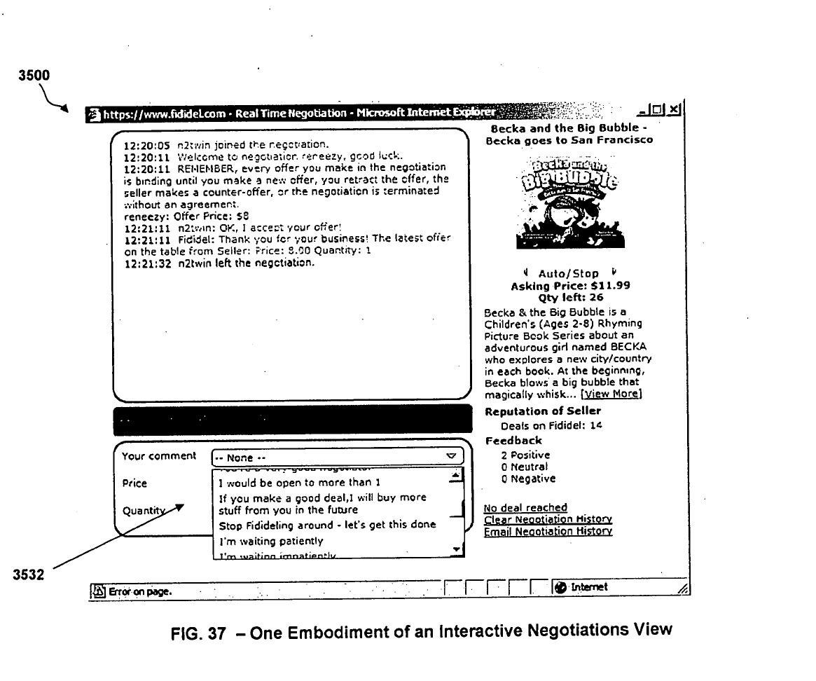

FIG. 36 illustrates additional features of an embodiment of negotiations view 3500. In this display, the buyer 130, denoted as “reneezy,” has offered $8 for the listed item 3310, and the agent 150, n2twin, has accepted the offer as shown in dialog 3512. At this point the negotiation may be closed as indicated in dialog 2512, and the agent, n2twin, disconnected from the negotiation process. FIG. 36 further illustrates additional features of an embodiment of negotiations view 3500 wherein the buyer 130 may be provided with a pulldown menu 3532, or other selection mechanism, allowing the buyer 130 to communicate to the agent 150. In one embodiment the pulldown menu 3532 includes a specific number of predefined options for reply. Alternately, in some embodiments the buyer 130 may be provided with a window or other display to type or otherwise enter specific responses. FIG. 37 illustrates some additional predefined representative buyer responses that may be selected in responding to an agent.

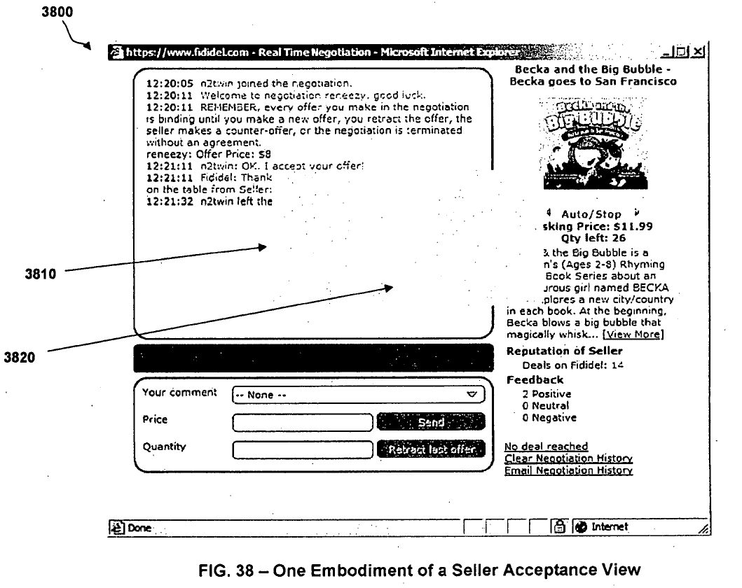

FIG. 38 illustrates a seller acceptance view 3800, wherein a seller 140's acceptance of the buyer 130's offer (in this case $8) is confirmed in display 3810 and a link 3820 is provided to allow the buyer to complete the transaction and pay for the item.

Once a buyer 130 selects payment link 3820, he or she may be directed to a transaction payment panel, such as panel 3900 as shown in FIG. 39, wherein item information 3910 and buyer 130 information 3920 may be provided. If the buyer 130 hasn't logged in or wishes to enter payment transaction information and/or create a new buyer account, he or she may be provided with a panel facilitation panel such as payment view 4000 as shown in FIG. 40. In this panel the buyer is provided with an interface to select payment by various means, such as by credit card, PayPal, and/or other financial payment services and mechanisms.

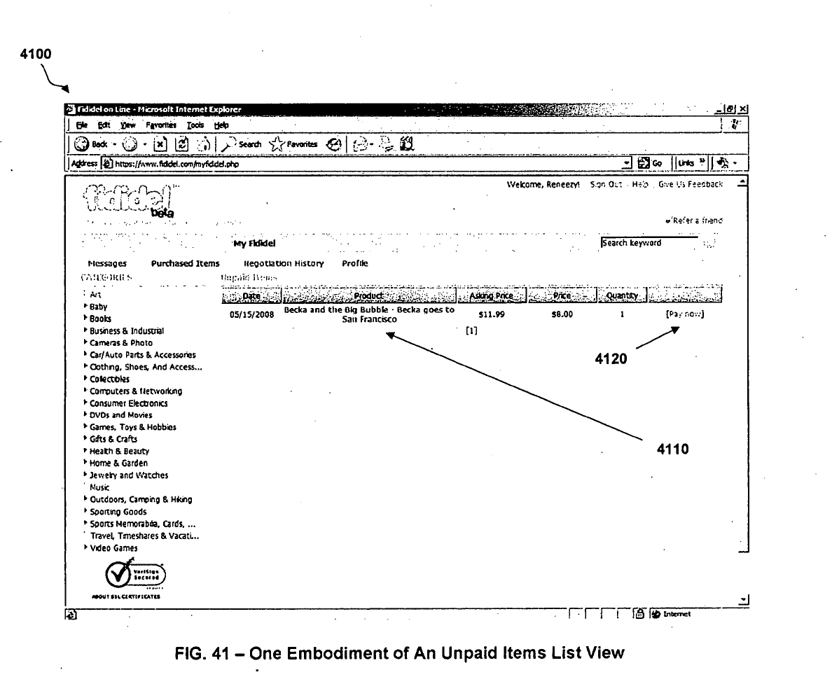

FIG. 41 illustrates an embodiment of an unpaid items list view 4100. A view such as view 4100 may be provided to show buyers 130, sellers 140 and/or agents 150 information regarding items purchased by buyers 130 that have not yet been paid for. For example, for each buyer a list 4110 of all items for which a negotiated sale price has been reached may be provided, with the seller 140 then being provided with a link 4120 or other mechanism to go to a payment screen, such as is shown in FIG. 39, to complete the transaction.

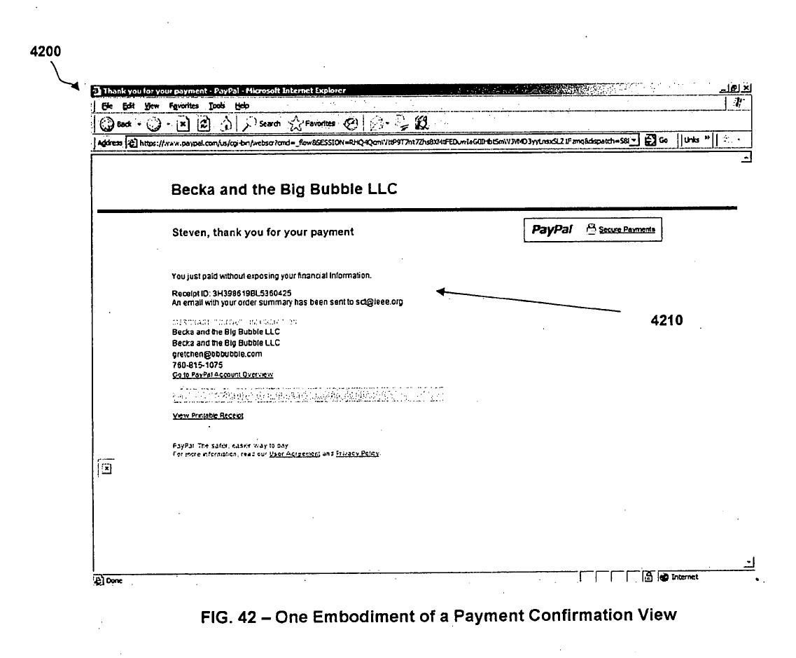

FIG. 42 illustrates an embodiment of a payment confirmation view 4200. A view such as view 4200 may be provided to allow a buyer 130, seller 140 and/or agent 150 to see information 4210 related to a completed transaction, such as buyer's name or user ID, transaction receipt, email addresses or other contact information associated with the buyer and/or seller, printable receipt links and/or other transaction related information.

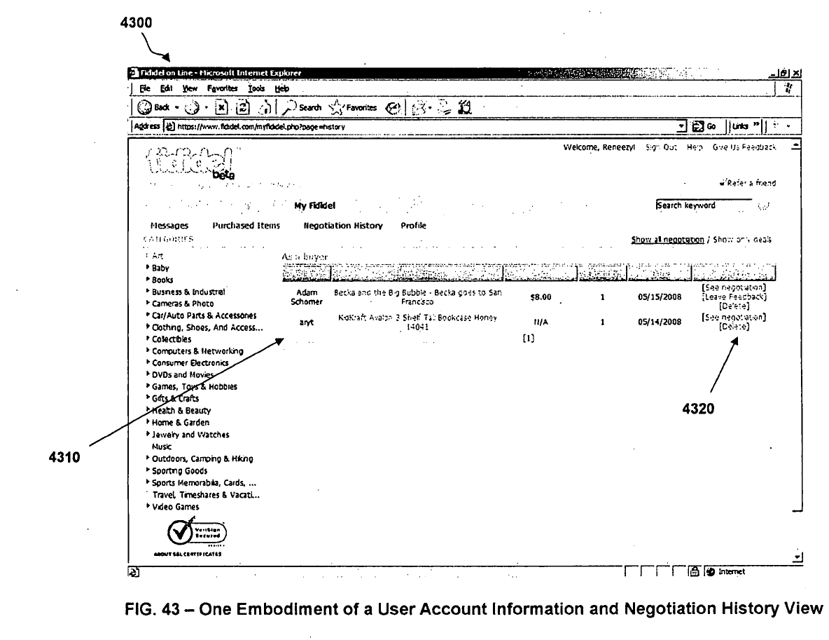

FIG. 43 illustrates an embodiment of a user account information and negotiation history view 4300. A view such as view 4300 may be provided to allow a buyer 130, seller 140 and/or agent 150 to see information 4310 related to a particular negotiation. For example, this information may include a history of the user's negotiations including information such as the seller name or ID, item information, pricing, quantities, dates transaction completion information and/or other transaction related information. Additional links 4320 may be provided to allow access to information such as a detailed transaction script (shown in FIG. 44), provision to leave feedback for sellers 140 regarding completed transactions as well as other information.

FIG. 44 illustrates one embodiment of a negotiations history view 4400. A view such as view 4400 may be provided to allow a buyer 130, seller 140 and/or agent 150 to see a detailed scripting 4410 of information related to a particular negotiation. For example, details regarding the negotiation date, party (Fididel system, agent, user/buyer, etc.), specific transaction offers, counteroffers and responses as well as other transaction related information. Information 4410 includes a list of the date, party and response initiated by each party throughout the transaction. In this particular transaction, the initial offer price was set at $118, and was progressively lowered by the agent 150 to $115; however, no agreement was reached.

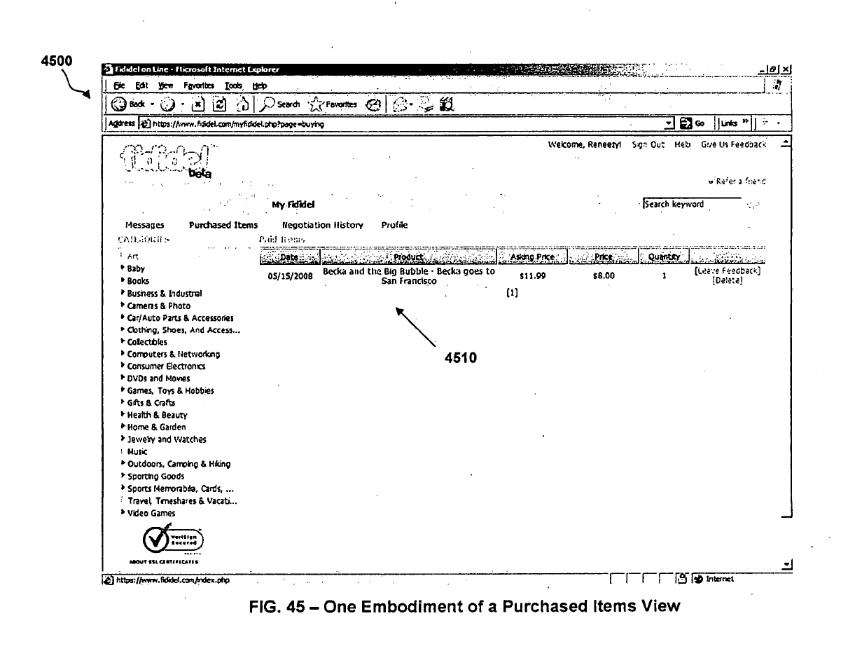

FIG. 45 illustrates one embodiment of a purchased item view 4500. A view such as view 4500 may be provided to allow a buyer 130, seller 140 and/or agent 150 to see a list 4510 of all purchased and paid for items purchased by a particular buyer 130. A similar view (not shown) may be provided for each seller 140 or agent 150 listing information related to each transaction, such as sales information, sales completion or non-completion and/or other transaction related information.

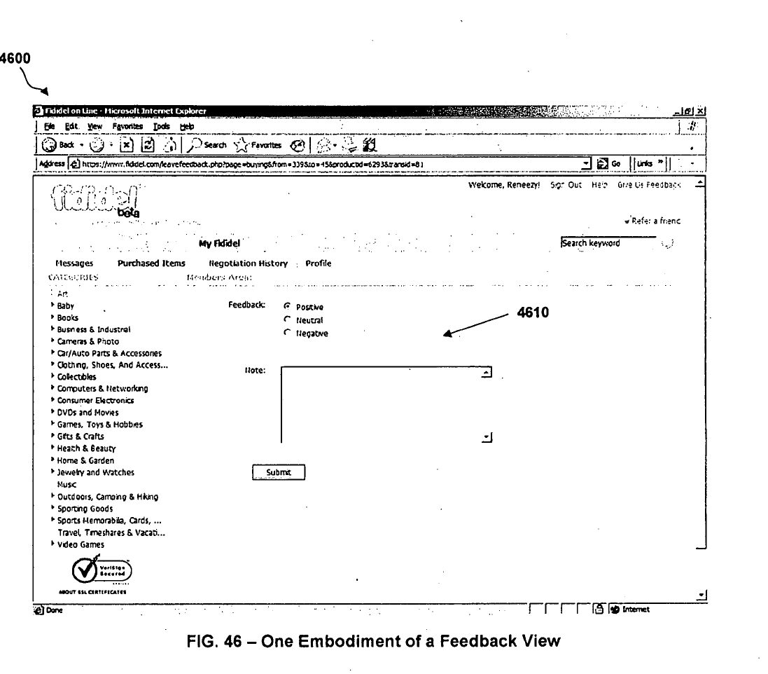

FIG. 46 illustrates one embodiment of a feedback view 4600. A view such as view 4600 may be provided to allow a buyer 130 to rate and/or comment on a seller 140 through a feedback interface 4610. In example view 4600 the buyer 130 is provided with a choice of feedback options including positive, neutral and negative, as well as a note or comment screen to provide textual feedback comments on the transaction.

In conjunction with a system such system 110 as shown in FIG. 1, it may be desirable to provide associated systems and methods for providing and/or facilitating the seller 140's ability to contact one or more buyers 130. Such a contact is denoted generically herein as an electronic communication or message.

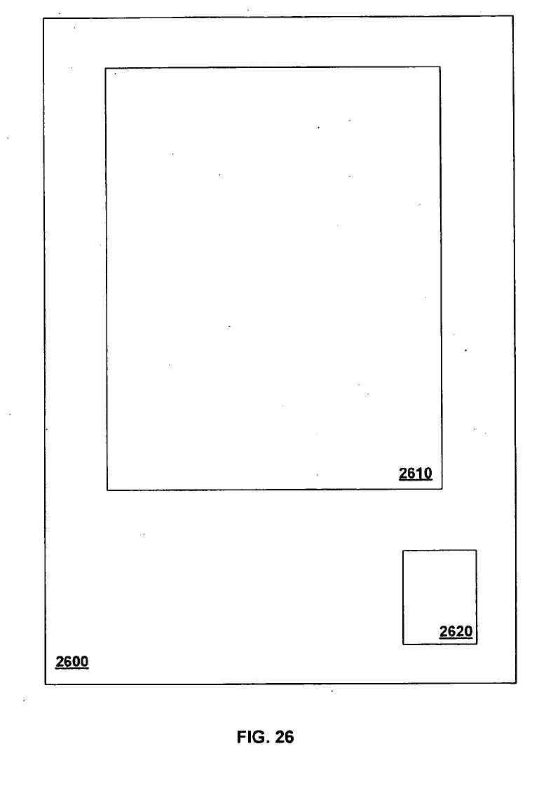

Attention is now directed to FIG. 26 which illustrates an such an electronic communication or message 2600 in accordance with aspects of the present invention. Such a message may be an email message, such as is commonly generated, transmitted and received by standard email client applications such as Microsoft Outlook, or by web based applications such as Gmail, Hotmail, or Yahoo Mail. Alternately, such a communication could be a cellular or portable device based communication or other type of message. Message 2600 will typically include a content component 2610 including elements such as a message title, header, send & receive addresses, as well as message content.

In accordance with aspects of the present invention, message 2600 will also include a selection button 2620, also denoted herein as a “Fididel Now” or a “Fididel!” email button or just a “Fididel Now” or “Fididel!” button or selection item. Selection button 2620 may be positioned at any of various areas in message 2600, not just in the lower right corner as shown in FIG. 26. In addition, the size, shape, coloring, text, and other appearance characteristics of selection button 2620 may also vary depending on the viewing device as well as system, sender, and/or receiver preferences. Likewise, information associated with or provided by selection button 2620 may vary, but will typically include, at a minimum, information related to one or more items offered at an online site such as a web site provided by management system 110.

In an exemplary embodiment, when a potential user (buyer 130) receives a message 2600, he can move a mouse cursor, such as a cursor provided on a standard computer using a mouse, or cursors manipulatable by other pointing devices such as scrolls, pushbuttons, or other equivalent means, over selection button 2620. Once the cursor is near or over selection button 2620, an indication of the availability of items offered by a seller 140 on a system such as system 110 as is described herein and in the related applications, and illustrated in FIG. 1, is then provided. In one exemplary embodiment, such a system may be an online negotiations system as provided by Fididel, Inc., at the web site www.fididel.com.

In an exemplary embodiment, technology known as HTML hover over technology may be used to implement information related to the availability of items when the mouse cursor or other pointer or indicator is over or in proximity to selection button 2620. Alternately, other technology may be used instead of or in addition to HTML hover over technology. As an example of this functionality, in one embodiment, when a message recipient moves his or her cursor over selection button 2620, a text box may appear on the screen describing items that may be available for sale on the Fididel system, and/or other related information. The indication may also include an audible message, such as a beep, alarm, ring tone, text to voice converted message, or other audible indication of availability of items for negotiation. Other text, audible, or visual indicators may also be used.

If the message recipient then selects, clicks on, presses, or otherwise actuates selection button 2620, he or she may be directed to a negotiation system, such as the Fididel System as described elsewhere herein, wherein a negotiation, including outsourced negotiations such as are described herein and in the related applications, may be commenced.

In a typical embodiment, connectivity to the negotiations site may be provided by an embedded hyperlink or other connection technique, embedded in or otherwise provided by or facilitated by selection button 2620.

In an exemplary embodiment, a message 2600, including a selection button 2620, may be provided as follows. A seller 140 may create listings for one or more items on a web page and associated system, such as a Fididel system. In one example, these listings may be described as personal classifieds, and an account associated with the personal classifieds may be denoted as a Fididel account.

A seller 140 associated with such personal classifieds may have or may create an email account at an online site such as Yahoo mail, Hotmail, and the like using an online email application. Alternately, a seller 140 could use a personal computer based email client application program, such as Microsoft Outlook or a similar or equivalent application. The seller 140 may then select to have his Fididel account linked or associated with his email application. This may be done in part with and/or facilitated by a module, such as a plug-in (described in more detail as follows as a “Fididel Now” or “Fididel!” module or plug-in) or other linking application provided in system 110 or in another system. Once the email and personal classified accounts are linked, when a seller 140 then creates an email for transmission, such as message 2600 shown in FIG. 26, the email will be generated with an included selection button 2620 if there are currently any items available as personal classifieds in the seller's associated Fididel account. In addition to this information, other optional fields of interest to the email user may also be provided. For example, these may include other similar or related items and/or a description area for other products a seller 140 wishes to sell, as well as signature field and/or contact information, or links to other locations or items of potential interest.

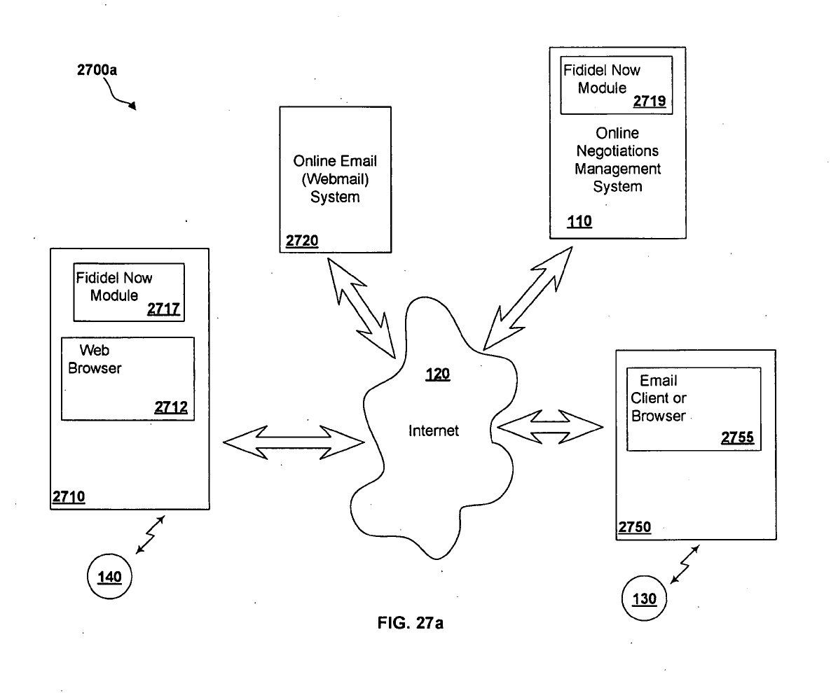

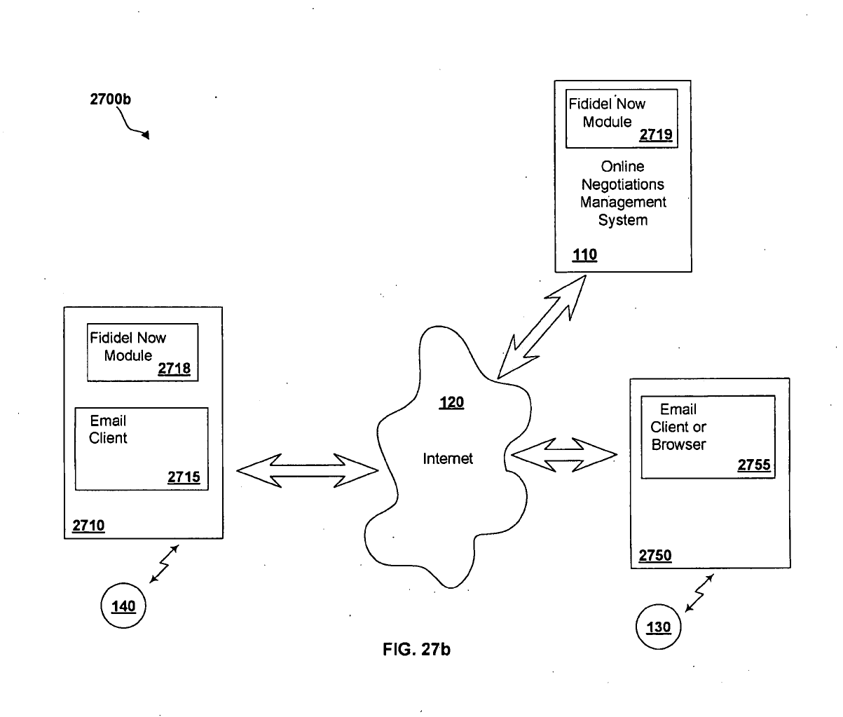

Attention is now directed to FIGS. 27a and 27b which illustrate embodiments of systems 2700a and 2700b to facilitate generation of a message such as message 2600. As shown in FIG. 2700a, a user 140 (typically a seller 140) may own or have access to a computer system 2710, such as a personal computer, which includes applications such as an operating system, web browsers, email clients, and other applications. In addition, system 2710 may include a module 2717, also denoted herein as a “Fididel Now” or “Fididel!” module, configured to support generation of messages such as message 2600. In the embodiment shown in FIG. 2700a, system 2710 is configured to be connected to one or more online email systems 2720, also known, in some embodiments, as “web mail,” wherein a web browser 2712 is connected through the Internet 120, or in some embodiments through other networks, to the online email system 2720 so that a user 140 can communicate availability of items for sale via negotiation in conjunction with an online negotiations management system, such as management system 110. Email messages such as message 2600, including a selection button 2620, may then be provided to a user 130 (typically a buyer 130), on the user 130's system 2750, which may include an email client application 2755 such as Microsoft Outlook, and/or a web browser allowing access to web mail via the Internet. It is noted that other variations of this general configuration are contemplated, such as allowing a cellular phone, PDA, or other portable device to act in addition to, or in place of, system 2710 and/or system 2755.

In one embodiment, module 2717 is configured to interface to and provide information to online email system 2720 to include selection button 2620 in emails sent by user 140. Information in selection button 2620 may be provided by retrieving information from management system 110 via the Internet 120 or via other networks and/or databases (not shown). Once the message or messages 2600 are received by user 130, the user may then merely hover over the selection button 2620, and or click on selection button 2620 to obtain information about potential items of interest, and/or contact management system 110 to enter into an online negotiation.

In another embodiment, a “Fididel Now” or “Fididel!” module 2719 may be provided on one or more servers associated with management system 110 instead of or in addition to “Fididel Now” or “Fididel” module 2717. The server based module 2719 may be configured to obtain information about available auction items and provide the information directly to selection button 2620 and/or provide the information to another application that can then update selection button 2620 accordingly.

Attention is now directed to FIG. 27b, which illustrates an embodiment of a system 2700b, similar to system 2700a. System 2700b may be provided in place of or in addition to a system such as is shown in FIG. 27a.

As shown in FIG. 27b, system 2700b may include an email client application 2715 on user system 2710, such as Microsoft Outlook, to generate and facilitate transmission of email messages. In addition, system 2710 may include a “Fididel Now” or “Fididel!” module 2718 configured to interface with client 2715. In an exemplary embodiment, module 2718 is a plug-in for client 2715, operative to access management system 110, retrieve information related to items listed by user 140, and generate or facilitate generation of selection button 2620 in one or more messages 2600 provided by client application 2715. Alternately and/or in addition, another “Fididel Now” or “Fididel!” module 2719 may be provided on a server associated with management system 110. Module 2719 may be configured to provide similar functionality as module 2718, including retrieving and/or providing information related to items offered by user 140, as well as providing such information to client application 2715 for incorporation in one or more selection buttons 2620 included in one or more messages 2600.

In addition to functionality as provided to individual users, additional embodiments may be provided that are directed to multi-user or corporate contexts. As an example of the functionality provided by one embodiment in a corporate context, a marketing manager associated with a retailer (such as, for example, Circuit City) could go to a home page (Fididel home page) provided in conjunction with system 110, and highlight a special on flat screen televisions. Then, when a Circuit City employee sends an email, a selection button 2620 would be included (for example, at the bottom of his/her signature page) with information associated the most recent update of the information associated with the flat screen items—put another way, the server based Fididel Now or Fididel! module 2619 would be updated to reflect only flat screen information. In addition, as is also described herein and in the related applications, such functionality need not reside solely on a central management system (such as a single system 110), such as a Fididel System, but may also be provided, in whole or part, on a multi-user or third party corporate web site and/or associated system. In such embodiments, messages sent to users would appear to originate in conjunction with the third party or corporate site and would provide information about items available on such a site and/or would provide direct connectivity to such a site.

In an alternate embodiment (not shown), management system 110 may merely provide information to user 140, such as via a web page, email, download, link, or other mechanism, to allow user 140 to copy and paste a URL associated with items offered by user 140 into selection button 2620. For example, a user 140 may be provided with instructions for incorporating such information into one or more emails, as well as a link, object, executable code, or other mechanism for providing the information to the message recipient. The user could then cut and paste the information into his or her email message.

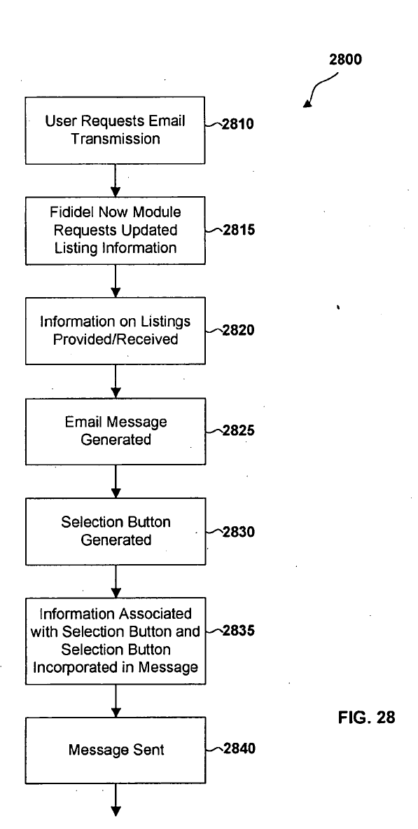

Attention is now directed to FIG. 28 which provides details of an embodiment of an exemplary process 2800 enabling online negotiations. Such as process 2800 is typically implemented in one or more modules within a system such as systems 2700a or 2700b as shown in FIGS. 27a and 27b. One or more stages of process 2700 may be implemented in a Fididel Now or Fididel! module as illustrated in FIGS. 27a and 27b, with such modules based on one or more systems such as client system 2710 and/or management system 110. While the process illustrated in FIG. 28 includes particular stages, it is apparent that other processes including fewer, more, or different stages than those shown in FIG. 28 are within the spirit and scope of the present invention. Accordingly, the process shown in FIG. 28 is provided for purposes of illustration, not limitation.

Process 2800 may begin with a user 140 (typically a seller 140) initiating generation of an email message at stage 2810 either via a webmail connection or in conjunction with a client application. Updated information related to items offered by user 140 may then be retrieved. In one embodiment, a Fididel Now or Fididel! module such as is illustrated in FIGS. 27a and 27b requests such information. Requested information may be then be received and processed at stage 2820. An email message may then be generated at stage 2825, with the email message targeted to a user 130 (typically a buyer 130). This may be done by client application 2715, webmail system 2720, or by other mechanisms for generation electronic communications. The selection button 2620 may then be generated at stage 2830, with information related to the items offered by user 140 linked to the selection button and incorporated into the email message at stage 2835. Once message generation and selection button incorporation is completed, the message may then be sent at stage 2840 to one or more email recipients. Upon receipt, the email recipient may view the message and obtain information about items offered by the seller by moving or positioning a cursor on or near the selection button and/or actuating the selection button.

It is noted that in various embodiments the present invention may relate to processes such as are described or illustrated herein and/or in the related applications. These processes are typically implemented in one or more modules comprising systems as described herein and/or in the related applications, and such modules may include computer software stored on a computer readable medium including instructions configured to be executed by one or more processors. It is further noted that, while the processes described and illustrated herein and/or in the related applications may include particular stages, it is apparent that other processes including fewer, more, or different stages than those described and shown are also within the spirit and scope of the present invention. Accordingly, the processes shown herein and in the related applications are provided for purposes of illustration, not limitation.

As noted, some embodiments of the present invention may include computer software and/or computer hardware/software combinations configured to implement one or more processes or functions associated with the present invention such as those described above and/or in the related applications. These embodiments may be in the form of modules implementing functionality in software and/or hardware software combinations. Embodiments may also take the form of a computer storage product with a computer-readable medium having computer code thereon for performing various computer-implemented operations, such as operations related to functionality as describe herein. The media and computer code may be those specially designed and constructed for the purposes of the present invention, or they may be of the kind well known and available to those having skill in the computer software arts, or they may be a combination of both.

Examples of computer-readable media within the spirit and scope of the present invention include, but are not limited to: magnetic media such as hard disks; optical media such as CD-ROMs, DVDs and holographic devices; magneto-optical media; and hardware devices that are specially configured to store and execute program code, such as programmable microcontrollers, application-specific integrated circuits (“ASICs”), programmable logic devices (“PLDs”) and ROM and RAM devices. Examples of computer code may include machine code, such as produced by a compiler, and files containing higher-level code that are executed by a computer using an interpreter. Computer code may be comprised of one or more modules executing a particular process or processes to provide useful results, and the modules may communicate with one another via means known in the art. For example, some embodiments of the invention may be implemented using assembly language, Java, C, C#, C++, or other programming languages and software development tools as are known in the art. Other embodiments of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

I claim:

1. A computer implemented method for providing an online sales negotiation, comprising:
receiving, from a first buyer, a request to negotiate for a first item of a plurality of items offered for sale;
assigning, responsive to the request to negotiate, a first negotiator to a first negotiation session with the first buyer, for purchase of the first item; and
providing a user interface to the first buyer to facilitate the first negotiation session; wherein said request to negotiate is provided in response to a listing of ones of said plurality of items offered for sale.

2. The computer implemented method of claim 1 wherein the first negotiator is a first agent, said first agent assigned to negotiate for sale of said first item on behalf of a first seller offering the first item.

3. The computer implemented method of claim 2 wherein the first agent is assigned to the first negotiation session based on the ordering of the first agent in a list of available agents.

4. The computer implemented method of claim 2 wherein the first agent is assigned to the first negotiation session based on a random selection.

5. The computer implemented method of claim 2 wherein the first agent is assigned to the first negotiation session based on one or more experience or expertise criteria of the first agent, wherein said one or more experience or expertise criteria are related to a characteristic of the first item.

6. The computer implemented method of claim 2 wherein assigning the first agent to the first negotiation session comprises:
sending, to a plurality of available agents, a request to negotiate for the first item;
receiving, from a first replying agent of said plurality of available agents, an acknowledgment to the request to negotiate; and
selecting said first replying agent as the first agent, wherein the acknowledgment to the request to negotiate is a first temporally received acknowledgment from said plurality of agents.

7. The computer implemented method of claim 1 wherein the first negotiator is a first seller, said first seller offering the first item for sale.

8. The computer implemented method of claim 1 wherein said assigning a first negotiator comprises:
determining if a first seller offering said first item is available for negotiation; and
assigning, responsive to said determining, the first seller to the first negotiation session.

9. The computer implemented method of claim 8 further comprising:
selecting, if the first seller is unavailable, a first agent; and
assigning the selected first agent as the first negotiator.

10. The computer implemented method of claim 9 wherein the first agent is selected based on the ordering of the first agent in a list of available agents.

11. The computer implemented method of claim 10 wherein the first agent is the first agent listed in the ordering of available agents.

12. The computer implemented method of claim 9 wherein the first agent is selected based on a random selection.

13. The computer implemented method of claim 9 wherein the first agent is selected based on one or more experience or expertise criteria of the first agent, wherein said one or more experience or expertise criteria are related to a characteristic of the first item.

14. The computer implemented method of claim 8 further comprising:
determining, if the first seller is unavailable, whether a nominated agent is available for negotiation; and
assigning, responsive to said determining, the nominated agent as the first agent.

15. The computer implemented method of claim 14 further comprising selecting, from a plurality of nominated agents, the nominated agent.

16. The computer implemented method of claim 15 wherein said selecting the nominated agent comprises:
sending, to said plurality of nominated agents, a request to negotiate for the first item;
receiving, from a first replying nominated agent of said plurality of nominated agents, an acknowledgment to the request to negotiate; and
selecting said first replying nominated agent as the nominated agent, wherein the acknowledgment to the request to negotiate is a first temporally received acknowledgment from said plurality of nominated agents.

17. The computer implemented method of claim 14 further comprising:
selecting, if a nominated agent is unavailable, the first agent from a list of available agents; and
assigning the selected first agent as the first negotiator.

18. The computer implemented method of claim 17 wherein the first agent is selected based on the ordering of the first agent in the list of available agents.

19. The computer implemented method of claim 18 wherein the first agent is the first agent listed in the ordering of available agents.

20. The computer implemented method of claim 17 wherein the first agent is selected based on a random selection.

21. The computer implemented method of claim 17 wherein the first agent is selected based on one or more experience or expertise criteria of the first agent, wherein said one or more experience or expertise criteria are related to a characteristic of the first item.

22. The computer implemented method of claim 17 wherein assigning the first agent to the first negotiation session comprises:
sending, to a plurality of available agents, a request to negotiate for the first item;
receiving, from a first replying agent of said plurality of available agents, an acknowledgment to the request to negotiate; and
selecting said first replying agent as the first agent, wherein the acknowledgment to the request to negotiate is a first temporally received acknowledgment from said plurality of agents.

23. The computer implemented method of claim 1 further comprising providing a listing of ones of said plurality of items offered for sale.

24. The computer implemented method of claim 23 wherein the listing of a plurality of items offered for sale is provided on a web page.

25. The computer implemented method of claim 23 wherein the listing of a plurality of items offered for sale is provided on a mobile web page.

26. The computer implemented method of claim 23 wherein the listing of a plurality of items offered for sale includes one or more selection items associated with one or more of said plurality of items, wherein said selection items are configured to connect the first buyer, upon actuation of the selection item, to the negotiation session through the user interface.

27. The computer implemented method of claim 1 wherein the request to negotiate is provided from the first buyer through a web browser.

28. The computer implemented method of claim 27 wherein the web browser is provided on a computer.

29. The computer implemented method of claim 27 wherein the web browser is a mobile web browser provided on a mobile device.

30. The computer implemented method of claim 1 wherein the user interface includes a negotiation panel.

31. The computer implemented method of claim 30 wherein the negotiation panel includes a sub-panel configured to provide buyer and agent or seller information related to the negotiation.

32. The computer implemented method of claim 30 wherein the negotiation panel includes a sub-panel configured to provide one or more negotiation response pulldown menus, said pulldown menus configured to allow the first buyer to select a negotiation response to send to the agent or seller.

33. The computer implemented method of claim 32 wherein the pulldown menus include a set of predefined buyer responses.

34. The computer implemented method of claim 30 wherein the negotiation panel includes a sub-panel configured to provide one or more negotiation response text windows, said text windows disposed to receive a text based negotiation response from the first buyer to send to the agent or seller.

35. The computer implemented method of claim 1 further comprising providing, responsive to agreed upon sales terms between the first buyer and first negotiator, a payment interface, said payment interface disposed to facilitate receipt of first buyer payment information.

36. The computer implemented method of claim 35 further comprising crediting, responsive to a first buyer payment, a seller account.

37. The computer implemented method of claim 35 further comprising crediting, responsive to a first buyer payment, an agent account.

38. The computer implemented method of claim 1 further comprising storing a set of information associated with the first negotiation session, said set of information including information related to first buyer actions and first negotiator actions.

39. The computer implemented method of claim 38 further comprising displaying, in the user interface, a summary of first buyer actions and first negotiator actions of the first negotiation session.

40. The computer implemented method of claim 1 further comprising providing a second user interface, to the first negotiator, to facilitate the first negotiation session.

41. The computer implemented method of claim 40 wherein the second user interface includes a negotiator panel.

42. The computer implemented method of claim 41 wherein the negotiator panel includes a sub-panel configured to provide buyer and agent or seller information related to the negotiation.

43. The computer implemented method of claim 41 wherein the negotiator panel includes a sub-panel configured to provide one or more negotiation response pulldown menus, said pulldown menus configured to allow the first negotiator to select a negotiation response to send to the first buyer.

44. The computer implemented method of claim 43 wherein the pulldown menus include a set of predefined negotiator responses.

45. The computer implemented method of claim 41 wherein the negotiator panel includes a sub-panel configured to provide one or more negotiation response text windows, said text windows disposed to receive a text based negotiation response from the first negotiator to send to the first buyer.

46. A system for facilitating online negotiations comprising:
a processor;
a memory coupled to the processor; and
a machine readable medium including a set of instructions for execution on the processor to:
receive, from a first buyer, a request to negotiate for a first item of said plurality of items offered for sale;
assign, responsive to the request to negotiate, a first negotiator to a first negotiation session with the first buyer, for purchase of the first item; and
provide a user interface to the first buyer to facilitate the first negotiation session; wherein said request to negotiate is provided in response to a listing of ones of said plurality of items offered for sale.

47. The system of claim 46 wherein the first negotiator is a first agent, and said instructions include instructions to assign the first agent to negotiate for sale of said first item on behalf of a first seller offering the first item.

48. The system of claim 47 wherein the instructions include instructions to assign the first agent to the first negotiation session based on the ordering of the first agent in a list of available agents.

49. The system of claim 47 wherein the instructions include instructions to assign the first agent to the first negotiation session using a random selection.

50. The system of claim 47 wherein the instructions include instructions to assign the first agent to the first negotiation based on one or more experience or expertise criteria of the first agent, wherein said one or more experience or expertise criteria are related to a characteristic of the first item.

51. The system of claim 47 wherein the instructions include instructions to:
send, to a plurality of available agents, a request to negotiate for the first item;
receive, from a first replying agent of said plurality of available agents, an acknowledgment to the request to negotiate; and
select said first replying agent as the first agent, wherein the acknowledgment to the request to negotiate is a first temporally received acknowledgment from said plurality of available agents.

52. The system of claim 46 wherein the instructions include instructions to assign a first seller as the negotiator, wherein the first seller is offering the first item for sale.

53. The system of claim 46 wherein the instructions include instructions to:
determine if a first seller offering said first item is available for negotiation; and
assign, responsive to said determining, the first seller to the negotiation.

54. The system of claim 53 wherein the instructions further include instructions to:
select, if the first seller is unavailable, a first agent; and
assign the selected first agent as the first negotiator.

55. The system of claim 54 wherein the instructions include instructions to select the first agent based on the ordering of the first agent in a list of available agents.

56. The system of claim 55 wherein the first agent is the first agent listed in the ordering of available agents.

57. The system of claim 54 wherein the instructions include instructions to select the first agent using a random selection.

58. The system of claim 54 wherein the instructions include instructions to select the first agent based on one or more experience or expertise criteria of the first agent, wherein said one or more experience or expertise criteria are related to a characteristic of the first item.

59. The system of claim 53 wherein the instructions include instructions to:
determine, if the first seller is unavailable, whether a nominated agent is available for negotiation; and
assign, responsive to said determining, the nominated agent as the first agent.

60. The system of claim 59 wherein the instructions include instructions to:
select, from a plurality of nominated agents, the nominated agent.

61. The system of claim 60 wherein the instructions include instructions to:
send, to said plurality of nominated agents, a request to negotiate for the first item;
receive, from a first replying nominated agent of said plurality of nominated agents, an acknowledgment to the request to negotiate; and
select said first replying nominated agent as the nominated agent, wherein the acknowledgment to the request to negotiate is a first temporally received acknowledgment from said plurality of nominated agents.

62. The system of claim 59 wherein the instructions include instructions to:
select, if a nominated agent is unavailable, the first agent from a list of available agents; and
assign the selected first agent as the first negotiator.

63. The system of claim 62 wherein the instructions include instructions to select the first agent based on the ordering of the first agent in the list of available agents.

64. The system of claim 63 wherein the first agent is the first agent listed in the ordering of available agents.

65. The system of claim 62 wherein the instructions include instructions to select the first agent based on a random selection.

66. The system of claim 62 wherein the instructions include instructions to select the first agent based on one or more experience or expertise criteria of the first agent, wherein said one or more experience or expertise criteria are related to a characteristic of the first item.

67. The system of claim 62 wherein the instructions include instructions to select the first agent by:
sending, to a plurality of available agents, a request to negotiate for the first item;
receiving, from a first replying agent of said plurality of available agents, an acknowledgment to the request to negotiate; and
selecting said first replying agent as the first agent, wherein the acknowledgment to the request to negotiate is a first temporally received acknowledgment from said plurality of available agents.

68. The system of claim 46 wherein the instructions include instructions to provide a listing of ones of said plurality of items offered for sale.

69. The system of claim 68 wherein the instructions to provide a listing of ones of said plurality of items offered for sale include instructions to provide the listing of a plurality of items offered for sale on a web page.

70. The system of claim 68 wherein the instructions to provide a listing of ones of said plurality of items offered for sale include instructions to provide the listing of a plurality of items offered for sale on a mobile web page.

71. The system of claim 68 wherein the instructions to provide a listing of ones of said plurality of items offered for sale include instructions to provide one or more selection items associated with the one or more of said plurality of items, wherein said selection items are configured to connect the first buyer, upon actuation, to the negotiation session through the user interface.

72. The system of claim 46 wherein the request to negotiate is provided from the first buyer through a web browser.

73. The system of claim 72 wherein the web browser is provided on a computer.

74. The system of claim 72 wherein the web browser is a mobile web browser provided on a mobile device.

75. The system of claim 46 wherein the instructions include instructions to provide a negotiation panel on a device associate with the first buyer.

76. The system of claim 75 wherein the negotiation panel includes a sub-panel configured to provide buyer and agent or seller information related to the negotiation.

77. The system of claim 75 wherein the negotiation panel includes a sub-panel configured to provide one or more negotiation response pulldown menus, said pulldown menus configured to allow the first buyer to select a negotiation response to send to the agent or seller.

78. The system of claim 77 wherein the pulldown menus include a set of predefined buyer responses.

79. The system of claim 75 wherein the negotiation panel includes one or more negotiation response text windows, said text windows disposed to receive a text based negotiation response from the first buyer to send to the agent or seller.

80. The system of claim 46 wherein the instructions include instructions to provide, responsive to agreed upon sales terms between the first buyer and first negotiator, a payment interface, said payment interface disposed to facilitate receipt of first buyer payment information.

81. The system of claim 80 wherein the instructions include instructions to credit, responsive to first buyer payment for the first sale item, a seller account.

82. The system of claim 80 wherein the instructions include instructions to credit, responsive to first buyer payment for the sale item, an agent account.

83. The system of claim 46 wherein the instructions include instructions to store a set of information associated with the first negotiation session, said set of information including information related to first buyer actions and first negotiator actions.

84. The system of claim 83 wherein the instructions include instructions to display, in the user interface, a summary of first buyer actions and first negotiator actions of the first negotiation session.

85. The system of claim 46 wherein the instructions include instructions to provide a second user interface, to the first negotiator, to facilitate the first negotiation session.

86. The system of claim 46 wherein the instructions include instructions to provide a negotiation panel in the second user interface.

87. The system of claim 86 wherein the negotiation panel includes a sub-panel configured to provide buyer and agent or seller information related to the negotiation.

88. The system of claim 86 wherein the negotiation panel includes a sub-panel configured to provide one or more negotiation response pulldown menus, said pulldown menus configured to allow the first negotiator to select a negotiation response to send to the first buyer.

89. The system of claim 88 wherein the pulldown menus include a set of predefined buyer responses.

90. The system of claim 86 wherein the negotiation panel includes a sub-panel configured to provide one or more negotiation response text windows, said text windows disposed to receive a text based negotiation response from the first negotiator to send to the first buyer.

91. A computer implemented method for providing an online sales negotiation on a third party web site, comprising:
providing a user interface, on the third party web site, disposed to receive a request from a first buyer to negotiate for purchase of a first item of a plurality of items offered on the third party web site by a first seller, wherein said first seller is associated with the third party web site;
receiving, from the first buyer, a request to negotiate for the first item;
assigning, responsive to the request to negotiate, a first negotiator to a first negotiation session with the first buyer, for purchase of the first item; and
providing a user interface, on the third party web site, to the first buyer to facilitate the first negotiation session.

92. The computer implemented method of claim 91 wherein the first seller is an entity offering sales items on the third party web site.

93. The computer implemented method of claim 91 wherein the first negotiator is a first agent, said first agent assigned to negotiate for sale of said first item on behalf of the first seller.

94. The computer implemented method of claim 91 wherein the first negotiator is the first seller.

95. A computer implemented method for providing an online sales negotiation, comprising:
receiving, from a first buyer, a request to negotiate for a first item of said plurality of items offered for sale;
providing a user interface to the first buyer to facilitate the first negotiation session; and
providing, from an expert system, a response to the request to negotiate for a first sale item; wherein said request to negotiate is provided in response to a listing of ones of said plurality of items offered for sale.

96. The computer implemented method of claim 95 wherein said providing a response to the request to negotiate includes providing an offer price for the first item.

97. The computer implemented method of claim 96 further comprising receiving, from the first buyer, a counter-offer to the offer price.

98. The computer implemented method of claim 97 further comprising generating, in response to the counter-offer received from the first buyer, a second counter-offer.

99. The computer implemented method of claim 97 further comprising accepting, in reply to the counter-offer received from the first buyer, the counter-offer, if the counter-offer is within a predetermined acceptable price range.

100. A processor readable medium containing instructions that when executed on a processor:
provide a listing of ones of a plurality of items offered for sale;
receive, from a first buyer, a request to negotiate for a first item of said plurality of items offered for sale;
assign, responsive to the request to negotiate, a first negotiator to a first negotiation session with the first buyer, for purchase of the first item; and
provide a user interface to the first buyer to facilitate the first negotiation session.

101. The computer readable medium of claim 100 wherein the first negotiator is a first agent, said first agent assigned to negotiate for sale of said first item on behalf of a first seller offering the first item.

102. The computer readable medium of claim 101 wherein the instructions include instructions to assign the first agent to the first negotiation session based on the ordering of the first agent in a list of available agents.

103. The computer readable medium of claim 101 wherein the instructions include instructions to assign the first agent to the first negotiation session using a random selection.

104. A method of assigning agents in support of outsourced negotiations, comprising:
receiving, from a first buyer, a request to negotiate for a first item of a plurality of items offered for sale;
assigning, responsive to the request to negotiate, a first agent to a first negotiation session with the first buyer, for purchase of the first item; and
providing a user interface to the first buyer to facilitate the first negotiation session; wherein said request to negotiate is provided in response to a listing of ones of said plurality of items offered for sale.

105. The method of claim 104 wherein the first agent is assigned to the first negotiation session based on the ordering of the first agent in a list of available agents.

106. The method of claim 104 wherein the first agent is assigned to the first negotiation session based on a random selection.

107. The method of claim 104 wherein the first agent is assigned to the first negotiation based on one or more experience or expertise criteria of the first agent, wherein said one or more experience or expertise criteria are related to a characteristic of the first item.

108. The method of claim 104 wherein said assigning the first agent to the first negotiation comprises:
sending, to a plurality of available agents, a request to negotiate for the first item;
receiving, from a first replying agent of said plurality of available agents, an acknowledgment to the request to negotiate; and
selecting said first replying agent as the first agent, wherein the acknowledgment to the request to negotiate is a first temporally received acknowledgment from said plurality of agents.
